(19) United States
(12) Patent Application Publication
(10) Pub. No.: US 2011/0106617 A1
(43) Pub. Date: May 5, 2011

(54) METHOD AND SYSTEM OF PROCESSING A QUERY USING HUMAN ASSISTANTS

(75) Inventors: Thomas E Cooper, Indianapolis, IN (US); Scott A. Jones, Carmel, IN (US)

(73) Assignee: CHACHA SEARCH, INC., Carmel, IN (US)

(21) Appl. No.: 12/915,379

(22) Filed: Oct. 29, 2010

Related U.S. Application Data
(60) Provisional application No. 61/255,894, filed on Oct. 29, 2009.
(60) Provisional application No. 61/286,038, filed on Dec. 14, 2009.

(51) Int. Cl. G06F 17/30; G06Q 30/00

(52) U.S. Cl. 705/14.49; 707/759; 707/748; 705/14.4; 707/E17.014

(57) ABSTRACT

A system and method of providing information to improve efficiency of human searchers obtaining information on behalf of users is described. A query is processed to improve its form prior to being presented to a human searcher. A type associated with a query is determined which may affect a probability that a human searcher will respond to the query. Actions of a human searcher may be used to modify automated processing and decision making for processing of a query.

### CROSS-REFERENCE TO RELATED APPLICATIONS

This disclosure is related to and claims priority to U.S. Provisional Application Ser. No. 61/255,894, inventor Thomas E. Cooper, entitled, “METHOD AND SYSTEM OF PROCESSING A QUERY USING HUMAN ASSISTANTS,” filed Oct. 29, 2009 and to U.S. Provisional Application Ser. No. 61/286,038, inventor Scott A. Jones, entitled, “METHOD AND SYSTEM FOR ADVERTISING PERFORMANCE VERIFICATION,” filed Dec. 14, 2009, the contents of which are incorporated herein by reference in their entirety.

### BACKGROUND

1. Field of the Invention

The present invention is related to search engine technologies, more specifically to human-assisted search engines. A method and system of processing a query using assistance of a human searcher is described. The present invention is also related to advertising systems which verify delivery of advertisements by publishers. In particular, systems which verify delivery of messaging based advertising are discussed and a method for verifying delivery and performance is described.

2. Description of the Related Art

In processing a query submitted to an information search system there are two problems to be solved. A query must be interpreted, and must be matched to an index which will locate an answer corresponding to the request. The interpretation problem is traditionally solved by requiring a user to construct a query which is suited to the information desired. The retrieval problem is solved by indexing of a corpus of documents which is ranked based on keywords, categories, and/or other forms of metadata. Search engines such as Google, or Yahoo!® have used such techniques effectively to provide users with access to websites and other forms of information in a scalable and somewhat effective manner.

However such systems have some intrinsic weaknesses. As a query becomes longer, it may be difficult to determine a dominant keyword or keywords which are to be used to select an item. Further it is often difficult to effectively index a web page to locate a precise answer to a query. A natural language query may present further interpretation problems due to the combinatorial explosion intrinsic to natural language.

For these and other reasons, systems have recently been developed to allow a user to ask a natural language query and receive an answer to the query. A natural language query may be interpreted by a person, and an answer obtained by a person using search resources such as search engines, databases, web directories, etc. In such an instance, a capable searcher provided with suitable search facilities may obtain a response to a user request which is a concise answer to the query. Service providers such as AQA (Any Question Answered) and ChaCha have developed systems whereby a user query may be routed to a human searcher, and a response returned to the user.

Human assisted search systems may require a significant amount of time and effort by a searcher to obtain an answer. In such an instance, the cost to respond to a query may be high as a searcher may expect to be reasonably compensated for work performed. To mitigate this problem, a database of questions and answers may be provided. For example U.S. Pat. No. 6,434,549 (filed Dec. 13, 1999) by Linetsky, et. al., describes a system for searching a database of previous queries associated with a question and answer database. However such an approach may not be completely effective, as a database of previous queries may include outdated answers, may be incomplete, and/or may not properly match a user query.

Due to the need to use human searchers as efficiently as possible, it may be useful to provide a human intermediary or “expediter” who may interpret a user query and locate an answer with minimal effort. Further an expediter may categorize a query, improve the form of the query, and route the query to a searcher. Such a system is described in U.S. Published Application Serial Number 2009/0132500 (filed Nov. 21, 2008), by Jones, et. al. While effective in providing a higher quality answer, if every query is routed to a human expediter, the system may not provide a best balance between automation and human based query processing.

In light of this, what is needed is an improved system for processing a query for use with a human assisted search service.

### SUMMARY

A system is provided whereby a user may submit a query to a search service. A query may be submitted using any type of messaging service which is available to a user and a search system. A received query may be modified based on processing applied to the original query prior to performing a search. Once the query has been modified, a search is performed using the modified query. A user is then provided with a search result. A query may be modified by based on historical query and answer information. A type of processing to be performed for a query or search request may be determined based on a statistical model.

A keyword from a query may be used to select an advertisement to send to responsive to a search request. A keyword may be part of an index that is associated with an advertisement. An advertisement is delivered to a verifier. A verifier may add information to the message provided by an advertiser. An advertisement is then delivered to a user, and information of the delivery may be provided to an advertiser providing the advertisement and a publisher publishing the advertisement.

Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a database record for a request table.

FIG. 3 is a database record for a guide table.

FIG. 4 is a database record for a user.

FIG. 5 is a database record for a succinct query.

FIG. 6 is a database record for a result.

FIG. 7 is a database record for a profile.

FIG. 8 is a database record for a category.

FIG. 9 is a database record for a resource.

FIG. 10 is a flowchart of a process for processing a request.

FIG. 11 is a flowchart of a process for natural language processing of a request.

FIG. 12 is a flowchart of an alternate process for natural language processing of a request.

FIG. 13 is a flowchart of a process for vetting a request.

FIG. 14 is a flowchart of a process for responding to a request.

FIG. 15 is a flowchart of a process for selecting a response to a request.

FIG. 16 is a flowchart of a process for routing a request.

FIG. 17 is a flowchart of a process for vetting a request by an expediter.

FIG. 18 illustrates a graphical user interface (GUI) for an expediter.

FIG. 19 illustrates a GUI for an expediter.

FIG. 19A illustrates a GUI for an expediter.

FIG. 20 illustrates a GUI for an expediter.

FIG. 21 illustrates a GUI for an expediter.

FIG. 22 illustrates a GUI for an expediter.

FIG. 23 illustrates a GUI for an expediter.

FIG. 24 is a block diagram of an exemplary system embodiment.

FIG. 25 illustrates a database record for a request.

FIG. 26 illustrates a database record for a user.

FIG. 27 illustrates a database record for an aggregator.

FIG. 28 illustrates a database record for an advertisement.

FIG. 29 illustrates a database record for an advertiser.

FIG. 30 illustrates a database record for a publisher.

FIG. 31 illustrates a database record for a verifier.

FIG. 32 is a flowchart of a process of creating advertisements.

FIG. 33 is a flowchart of a process of distributing advertisements.

FIG. 34 is a flowchart of a process of verification of performance responsive to a response code.

FIG. 35 is a flowchart of a process of verification of performance responsive to a voice call.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A query is received and may be processed in order to rewrite the query to map more effectively to an indexing query or “succinct query”. Techniques such as spell checking, temporal filtering, node graphing, “named entity” recognition, query reconstruction, and categorization may be applied to create a first approximation of a succinct query.

A response may be examined to determine whether a query is strongly related to the answer. Queries available as index queries which are similar to a result of the rewriting process may be determined to be equivalent to a query which was provided by a user. A category may be associated with a query based on the rewritten query and/or similar queries.

A rewritten query is processed to determine whether an automated response may be applied to the query. For example, if the query includes a keyword indicating an automated request or syntax, the query may receive an automated response. A query which may correspond to a recognized pattern for an automated feed and/or resource may be passed to an automated resource which may provide an answer to a user. For example, regular expression analysis may be used to match a rewritten query to a data feed and/or a predetermined answer.

A query which is determined not to be suitable for an automatic response is compared to a database of previous queries and answers. A comparison may be based on similarity of a rewritten query and a reference query in a database of queries and answers. An answer provided may be related to a ranking of answers which may include guide opinions, similarity to a query, etc. If a suitable match is found to a query, and an answer is highly rated, the answer may be provided to a user.

If a query can not be answered by automated analysis, it may be passed to an expediter. An expediter may be provided with historical context information associated with a user and tools needed to respond to a user request. An expediter may use human intelligence to rewrite a query, construct a query, categorize a query, and select an answer to a user request. An expediter may be able to refresh information of available queries, answers, categories, etc., as a query is processed. After an expediter completes processing of a query a finished query may be compared to a database of indexed queries. If a matching query is found, an expediter may be able to indicate if an answer selected is suitable, which may assist in ranking of answers associated with a succinct query.

A query constructed by an expediter may be further compared to patterns. A match to a pattern may be used to determine whether a data feed, or other automated resource may be used to respond to the query as processed by an expediter. If it is determined that a response is available, a response may be provided automatically.

A query which is determined not to be suitable to be answered automatically, and/or using the assistance of an expediter may be provided to a searcher based on a categorization associated with the query. Historical information of a user and/or queries may be provided to a searcher.

A system is provided whereby a human searcher or guide may respond to a user request. A query is received from a user and may be analyzed automatically to determine whether a response may be provided based on automated processing. If it is determined that automated processing may not provide a response, a request or query may be directed to an expediter. An “expediter” is a guide trained to process a query to determine context and direct the query to an appropriate resource. If it is determined that a guide who is trained to search for information or “searcher” is required to respond to a request, a query processed by an expediter may be routed to a searcher. A searcher may be a “specialist” or guide who has elected to search queries associated with a category and/or keyword. A searcher may be a “generalist” or guide who has elected to search queries associated with any category and/or keyword.

A query which is received may undergo various forms of automated processing. An initial query process may include processes such as spelling and grammar checking, keyword detection, signature removal, language detection, word substitution, named entity processing, grammatical analysis, and categorization. A serial and/or parallel processing of a query as received or “raw query” may be performed. A profile may be associated with a query, which may include geographic, demographic, personality, affiliation and/or other information may modify processing of a query.

A query may be compared to a database of regular or “structured” or “succinct” queries. A succinct query may be used to aggregate answers associated with similar queries in order to increase answer reuse probability. If a first structured query is grammatically close to a second structured query, answers associated with the first and the second succinct queries may be evaluated to determine if an answer is available to respond to a user query. A category associated with an answer associated with a succinct query may affect a ranking of a category associated with a request.

A process for determining whether an automated response may be provided to a query or request may be used in multiple instances. A raw or unprocessed request may be compared to a group of defined query structures which may be recognized automatically. A raw query may be compared to a database of queries which have been verified to have high quality responses associated with the queries. Morphology techniques such as “regular expressions” may be used to match variants of a query to query indicated in a database. A check may be made to determine if a query is a recognized keyword, which may be associated with a response trigger, which may be provided automatically. Automated response review may be performed at multiple points in processing of a query.

An answer reuse process may be applied to a query. Succinct queries which match a raw query and/or a rewritten query may be examined to determine if a suitable answer or result is associated with a selected succinct query. A category associated with a query may be used to rank a result associated with a succinct query. If an answer which is of sufficient quality is associated with a matching succinct query, the answer may be provided responsive to the query.

If an automated result is determined to be unavailable, a process is provided to determine if a query is to be provided to an expediter, or may be provided directly to a searcher. A processed query is examined to determine the probability that an expediter may successfully respond to the query. Items such as probability of an automated response, temporal nature of a query, match to a database of queries, sensitivity to context, etc., are considered in determining if an expediter is to receive a request.

A process is provided whereby an expediter may review automated responses, matching to existing queries and/or results, and may categorize and/or confirm a succinct query associated with a request. A query processed by an expediter may be reviewed for automated processing. Results determined by automated analysis of a query processed by an expediter may be confirmed, reviewed and/or rejected by an expediter.

A “user” is any person or entity which may submit a request, search request, or query. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” or “expediter” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. For example, a transcriber may extract text information from an image, may translate a query from one language to another, etc. A guide may be referred to as a “human assistant” or “human searcher” or “searcher”. A guide may perform any type of task. Any guide may act in any defined guide role. However, a human assistant who performs a task and a guide who conducts a search associated with a query may not necessarily be the same person. For example, a human assistant may perform a task to facilitate a search which is conducted by another person who is registered as a guide.

An “identifier”, or ID, may include character, number and/or other type of information which may be used to identify an item including an item of a database. Items may include but are not limited to a guide, a user, a resource, an advertisement, a keyword, a category, a search result, a search request, a query, a rating, a ranking, a message and/or a profile.

A “guided request” is a request which uses the assistance of one or more guides.

A “result” or “search result” or “answer” is any information which may be provided responsive to a request. A result includes, but is not limited to, any or all of an advertisement, a link to a web page, a message of any sort, an image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

The terms voice and speech are used interchangeably herein. A user, a resource, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

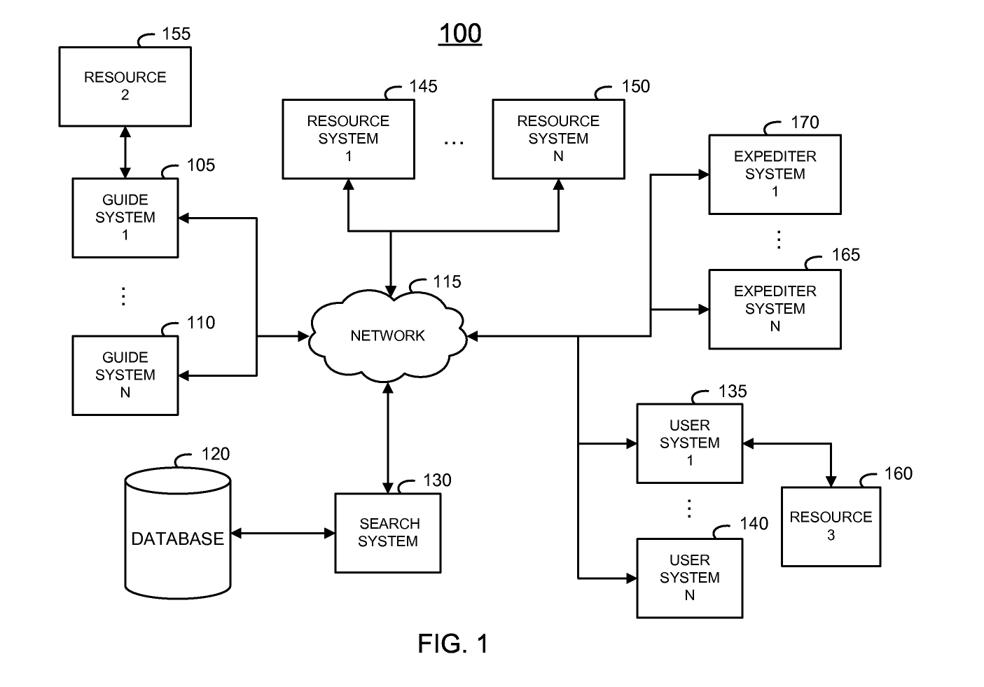

Communication between a guide, a user, a resource and/or a search system may include conversion of text to speech and speech to text. Any type of conversion and/or other processing of information which may facilitate communication between a user, a guide, a resource and/or a search system may be performed by any element of the system 100 (FIG. 1). Any type of media which can be sent and/or received using a communication system may be part of a communication session. A communication session may be conducted using any or all communication service associated with a user, a resource and/or a guide. Any communication session may include communication via multiple services and/or device. For example, a request may be submitted as a voice query, which might indicate an image located on a resource accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide and/or a search system. A resource, a guide, and/or an advertisement may be rated. Rating information may be obtained from a user, a guide, a resource and/or a search system. Rating information may be used to select a resource, a guide, an advertisement and/or any item based on information associated with an item indicated in a database. A search service may be compensated by advertising revenue. Advertising or content may be delivered to a user, and/or guide using any service associated with a user and/or guide.

As illustrated in FIG. 1, system 100 includes guide systems 105, 110, a network 115 such as the Internet, a search system 130, user systems 135, 140, a database 120, which may comprise various records, a guide resource 155, resource systems 145, 150, a user resource 160, and expediter systems 165, 170.

While only a limited number of systems associated with a guide, resource, user, expediter and a search system are depicted in FIG. 1, it is within the scope of the disclosure for multiple systems for guide, resource, user, expediter and search systems to be utilized.

Any user system (e.g., the user systems 135, 140) can be operated by an information seeker, who may be any person, to submit a search request to the search system 130 and/or receive a search result and/or other information. Any guide system (e.g., the guide systems 105, 110 and/or the expediter systems 165, 170) can be operated by a human searcher to obtain a search result responsive to a request which may have been submitted by an information seeker located at a user system. Any resource system (e.g., the resource systems 145, 150) may be operated by a human provider of information and/or may be an automated system which may provide a search result and/or other information to a guide and/or a user. A search engine, a database, a local information source of a guide system such as a disk or removable memory, etc. may be resource systems. A resource may not be accessible using the network 115. For example, a resource such as the guide resource 155, “Resource 2”, may be accessible to a guide operating a guide system such as the guide system 105, or a resource such as the user resource 160, ‘Resource 3’, may be accessible to a user operating the user system 135. A resource might include printed materials, images, video, and/or audio information, a software application, any information accessible to a guide, a user, a database, a system and/or any combination thereof.

The network 115 may be a global public network of networks (the Internet) and/or consist in whole or in part of one or more private networks and communicatively couples the guide systems 105, 110, the resource systems 145, 150, the user systems 135, 140, and the expediter systems 165, 170, with the other components of the system such as the search system 130, and the database 120. The network 115 may include one or more wireless networks which may enable wireless communication between the various elements of the system 100. For example, a mobile phone carrier network might be used to connect a user device to the search system 130.

The search system 130 allows interaction to occur among the guide systems 105, 110, the resource systems 145, 150, the user systems 135, 140, and the expediter systems 165, 170. For example, an information search query can be transmitted from the user systems 135, 140, to the search system 130, where a search query can be accessed by the guide systems 105, 110, the expediter systems 165, 170 and/or the resource systems 145, 150. Similarly, a search result or response produced from the resource systems 145, 150, using the guide systems 105, 110, and/or the expediter systems 165, 170, in response to a search query submitted by the user systems 135, 140, may be transmitted to the search system 130, where it may be stored by the search system 130, and/or may be transmitted to the user systems 135, 140. Any type of communication between a user, a guide, and a resource may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entire database 120.

The guide systems 105, 110, the resource systems 145, 150, the user systems 135, 140, the search system 130, and the expediter systems 165, 170 may include equipment, software, systems and personnel required to send and/or receive messages between a user system, a guide system, a resource system, and/or the search system using the network 115. The database 120 includes information which may allow the search system 130 to establish communication between any or all of the elements of the system 100.

A user system, a guide system, and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, expediter systems, resources, and/or to implement the search system 130.

A guide may be required to register with the search system 130. As part of a registration process, at least one communication service is associated with a guide. In at least one embodiment, a guide may register with the search system 130 and establish a username and password which are associated with the guide. A guide may login to the search system 130 using a web browser functionality of the guide system 105 in order to communicate with the search system 130. Multiple communication services may be associated with a guide and may allow a communication session to be established between a guide system such as the guide system 105 and a user system, an expediter system, a resource system and/or the search system 130. Multiple identifiers of a guide may be associated with each other. Information such as IM credential, an email address, a phone number, a URL, a username, etc., of a guide may be identified which may allow the search system 130 to establish a communication session between a guide system and a user system, a resource system, and/or the search system 130.

When a guide registers with the search system 130, the guide may be associated with one or more keywords, categories, and/or other information. For example a keyword or category may be selected by a guide, or may be associated with a guide based on a test administered to a guide and/or other information provided during and/or after a registration process. Information associated with a guide may be stored in the database 120 and may be used for purposes such as matching a guide to a user request, determining and/or providing compensation for a guide, communicating with a guide, etc., as will be described further herein below.

A user may be identified by the search system 130. When a user system such as the user system 135 establishes a communication session with the search system 130, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 135 and a guide system, a resource system and/or the search system 130. Information such as a keyword, a category, a user profile, a previous search request, a search result, etc., may be associated with a user. Information of a user may be stored in the database 120.

A resource, which may be a person, an entity, a search engine, a database, a software application, a corpus of one or more types of media such as text or printed information, images, audio, video, etc., or a combination thereof, may be identified by the search system 130. Any source of information may be a resource within the context of the disclosure herein. Information of at least one method of communication is associated with a resource system which allows a communication session to be established between the search system 130, a user system, a guide system, an expediter system and/or a resource system such as the resource systems 145, 150. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 145 and a user system, a guide system, and/or the search system 130. Information such as a keyword, a category, a profile, or other information may be associated with a resource. Information of a resource may be stored in the database 120.

A resource such as the resources 155, 160 and/or resources accessible via the resource systems 145, 150, may include any system, software, hardware, personnel and/or other facility which may provide information to a guide, a user, and/or the search system 130. For example, a resource may be a search engine, a database system, a library, a personal hard drive and/or other local storage, printed materials, recordings of any sort, a software program, a person or persons, an organization, etc. A resource may be freely accessible to any user and/or guide and/or may be available on a restricted basis. The resource system 145, 150, may include resources which are available on an unrestricted and/or restricted basis. A resource may not be accessible using the network 115, but may be accessible to selected guide. For example, a resource such as the resource 155 may be accessible to one or more guides operating a guide system such as the guide system 105 using any type of communication. For example, a guide may obtain information of an event to provide a search result. Information in any form, such as printed media, audio and/or visual information, software, hardware, etc., which may be accessible to a guide, a user and/or an operator of a resource system may be a resource.

The search system 130 may establish a communication session between any user system, guide system, and/or resource system using information indicated in the database 120. For example, the user system 135 may establish a voice communication session with the search system 130, the search system 130 may establish a voice communication session between the user system 135 and the guide system 105, and the search system 130 may establish a voice communication session between the user system 135 and the resource system 145. While a voice communication session is used in this example, any type of communication session using one or more services such as SMS, EMS, MMS, email, IM, chat, web based communication, etc., may be established between any user system, guide system, and/or resource system and/or the search system 130.

The expediter systems 165, 170, may be operated by a guide who has registered as an expediter. As part of a registration process, at least one communication method is associated with an expediter. In at least one embodiment, an expediter may register with the search system 130 and establish a username and password which are associated with the expediter. An expediter may login to the search system 130 using a web browser functionality of expediter system 165, 170, in order to communicate with the search system 130. Multiple communication services may be associated with an expediter and may allow a communication session to be established between an expediter system such as the expediter system 165 and a user system, a resource system and/or the search system 130. Multiple identifiers of an expediter may be associated with each other. Information such as IM credential, an email address, a phone number, a URL, a username, etc., of an expediter may be identified which may allow the search system 130 to establish a communication session between an expediter system and a user system, a resource system, and/or the search system 130.

When an expediter registers with the search system 130, the expediter may be associated with one or more task types, profiles, categories, and/or other information. For example, a type of activity may be selected by an expediter, or may be associated with an expediter based on a test administered to an expediter and/or other information provided during and/or after a registration process. Information associated with an expediter may be stored in the database 120 and may be used for purposes such as matching an expediter to a user request, determining and/or providing compensation for an expediter, communicating with an expediter, etc., as will be described further herein below.

Information associated with a user, a guide, an expediter, and/or a resource may be obtained in various ways. For example, a registration process may be performed using a web form provided by the search system 130, and/or information may be obtained from an external database, and/or information may be obtained based on analysis of information indicated by a user, a guide, and/or a resource. A “profile” is one or more characteristics which may be associated with one or more individuals. A profile may include geographic data such as a street address, latitude and longitude, etc., may include demographic information such as age, gender, race, income, family size, political affiliations, etc. A profile may include personality information such as results of psychometric testing, subjective evaluations of an individual, etc., may include affiliation information such as employment, club, activity, societal membership information, information of a device, service, transaction and/or any information which might be associated with a user and/or a guide.

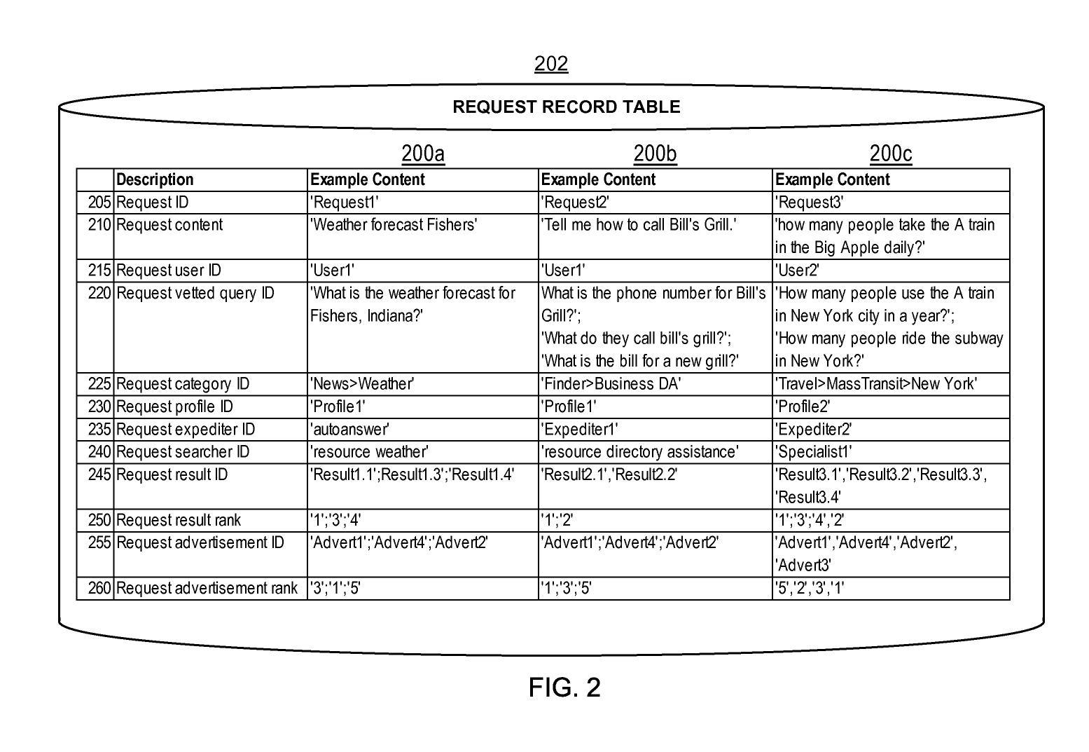

If a request is submitted to the search system 130, a record of the request may be created, and may be stored in the database 120. A request record table 202 (FIG. 2) may be composed of a number of request records 200. The request records 200 may be associated with or resident in the database 120 (FIG. 1). The request record 200 (FIG. 2) may include a request ID field 205, a request content field 210, a request user ID field 215, a request vetted query ID field 220, a request category ID field 225, a request profile ID field 230, a request expediter ID field 235, a request searcher ID field 240, a request result ID field 245, a request result rank field 250, a request advertisement ID field 255, and a request advertisement rank field 260.

The request record ID field 205 contains an identifier of a request, which is preferably unique and preferably used consistently. For example, in at least one embodiment, the request record ID field 205 can include a randomly generated numerical code and/or a character string indicating a request. A request record ID serves to distinguish a request record associated with a request from a request record associated with other requests. Although particular examples of identifiers are described herein, other types of identifiers uniquely indicating a request may be utilized without departing from the spirit and scope of the embodiments herein. Using the example in FIG. 2, ‘Request1’ is the request record ID associated with the request record 200a. ‘Request2’ is the request ID associated with the request record 200b. ‘Request3’ is the request ID associated with the request record 200c.

The request content field 210 may include information regarding content of a request. For example, text associated with a query submitted by a user may be indicated in the request content field 210. Content of the request content field 210 may be processed in order to associate a keyword and/or category and/or other information with a request. Information such as audio recordings, images, etc., which are associated with a request may be indicated in the request content field 210. Using the example illustrated in FIG. 2, the query ‘Weather forecast Fishers’ is the content associated with the request record 200a. This may indicate that the query ‘Weather forecast Fishers’ may be processed in order to respond to ‘Request1’. Information indicated in the request content field 210 may be used to determine which information associated with an index may be provided responsive to a request. For example, keywords associated with the request ‘Weather forecast Fishers’ may compared to interests or keywords associated with an index to determine a number of categories associated with the request ‘Request1’. Content of the request content field 210 may be compared to a database of queries, and/or may be processed as further described herein.

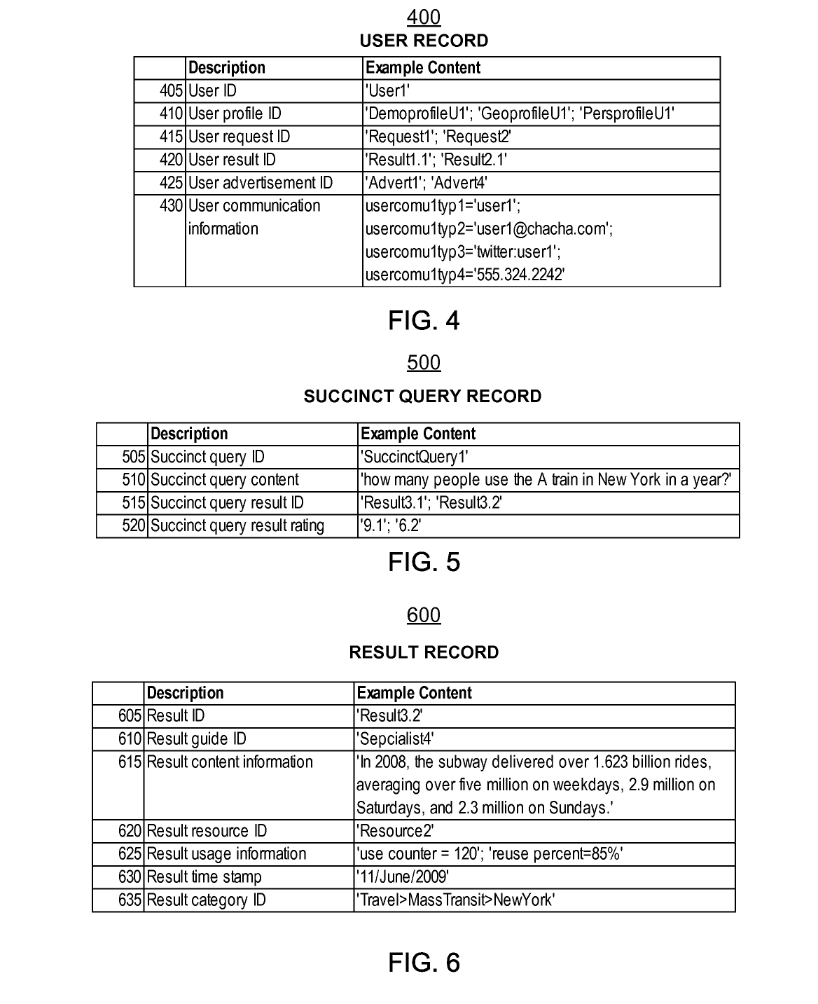

The request user ID field 215 may include information of a user that submitted a query. The request user ID field 215 may be used to associate any number of users with a query. In at least one embodiment, each request is uniquely associated with a single user. In at least one embodiment, if a request submitted by a user is equivalent to a previous request, multiple users may be associated with a request. In at least one embodiment, an individual user may submit a request which is associated with a group of one or more users. A result and/or other item associated with a request may be presented responsive to a request in an order based at least in part on a ranking of the item associated with the request. Information indicated in the request user ID field 215 may be used to obtain information of a user using a record such as the user record 400 illustrated in FIG. 4. Using the example illustrated in FIG. 2, ‘User1’ is associated with ‘Request1’ and ‘Request2’ and ‘User2’ is associated with ‘Request3’.

The request vetted query ID field 220 may include information of a vetted or succinct query associated with a request. For example, a comparison of content of the request content field 210 with a database of vetted queries may be used to rank a vetted query to be associated with a request. Content of the request vetted query ID field 220 may be provided to a guide selected to respond to a request. Content of the request vetted query ID field 220 may be used to look up a search result associated with a vetted query. Any number of vetted queries may be associated with a request. Using the example in FIG. 2, the vetted queries ‘What is the phone number for Bill's Grill?’, ‘What do they call bill's grill?’ and ‘What is the bill for a new grill?’ are associated with ‘Request2’, which may indicate a best match of those queries to the content of the request content field 210. Vetted queries may be associated with a request based on factors such as grammar analysis of the relationship between a request and a vetted query. Factors such as keyword matching, thesaurus equivalence, etc. may be used to match a query to a vetted query.

The request category ID field 225 may include information of a number of categories and/or keywords associated with a request. Content of the request category ID field 225 may be modified by an automated classification of a request. A human may select a category and/or keyword associated with a request. A categorization may be associated with a resource, a guide, an advertisement, training information, etc. An item associated with a category may be presented to a guide and/or a user if a request associated with a category is submitted. An item associated with a category and/or other information may be presented for review by a person. Association of a category with a request may be used to select items such as an advertisement associated with the category to be presented responsive to a request. Association of a category with a request may be used to select a guide associated with the category to vote regarding an item associated with the request. A category may be associated with a request based on any type of information associated with the request. In at least one embodiment, only one category may be associated with a request. Using the illustrated example, the category ‘Travel>MassTransit>NewYork’ is associated with ‘Request3’. Association with ‘Travel>MassTransit>NewYork’ may cause a query to be provided to an expediter, a specialist, and/or a generalist. For example, a ranking of available guides may be based at least in part on a category associated with a request.

The request profile ID field 230 may include information of a number of profiles associated with a request. For example, a profile may be associated with a request based at least in part on a profile associated with a user associated with a request. For example, a geographic profile which is common to a number of users associated with a request may be associated with a request, or a guide may determine that a profile is to be associated with a request based on content and/or subject matter of a request associated with a user, etc. A guide selected to respond to a request may be selected based at least in part on a profile associated with the request. A reviewer may be selected to review an item associated with a request based at least in part on a profile associated with a request. For example, ‘Profile1’ is associated with ‘Request1’ as indicated in the request record 200a.

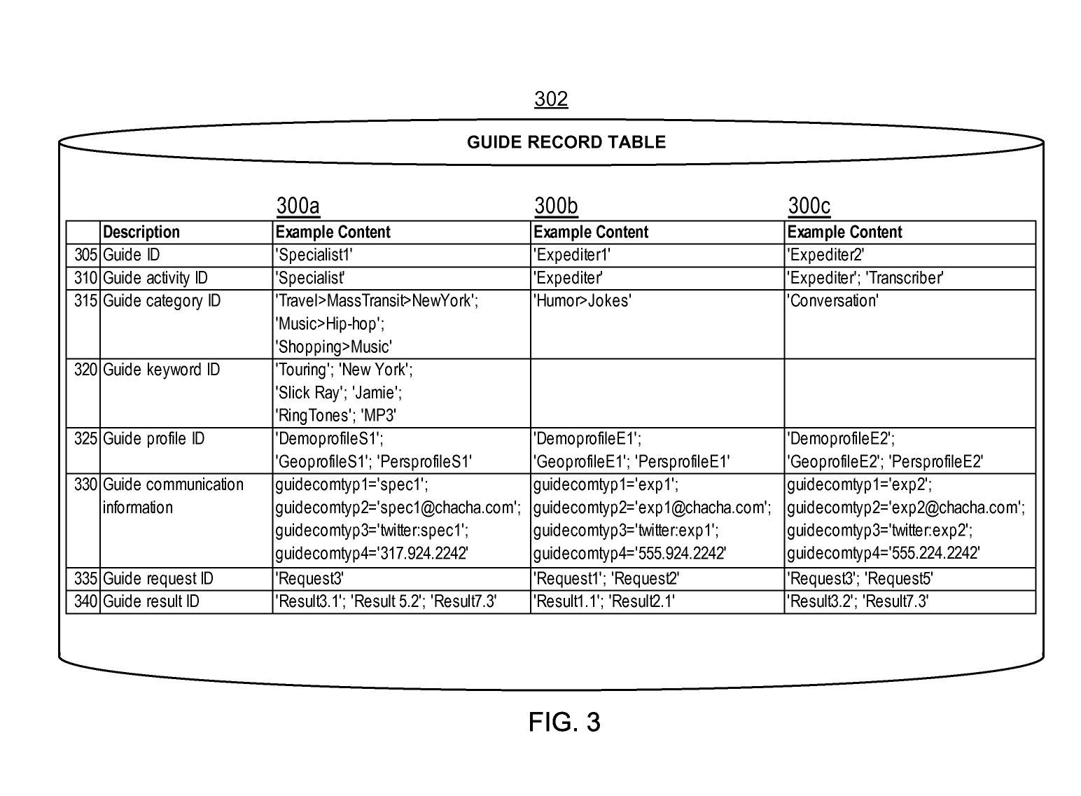

The request expediter ID field 235 may include one or more identifiers associated with an expediter. The request expediter ID field 235 may include one or more identifiers of an expediter which may be used to obtain further information of an expediter using a record such as the guide record 300b (FIG. 3). Using the example in FIG. 2, the expediter ID ‘Expediter1’ is associated with the request record 200b. While only one expediter identifier has been illustrated, any number of expediter identifiers may be associated with a request. Association of an expediter ID with a request may indicate that an expediter has responded to the request, and/or that an expediter may have reviewed, edited, or otherwise associated information with a request. If a request is processed using automated resources, an indicator of the resources used may be indicated in the request ambassador ID field 235. For example, ‘autoanswer’ is indicated in the request expediter ID field 235 of the request record 200a.

The request searcher ID field 240 may include one or more identifiers associated with a searcher. The request searcher ID field 240 may include one or more identifiers of a searcher which may be used to obtain further information of a searcher using a record such as the guide record 300a (FIG. 3). Using the example in FIG. 2, the searcher ID ‘Specialist1’ is associated with the request record 200c, which may indicate that a search result associated with a request is a search result provided by ‘Specialist1’. For example, the highest ranked result ‘Result3.1’ associated with ‘Request3’ may have been produced by ‘Specialist1’.

The request result ID field 245 may include information of a number of results associated with a request. A search result may be associated with a request when a guide obtains the search result responsive to the request. For example, if a request is submitted to the search system 130 (FIG. 1), a guide may be selected based on a ranking of the guide for the request, and the guide may provide a result responsive to the request. A result may be associated with a request if the request is submitted to a resource such as a search engine, database or other resource system, or a result may be associated with a request based on comparison of the request with a database of queries and/or search results. Any number of search results may be associated with a request. A result may be associated with a request based on a selection of an expediter, and/or automatically. Using the example illustrated in FIG. 2, ‘Result1.1’, ‘Result1.3’, and ‘Result1.4’ have been associated with ‘Request1’.

The request result rank field 250 may include information regarding a ranking of a result associated with a request. In at least one embodiment, the request result ID field 245 and the request result rank field 250 are linked by, for example, a pointer. Using the example illustrated, ‘Result1.1’ has a ranking of ‘1’, ‘Result1.3’ has a ranking of ‘3’, and ‘Result1.4’ has a ranking of ‘4’. Content of the request result ID field 245 and the request result rank field 250 may be used at least in part to determine an order in which a search result is presented to a user responsive to a request. ‘Result1.1’ might be preferentially presented to a user responsive to ‘Request1’. A ranking of a result may be determined based on criteria such as keyword ranking, guide ratings, etc., which may include automated and/or human assisted rating and/or ranking. For example, a result associated with a data resource may be ranked higher than a stored result selected by a trusted guide, which may be ranked higher than a result selected by a specialist, which may be ranked higher than a result selected by a generalist.

The request advertisement ID field 255 may include information of a number of advertisements associated with a request. An advertisement may be associated with a request when a guide selects the advertisement to be presented to a user responsive to the request. If a request is submitted to the search system 130 (FIG. 1), a guide may be selected, and the guide may provide an advertisement responsive to the request. An advertisement may be associated with a request automatically such as when a category and/or a keyword is associated with the request. Any number of advertisements may be associated with a request. Using the example illustrated in FIG. 2, ‘Advert1’, ‘Advert4’, and ‘Advert2’ have been associated with ‘Request1’.

The request advertisement rank field 260 may include information regarding a ranking of an advertisement associated with a request. In at least one embodiment, the request advertisement ID field 255 and the request advertisement rank field 260 are linked by, for example, a pointer. Using the example illustrated in FIG. 2, ‘Advert1’ has a ranking of ‘3’, ‘Advert4’ has a ranking of ‘1’, and ‘Advert2’ has a ranking of ‘5’. Content of the request advertisement ID field 255 and the request advertisement rank field 260 may be used at least in part to determine an order in which an advertisement is presented responsive to a request. ‘Advert4’ might be preferentially presented to a user responsive to ‘Request1’.

While a few request records 200a-c have been illustrated in FIG. 2, any number of request records 200 may be provided as required to operate the embodiments.

If a guide is registered with the search system 130 (FIG. 1), a record of the guide may be created, and may be stored in the database 120. A guide record table 302 is illustrated in FIG. 3. The guide record table 302 may be composed of a number of guide records 300. The guide records 300 may include a guide ID field 305, a guide activity ID field 310, a guide category ID field 315, a guide keyword ID field 320, a guide profile ID field 325, a guide communication information field 330, a guide request ID field 335, and a guide result ID field 340.

The guide ID field 305 preferably contains a unique identifier of a guide, which is preferably used consistently. For example, in at least one embodiment, the guide ID field 305 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 3, ‘Specialist1’ is the guide ID associated with the guide record 300a.

The guide activity ID field 310 may include information of a type of activity associated with a guide. For example, if a guide elects to respond to a request associated with a category of information, the guide may be indicated as a specialist searcher. Similarly if a guide elects to act as a transcriber who converts a spoken query to a text query, the guide may be indicated as a transcriber. Guide roles may include tasks such as expediter, translator, trainer, concierge, sales agent, etc. Any role which may be assigned to a guide may be reflected in the guide activity ID field 310. A guide may participate in testing, training, and/or other forms of activity which may be used to associate a guide activity ID with a guide. Any number of activities may be associated with a guide. A guide may have a rating and/or ranking associated with a guide activity which may affect the probability that a guide will be selected to respond to a request. The guide ‘Expediter2’ is associated with the roles ‘Expediter’ and ‘Transcriber’ as indicated in the guide activity ID field 310 of the guide record 300c.

The guide category ID field 315 may include information of a number of categories associated with a guide. Content of the guide category ID field 315 may be modified based on an action of a guide. A category may be associated with a guide based on one or more types of information processing. For example, the category ‘translate English to Spanish’, or ‘transcribe spoken queries’ or ‘Sports’ might be associated with a guide to indicate a skill or expertise associated with the guide. Association with a category may be used in part to rate or rank a guide and/or to select a guide. A person may select a category and/or keyword which is associated with a guide. A category may be associated with a guide based on testing of a guide. A category may be associated with a guide based on an affiliate group associated with the guide. For example, if a guide has chosen to be affiliated with affiliate groups associated with a type of food, a category associated with the type of food might be associated with the guide. A category may signify any type of skill or expertise which may be used to match a guide to a task. A category associated with a guide may be used to select an item which is to be presented to a guide. A guide may be selected to review an item based on the association of a guide with a category. For example, a guide may be selected to review and/or provide information such as resources, media, search results, etc., based on a category associated with the guide. A category associated with a guide may be used to determine whether a guide will receive a type of request. Using the example illustrated in FIG. 3, ‘Travel>MassTransit>New York’, ‘Music>Hip-hop’ and ‘Shopping>Music’ are associated with ‘Specialist1’. The guide record 300b indicates that ‘Expediter1’ is associated with ‘Humor>Jokes’.

The guide keyword ID field 320 may include information of a number of keywords associated with a guide. Content of the guide keyword ID field 320 may be modified based on an action of a guide. A person may select a keyword which is associated with a guide. For example, a guide may select a keyword to be associated with the guide during a registration process. A keyword may be associated with a guide based on testing of a guide. For example, a guide may be required to demonstrate knowledge of a category and/or keyword in order to be associated with the keyword. Content of the guide keyword ID field 320 may be compared to content of a request in order to determine a ranking of a guide for responding to a request. For example, if a keyword indicated in the guide keyword ID field is associated with content of a request, the guide may be more likely to be selected to respond to the request. Keywords may be associated with a category associated with a guide. For example, a guide may be associated with a keyword which causes the guide to be associated with a category. The guide keyword ID field 320 and the guide category ID field 315 may be linked. Using the example illustrated in FIG. 3, the keywords ‘Touring’, and ‘New York’ are associated with the category ‘Travel>MassTransit>NewYork’ for the guide ‘Specialist1’. While keywords are associated with ‘Expediter1’ and ‘Expediter2’, it is foreseen that keywords may be associated with any guide in order to select a guide to respond to a request.

The guide profile ID field 325 may include information of a number of profiles associated with a guide. Content of the guide profile ID field 325 may be modified based on an action of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in a guide profile may be obtained from an external database. Information indicated in the content of the guide profile ID field 325 may be compared to information indicated in the content of a profile associated with a request in order to determine a ranking of a guide for responding to a request. Likewise, a profile associated with a guide may be used to select and/or rank a guide. Using the example illustrated, ‘DemoprofileS1’, ‘GeoprofileS1’ and ‘PersprofileS1’ are associated with ‘Specialist1’. This may indicate that ‘Specialist1’ has indicated and/or generated ‘DemoprofileS1’ which may be a demographic profile, ‘GeoprofileS1’ which may be a geographic profile and ‘PersprofileS1’ which might indicate personality information regarding ‘Specialist1’. Any or all information indicated in a profile associated with a guide may be used to determine a rating and/or ranking of a guide.

The guide communication information field 330 may include information of a device and/or service associated with a guide. Content of the guide communication information field 330 may be modified based on an action of a guide. If a guide establishes communications using a device and/or service, information regarding the device and/or service may be included in the guide communication information field 330. Any type of communication service and/or system may be indicated in the guide communication information field 330. For example, a username and/or password associated with a guide may be indicated in the guide communication information field 330. Communication services such as IM, e-mail, SMS, MMS, EMS, telephone, wireless or wired communication, etc., may be indicated in the guide communication information field 330. A telephone number, an email address, an IM provider and login ID, a keyword associated with a service, etc., may be indicated in the guide communication information field 330. Using the example illustrated in FIG. 3, the login ‘exp1’, the email ‘exp1@chacha.com’, the Twitter® credential ‘twitter.exp1’ and the phone number ‘555.924.2242’ are associated with ‘Expediter1’. This may indicate that ‘Expediter1’ may be contacted using the login ID ‘exp1’, via email at ‘exp1@chacha.com’, via the Twitter® service as ‘twitter.exp1’ and/or via voice, text, and/or other service associated with the phone number ‘555.924.2242’.

The guide request ID field 335 may include information of a request associated with a guide. Content of the guide request ID field 335 may be modified based on an action of a guide. If a guide produces a search result responsive to a request, an identifier of the request may be included in the guide request ID field 335. A rating and/or ranking associated with a request associated with a guide may affect compensation for a guide. Likewise a usage indicator associated with a request and a guide may affect a rating and/or ranking associated with the guide. A request may be associated with a guide based on a vote cast by a guide regarding items associated with the request. Using the example illustrated in FIG. 3, ‘Request3’, and ‘Request5’ are associated with ‘Expediter2’. This may indicate that ‘Expediter2’ has responded to, been selected to respond to, and/or has reviewed one or more items associated with ‘Request3’, and ‘Request5’.

The guide result ID field 340 may include information of a result associated with a guide. Content of the guide result ID field 340 may be modified based on an action of a guide. If a guide produces a search result responsive to a request, an identifier of the search result may be included in the guide result ID field 340. A rating and/or ranking associated with a search result associated with a guide may affect compensation for a guide. Likewise a usage indicator associated with a search result provided by a guide may affect a rating and/or ranking associated with a guide. Using the example illustrated in FIG. 3, ‘Result3.1’, ‘Result5.2’ and ‘Result7.3’ are associated with ‘Specialist1’. This may indicate that ‘Specialist1’ has provided and/or reviewed ‘Result3.1’, ‘Result5.2’ and ‘Result7.3’.

As illustrated in FIG. 4, an exemplary user record 400 is provided, of which one or more may be associated with or resident in the search database 120 (FIG. 1). The user record 400 may include a user ID field 405, a user profile ID field 410, a user request ID field 415, a user result ID field 420, a user advertisement ID field 425, and a user communication information field 430.

The user ID field 405 preferably contains a unique identifier of a user, which is preferably used consistently. For example, in at least one embodiment, the user ID field 405 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 4, ‘User1’ is the user ID associated with the user record 400.

The user profile ID field 410 may include information of a profile associated with a user. Content of the user profile ID field 410 may be modified based on an action of a user. A person may select a profile which is associated with a user. For example, a user may select a profile to be associated with the user during a registration process. A profile may be associated with a user based on testing of a user and/or information from a user. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. Historical information such as a request and/or result associated with a user may be used to determine profile information. Information indicated in a user profile may be obtained from an external database. A profile associated with a user may be used to select and/or rank a user for voting. Using the example illustrated in FIG. 4, ‘DemoprofileU1’, ‘GeoprofileU1’ and ‘PersprofileU1’ are associated with the user ‘User1’. This may indicate that ‘User1’ has indicated and/or generated ‘DemoprofileU1’ which may be a demographic profile, ‘GeoprofileU1’ which may be a geographic profile and ‘PersprofileU1’ which might indicate personality information regarding ‘User1’.

The user request ID field 415 may include information of a request associated with a user. Content of the user request ID field 415 may be modified based on an action of a user. If a user submits a request, an identifier of the request may be included in the user request ID field 415. Using the example illustrated in FIG. 4, ‘Request1’ and ‘Request2’ are associated with ‘User1’ which may indicate that ‘User1’ has submitted ‘Request1’ and ‘Request2’.

The user result ID field 420 may include information of a result associated with a user. Content of the user result ID field 420 may be modified based on an action of a user and/or a guide. If a user receives a result responsive to a request, an identifier of the result may be included in the user result ID field 420. A usage indicator associated with a result provided to a user may affect a rating and/or ranking associated with a guide. Using the example illustrated in FIG. 4, ‘Result1.1’ and ‘Result2.1’ are associated with the user ‘User1’. This may indicate that ‘User1’ has been presented with the results ‘Result1.1’ responsive to ‘Request1’ and ‘Result2.1’ responsive to ‘Request2’.

The user advertisement ID field 425 may include information of an advertisement associated with a user. Content of the user advertisement ID field 425 may be modified based on an action of a user. If a user receives an advertisement, an identifier of the advertisement may be included in the user advertisement ID field 425. A usage indicator associated with an advertisement provided to a user may affect a rating and/or ranking associated with a guide, compensation for the search system, and/or rating and/or ranking of an advertisement. Using the example illustrated in FIG. 4, ‘Advert1’ and ‘Advert4’ are associated with ‘User1’. This may indicate that ‘User1’ has been presented with ‘Advert1’ responsive to ‘Request1’, and ‘Advert4’ responsive to ‘Request2’.

The user communication information field 430 may include information of a device and/or service associated with a user. Content of the user communication information field 430 may be modified based on an action of a user. If a user establishes communications using a device and/or service, information regarding the device and/or service may be included in the user communication information field 430. Any type of communication service and/or system may be indicated in the user communication information field 430. For example, a username and/or password associated with a user may be indicated in the user communication information field 430. Communication services such as IM, e-mail, SMS, MMS, EMS, telephone, wireless or wired communication, etc., may be indicated in the user communication information field 430. A telephone number, an email address, an IM provider and login ID, a keyword associated with a service, etc., may be indicated in the user communication information field 430. Using the example illustrated in FIG. 4, the login ‘user1’, the email ‘user1@chacha.com’, the Twitter® credential ‘twitter:user1’ and the phone number ‘555.324.2242’ are associated with ‘user1’. This may indicate that ‘User1’ may be contacted using the login ID ‘user1’, via email at ‘user1@chacha.com’, via the Twitter® service as ‘user1’ and/or via voice, text, and/or other service associated with the phone number ‘555.324.2242’.

As illustrated in FIG. 5, an exemplary succinct query record 500 is provided, of which one or more may be associated with or resident in the search database 120 (FIG. 1). The succinct query record 500 may include a succinct query ID field 505, a succinct query content field 510, a succinct query result ID field 515, and a succinct query result rating field 520.

The succinct query ID field 505 preferably contains a unique identifier of a succinct query, which is preferably used consistently. For example, in at least one embodiment, the succinct query ID field 505 can include a randomly generated numerical code, and/or a text string indicating content associated with a succinct query. A succinct query ID serves to distinguish the succinct query record associated with a succinct query from a succinct query record associated with other succinct queries. Other unique identifiers of a succinct query may be utilized without departing from the spirit and scope of the embodiments. In at least one embodiment, a succinct query ID may include a description associated with a succinct query. Using the example illustrated in FIG. 5, ‘SuccinctQuery1’ is the succinct query ID associated with the succinct query record 500.

The succinct query content field 510 may include information of content associated with a succinct query. For example, a structured query which may be mapped to a number of raw queries may be indicated in the succinct query content field 510. In at least one embodiment a succinct query may be based on a generalized grammar construction which may be a target form for a rewritten query associated with a raw query. Information indicated in the succinct query content field 510 may be compared to content of a query to determine a rating of a succinct query associated with the query. For example, if there is a high correlation between keywords, and the grammatical function of the keywords in a succinct query and a raw query, the succinct query may have a high rating associated with the raw query. Using the example in FIG. 5, ‘how many people use the A train in New York in a year?’ is the content associated with ‘SuccinctQuery1’. As illustrated in FIG. 2, given the high correlation between the content of the request content field 210 of the request record 200c, and the content of the succinct query content field 510 in FIG. 5, ‘SuccinctQuery1’ may be indicated in the request vetted query ID field 220 of the request record 200c in FIG. 2.

The succinct query result ID field 515 may include information of a number of search results associated with a succinct query. For example, if a guide has produced a search result responsive to a request associated with a succinct query, an identifier of the search result may be indicated in the succinct query result ID field 515. An identifier of a result record such as the result record 600 (FIG. 6) may be indicated in the succinct query result ID field 515. A search result may be associated with a succinct query automatically. For example, if two succinct queries constructed by a guide are found to be equivalent, search results associated with the queries may be associated with one and/or both of the succinct queries. Information indicated in the succinct query result ID field 515 may be used to obtain information associated with a result. A rating of a result may be based at least in part on information indicated in a result record. Any number of search results may be associated with a succinct query. Using the example in FIG. 5, the results ‘Result3.1’ and ‘Result3.2’ are associated with ‘SuccinctQuery1’.

The succinct query result rating field 520 may include information of a rating of a result associated with a succinct query. In at least one embodiment, the succinct query result ID field 515 and the succinct query result rating field 520 are linked by, for example, a pointer. Using the example illustrated in FIG. 5, ‘Result3.1’ has a rating of ‘9.1’ and ‘Result3.2’ has a rating of ‘6.2’ associated with ‘SuccinctQuery1’. A rating of a result associated with a succinct query may affect the probability that a result will be provided to a user. A higher rating of a result for a succinct query may increase a probability that the result will be presented to a user responsive to a query matching the succinct query.

As illustrated in FIG. 6, an exemplary result record 600 is provided, of which one or more may be associated with or resident in the search database 120 (FIG. 1). The result record 600 may include a result ID field 605, a result guide ID field 610, a result content information field 615, a result resource ID field 620, a result usage information field 625, a result time stamp field 630, and a result category ID 635.

The result ID field 605 preferably contains a unique identifier of a result, which is preferably used consistently. For example, in at least one embodiment, the result ID field 605 can include a randomly generated numerical code, and/or a text string indicating a name associated with a result. A result ID serves to distinguish the result record associated with a result from a result record associated with other results. Other unique identifiers of a result may be utilized without departing from the spirit and scope of the embodiments. In at least one embodiment, a result ID may include a description associated with a result. Using the example illustrated in FIG. 6, ‘Result3.2’ is the result ID associated with the result record 600.

The result guide ID field 610 may include information of a guide associated with a result. For example, a guide who obtained a search result may be indicated in the result guide ID field 610. In at least one embodiment a guide ID associated with a guide who has voted on or selected a result may be indicated in the result guide ID field 610. Information contained in the result guide ID field 610 may be used to obtain information regarding a guide associated with a search result based on a record such as the guide record 300a (FIG. 3). Using the example illustrated in FIG. 6, ‘Specialist4’ is associated with ‘Result3.2’ which may indicate that ‘Specialist4’ has provided ‘Result3.2’.

The result content information field 615 may include information of content of a search result. For example, a text snippet associated with a search result may be indicated in the result content information field 615. A URL and/or other information associated with a search result may be indicated in the result content information field 615. Information contained in the result content information field 615 may be used to provide a search result to a user and/or a guide. Any type of information which may be used to provide a result may be indicated in the result content information field 615. Using the example illustrated in FIG. 6, the text snippet ‘In 2008, the subway delivered over 1.623 billion rides, averaging over five million on weekdays, 2.9 million on Saturdays, and 2.3 million on Sundays.’ is associated with ‘Result3.2’. This may indicate that the text snippet ‘In 2008, the subway delivered over 1.623 billion rides, averaging over five million on weekdays, 2.9 million on Saturdays, and 2.3 million on Sundays.’ may be provided to a user if ‘Result3.2’ is selected to be presented to a user.

The result resource ID field 620 may include information of a resource associated with a result. For example, a URL associated with a web page from which a text snippet was obtained may be indicated in the result resource ID field 620. A URL and/or other information such as a search query and/or a macro instruction associated with a search resource may be indicated in the result resource ID field 620. Information contained in the result resource ID field 620 may be used to provide access to a search resource for a guide and/or the search system 130 (FIG. 1). Using the example illustrated in FIG. 6, ‘Resource2’ is the result resource ID associated with ‘Result3.2’. This may indicate that ‘Resource2’ was used to obtain ‘Result3.2’.

The result usage information field 625 may include information regarding use of a search result. For example, a number of times that a search result has been presented to a user may be indicated in the result usage information field 625. Using the example illustrated in FIG. 6, the indicator ‘use counter=120’ is associated with ‘Result3.2’. This may indicate that ‘Result3.2’ has been presented to a user one hundred twenty times. Likewise, the result usage information field may indicate relative usage information. For example, if a search result is selected by an expediter, 90% of the time it is provided to an expediter, this may be indicated in the result usage information field 625. As illustrated in FIG. 6, ‘reuse percentage=85%’ in the result usage information field 625 may indicate that a result has been reused in eighty-five percent of the instances when it was presented to a guide and/or a user. Information in the result usage information field 625 may be utilized to determine whether a search result is to be reviewed, may be used to determine compensation, etc. The result usage information field 625 may include information regarding whether a result has been associated with a sponsor or advertiser and/or provided based on sponsorship. For example, if a result has been obtained using a resource provided by an advertiser, a guide and/or the search system 130 (FIG. 1) may be compensated by the advertiser based on information indicated in the result usage information field 625. For example if ‘Resource2’ included listings by restaurants which were provided by a listing service, the listing service might compensate a guide and/or a provider of the search system 130 (FIG. 1) based on delivery of a listing to a user. Similarly, if ‘Result3.2’ is provided by a resource which is compensated on a usage basis such as a database or data feed which provides private data, information indicated in the result usage information field 625 may be used to determine compensation for a provider of the resource.

The result time stamp field 630 may include information of time associated with a result. For example, a date, time, etc., which may indicate when a result was obtained, reviewed, etc., may be indicated in the result time stamp field. An older time stamp associated with a search result may affect a rating or ranking of a result. Using the example in FIG. 6, the time stamp ‘Jun. 11, 2009’ is associated with ‘Result3.2’.

The result category ID field 635 may include information of a category associated with a result. For example, if a query is associated with a category, and a search result is produced responsive to the query, the category associated with the query may be associated with the result. Association of a result with a category may be used for various purposes. In at least one embodiment, a category associated with a result may affect a ranking of a resource associated with the category. For example if a result associated with a category is obtained using a resource, a ranking of the resource associated with a category may be increased. In at least one embodiment, if a keyword is associated with a result and a query, a category associated with the result may be more likely to be associated with the query. Using the example in FIG. 6, the category ‘Travel>MassTransit>NewYork’ is associated with ‘Result3.2’.

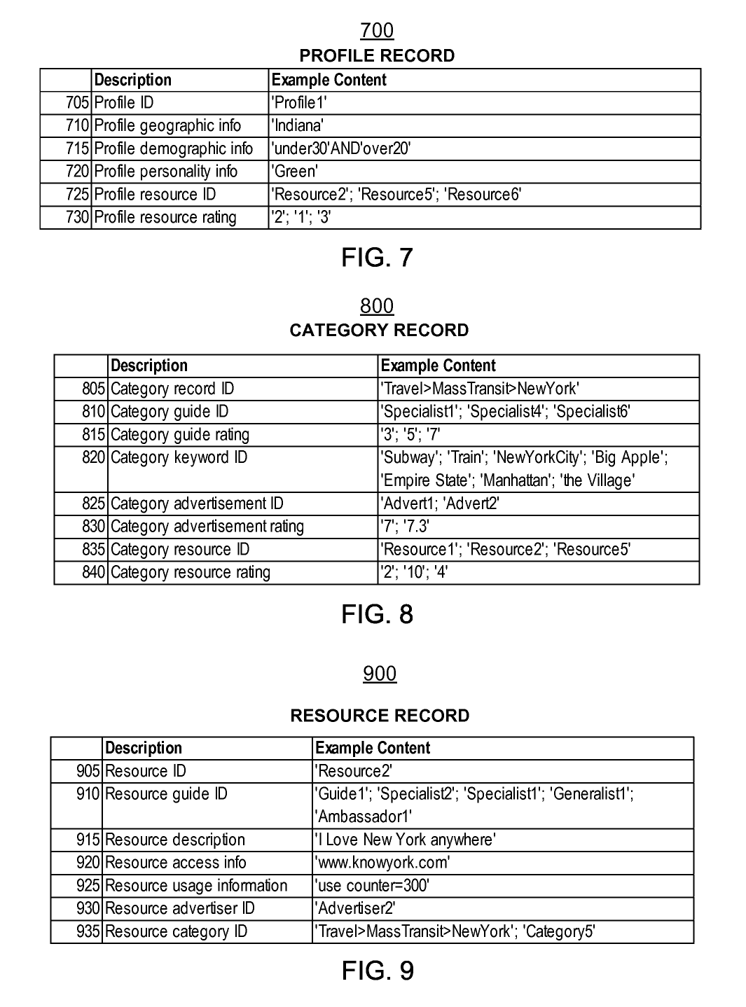

As illustrated in FIG. 7, an exemplary profile record 700 is provided, of which one or more may be associated with or resident in the database 120 (FIG. 1). The profile record 700 may include a profile ID field 705, a profile geographic information field 710, a profile demographic information field 715, a profile personality information field 720, a profile resource ID field 725, and a profile resource rating field 730.

The profile ID field 705 preferably contains a unique identifier of a profile, which is preferably used consistently. For example, in at least one embodiment, the profile ID field 705 can include a randomly generated numerical code, and/or a text string indicating a name associated with a profile. A profile ID serves to distinguish a profile record associated with a profile from a profile record associated with other profiles. Other unique identifiers of a profile may be utilized without departing from the spirit and scope of the embodiments. In at least one embodiment, a profile ID may include a description associated with a profile. Using the example illustrated in FIG. 7, ‘Profile1’ is the profile ID associated with the profile record 700.

The profile geographic information field 710 may include geographic information associated with a profile. Any type of geographic information may be indicated in the profile geographic information field 710. For example, GPS coordinates, a street address, a neighborhood name, a postal code, a city name, a state name, etc., could be indicated in the profile geographic information field 710. Using the example illustrated in FIG. 7, the geographic information ‘Indiana’ is associated with ‘Profile1’. This may indicate, for example, that a person with a home address in and/or other profile information associated with geographic information of the state of ‘Indiana’ may match ‘Profile1’, or may receive a higher rating and/or ranking associated with ‘Profile1’.

The profile demographic information field 715 may include demographic information associated with a profile. Any type of demographic information may be indicated in the profile demographic information field 715. For example, date of birth, sex, race, political affiliation, income, number of children, marital status, membership in organizations, etc., could be indicated in the profile demographic information field 715. Using the example illustrated in FIG. 7, the demographic information ‘under30’AND‘over20’ is associated with ‘Profile1’. This may indicate that a person aged greater than 20 years and less than 30 years may receive a higher rating and/or ranking associated with ‘Profile1’.

The profile personality information field 720 may include personality information associated with a profile. Any type of personality information may be indicated in the profile personality information field 720. For example, information of personality traits such as aggressiveness, curiosity, friendliness, intelligence, honesty, food preference, music preference, political affiliation, etc., could be indicated in the profile personality information field 720. Using the example illustrated in FIG. 7, the characteristic ‘Green’ is associated with ‘Profile1’. This may indicate that persons with an interest in ‘Green’ may receive a higher rating and/or ranking associated with ‘Profile1’.

The profile resource ID field 725 may include information of a resource associated with a profile. For example, if a resource is used to respond to queries associated with a profile, an indicator of the resource may be indicated in the profile resource ID field 725. Information indicated in the profile resource ID field 725 may be used to obtain information associated with a resource using a record such as the resource record 900 (FIG. 9). Using the example illustrated in FIG. 7, ‘Resource2’, ‘Resource5’, and ‘Resource6’ have been associated with ‘Profile1’.

The profile resource rating field 730 may include information regarding a rating of a resource associated with a profile. In at least one embodiment, the profile resource ID field 725 and the profile resource rating field 730 are linked by, for example, a pointer. Using the example illustrated in FIG. 7, ‘Resource2’ has a rating of ‘2’, ‘Resource5’ has a rating of ‘1’, and ‘Resource6’ has a rating of ‘3’. Content of the profile resource ID field 725 and the profile resource rating field 730 may be used at least in part to determine an order in which a resource is presented and/or utilized responsive to a request, a voting activity, a review activity, or other types of tasks and/or activities associated with a profile. Using the example illustrated in FIG. 7, ‘Resource5’ might be preferentially utilized for a request associated with ‘Profile1’. Any number of resources may be associated with a profile.

While a resource ranking associated with a profile has been used for the purposes of illustration, any type of item may be rated and/or ranked when associated with a profile. For example, a result, an advertisement, a category, a guide, a user, etc., may be ranked and/or rated associated with a profile. Using the example in FIG. 2, ‘User1’ may match ‘Profile1’, which may increase the likelihood that ‘Resource5’ may be selected to provide a result responsive to ‘Request1’. For example, ‘Resource5’ might provide information of weather suited for persons matching ‘Profile1’.

As illustrated in FIG. 8, an exemplary category record 800 is provided, of which one or more may be associated with or resident in the database 120 (FIG. 1). The category record 800 may include a category record ID field 805, a category guide ID field 810, a category guide rating field 815, a category keyword ID field 820, a category advertisement ID field 825, a category advertisement rating field 830, a category resource ID field 835, and a category resource rating field 840.

The category record ID field 805 contains an identifier of a category, which is preferably unique and preferably used consistently. For example, in at least one embodiment, the category record ID field 805 can include a randomly generated numerical code and/or a character string indicating a category. A category record ID serves to distinguish a category record associated with a category from a category record associated with other categories. Although particular examples of identifiers are described herein, other types of identifiers uniquely indicating a category may be utilized without departing from the spirit and scope of the embodiments herein. In at least one embodiment, a description of a proper path may be included in the content of the category record ID field 805. A category record ID may include a category description, a random numeric code, and/or any other information uniquely identifying an element within a data structure. Using the example in FIG. 8, ‘Travel>MassTransit>NewYork’ is the category record ID associated with the category record 800.

The category guide ID field 810 may include a number of identifiers associated with a guide. The category guide ID 810 may include one or more identifiers of a guide which may be used to obtain further information of a guide using a record such as the guide record 300 (FIG. 3). Using the example in FIG. 8, ‘Specialist1’, ‘Specialist4’ and ‘Specialist6’ have been associated with ‘Travel>MassTransit>NewYork’. While only a few guide identifiers have been illustrated in FIG. 8, any number of guide identifiers may be associated with a category. Association of a guide with a category may indicate that a guide has registered to respond to requests associated with the category, and/or that a guide may recommend, review, edit and/or otherwise associate information with the category.

The category guide rating field 815 may include information of a number of ratings associated with a guide. For example, the category guide rating field 815 may include a rating of a guide based on a result produced by a guide responsive to a request associated with the category identified in the category record ID field 805. In at least one embodiment, the category guide ID field 810 and the category guide rating field 815 may be linked by, for example, a pointer. Using the example illustrated in FIG. 8, ‘Specialist1’ has the rating ‘3’, ‘Specialist 4’ has the rating ‘5’ and ‘Specialist 6’ has the rating ‘7’ associated with ‘Travel>MassTransit>NewYork’. This may indicate that the guide ‘Specialist 6’ has the highest rating and might be selected first to respond to a request associated with ‘Travel>MassTransit>NewYork’. A rating or ranking of a guide may be determined based on any information indicated in the database 120 (FIG. 1).

The category keyword ID field 820 may include information of a number of keywords associated with the category indicated in the category record ID field 805. The information indicated in the category keyword ID field 820 may be compared to information indicated in a search request in order to associate a request with a category. For example, if a keyword is associated with content of a request, a ranking of a category associated with the keyword may be increased, which may make the category more likely to be associated with the request. For example, if a keyword indicated in a query is a match to a keyword indicated in the category keyword ID field 820, the category may be presented to a guide or an ambassador responding to a request. Any number of keywords may be associated with a category. Content of the category keyword ID field 820 may be determined based on activities of guides, users, system administrators, etc. Using the example in FIG. 8, the keywords ‘Subway’, ‘Train’, ‘NewYorkCity’, ‘Big Apple’, ‘Empire State’, ‘Manhattan’, and ‘the Village’ are associated with ‘Travel>MassTransit>NewYork’, which may cause ‘Travel>MassTransit>NewYork’ to be more likely to be associated with a request including those keywords.

The category advertisement ID field 825 may include a number of identifiers associated with an advertisement which may be associated with a category. Using the example in FIG. 8, the advertisement IDs ‘Advert1’ and ‘Advert2’ have been associated with the category record 800, which may indicate that the advertisements ‘Advert1’ and ‘Advert2’ may be presented to a guide and/or a user responsive to a request associated with Travel>MassTransit>NewYork'. While only a few advertisement identifiers have been illustrated in FIG. 8, any number of advertisement identifiers may be associated with a category.

The category advertisement rating field 830 may include information of one or more ratings associated with an advertisement. For example, the category advertisement rating field 830 may include a rating of an advertisement based at least in part on frequency of selection of an advertisement by a guide responsive to search requests associated with the category identified in the category record ID field 805. In at least one embodiment, the category advertisement ID field 825 and the category advertisement rating field 830 may be linked by, for example, a pointer. Using the example illustrated in FIG. 8, the rating ‘7’ has been associated with ‘Advert1’ and the rating ‘7.3’ has been associated with ‘Advert2’. This may indicate that ‘Advert2’ has the highest rating and might be more likely to be selected responsive to a request associated with ‘Travel>MassTransit>NewYork’.

The category resource ID field 835 may include one or more identifiers of a resource which may be associated with a category. Using the example in FIG. 8, the resources ‘Resource1’, ‘Resource2’, and ‘Resource5’ have been associated with ‘Travel>MassTransit>NewYork’. While only a few resource identifiers have been illustrated in FIG. 8, any number of resource identifiers may be associated with a category. In at least one embodiment, a resource associated with a category may be related to an advertiser and/or may be distributed to a guide associated with a category and an advertiser.

The category resource rating field 840 may include information of one or more ratings associated with a resource. For example, the category resource rating field 840 may include a rating of a resource based at least in part on frequency of use of a resource by a guide responsive to request associated with the category identified in the category record ID field 805. A rating of a resource may be based on any information indicated in the database 120 (FIG. 1). In at least one embodiment, the category resource ID field 835 and the category resource rating field 840 may be linked by, for example, a pointer. Using the example illustrated in FIG. 8, the rating ‘2’ has been associated with ‘Resource1’, the rating ‘10’ has been associated with ‘Resource2’ and the rating ‘4’ has been associated with ‘Resource5’. This may indicate that ‘Resource2’ may be more likely to be selected responsive to a request associated with ‘Travel>MassTransit>NewYork’. Any type of rating information may be included in a rating field such as the category resource rating field 840.

As illustrated in FIG. 9, an exemplary resource record 900 is provided, of which one or more may be associated with or resident in the database 120 (FIG. 1). The resource record 900 may include a resource ID field 905, a resource guide ID field 910, a resource description field 915, a resource access information field 920, a resource usage information field 925, a resource advertiser ID field 930 and a resource category ID field 935.

The resource ID field 905 preferably contains a unique identifier of a resource, which is preferably used consistently. For example, in at least one embodiment, the resource ID field 905 can include a randomly generated numerical code, and/or a string indicating a name associated with a resource. A resource ID serves to distinguish the resource record associated with a resource from a resource record associated with other resources. Other unique identifiers of a resource may be utilized without departing from the spirit and scope of the embodiments. In at least one embodiment, a resource ID may include a description associated with a resource. Using the example illustrated in FIG. 9, ‘Resource2’ is the resource ID associated with the resource record 900.

The resource guide ID field 910 may include information of a guide associated with a resource. For example, a guide who utilized a search resource may be indicated in the resource guide ID field 910. In at least one embodiment, a guide ID associated with a guide who has voted on and/or selected a result associated with a resource may be indicated in the resource guide ID field 910. Information contained in the resource guide ID field 910 may be used to obtain information regarding a guide associated with a search resource based on records such as the guide record 300a (FIG. 3). Any number of guides may be associated with a resource. Using the example illustrated in FIG. 9, ‘Guide1’, ‘Specialist2’, ‘Specialist1’, ‘Generalist1’, and ‘Ambassador1’ are associated with the resource ‘Resource2’ which may for example indicate that “Guide1’, ‘Specialist2’, ‘Specialist1’, ‘Generalist1’, and ‘Ambassador1’ may access ‘Resource2’.

The resource description field 915 may include information of a description of a search resource. For example, a text snippet associated with a search resource may be indicated in the resource description field 915. A URL and/or other information associated with a search resource may be indicated in the resource description field 915. Information contained in the resource description field 915 may be used to provide a description of search resource to a user and/or a guide. Using the example illustrated in FIG. 9, the text snippet ‘I Love New York anywhere’ is associated with the resource ‘Resource2’.

The resource access information field 920 may include access information associated with a resource. For example, a URL associated with a web page may be indicated in the resource access information field 920. A password, a login ID, a template for submitting a search query, an API for submitting and/or receiving information and/or any other information which may be utilized to access a resource may be indicated in the resource access information field 920. Information contained in the resource access information field 920 may be used to provide access to a resource for a guide, a user and/or the search system 130 (FIG. 1). Using the example illustrated in FIG. 9, the URL ‘www.knowyork.com’ is the access information associated with the resource ‘Resource2’. This may, for example, indicate that a result associated with ‘Resource2’ may be obtained using the resources found at ‘www.knowyork.com’.

The resource usage information field 925 may include information regarding use of a resource. For example, a number of times that a search resource has been utilized by a guide, an automated search, an API, etc., may be indicated in the resource usage information field 925. Using the example illustrated in FIG. 9, the indicator ‘use counter=300’ is associated with ‘Resource2’. This may indicate that ‘Resource2’ has been utilized three hundred times. Information in the resource usage information field 925 may be utilized to determine whether a search resource is to be reviewed, a ranking and/or rating associated with a resource, compensation, etc., of a resource. Any type of usage information may be recorded regarding any item.

The resource advertiser ID field 930 may include information regarding an advertiser associated with a resource. For example, an advertiser who may provide a resource and/or may designate a resource for use for any purpose may be indicated in the resource advertiser ID field 930. Using the example illustrated in FIG. 9, ‘Advertiser2’ is associated with ‘Resource2’. This may indicate that ‘Resource2’ has been designated as a resource which may be utilized by a guide and/or the search system to obtain a search result associated with ‘Advertiser2’. Information in the resource advertiser ID field 930 may be utilized at least in part to determine whether a search resource is to be provided to a guide and/or a ranking and/or rating associated with a resource, etc. For example if a sponsored result is to be obtained for a request, resources associated with the sponsor ‘Advertiser2’ may be ranked higher than resources which are not associated with a sponsor.

The resource category ID field 935 may include information regarding a category associated with a resource. For example, a category which may be used to rank a resource may be indicated in the resource category ID field 935. Using the example illustrated in FIG. 9, “Travel>MassTransit>NewYork’ and ‘Category5’ are associated with ‘Resource2’. This may indicate that ‘Resource2’ has been designated as a resource which may be utilized by a guide and/or the search system to obtain a search result associated with “Travel>MassTransit>NewYork’ and ‘Category5’. Information in the resource category ID field 935 may be utilized at least in part to determine whether a search resource is to be provided to a guide and/or a ranking and/or rating associated with a resource, etc. For example, if a category is associated with a request, a resource may be presented to a guide responding to the request in an order based on a ranking of a resource associated with the category.

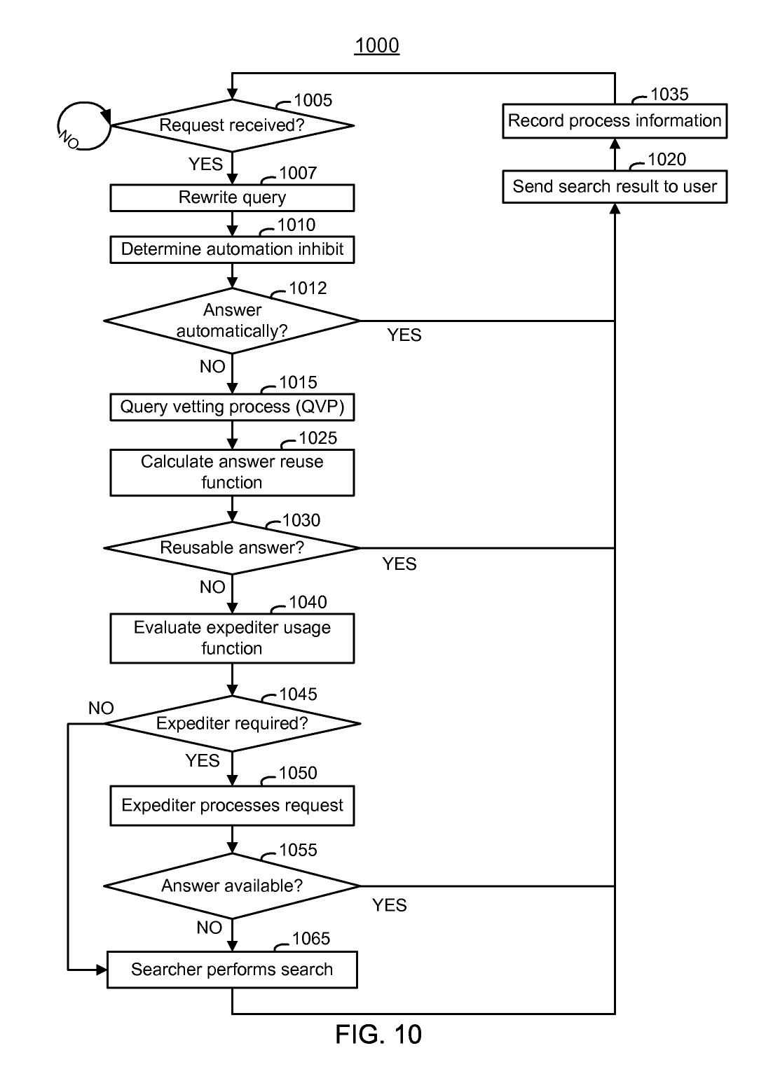

A process 1000 for responding to a user request is illustrated in FIG. 10. The process 1000 may be operative on any suitable element of the system 100 (FIG. 1). In at least one embodiment, the process 1000 is operative on a server associated with the search system 130.

In operation 1005, a determination is made as to whether a request is received. If in operation 1005 it is determined that a request is not received, control remains at operation 1005 and process 1000 continues. If in operation 1005 it is determined that a request is received, control is passed to operation 1007 and process 1000 continues.

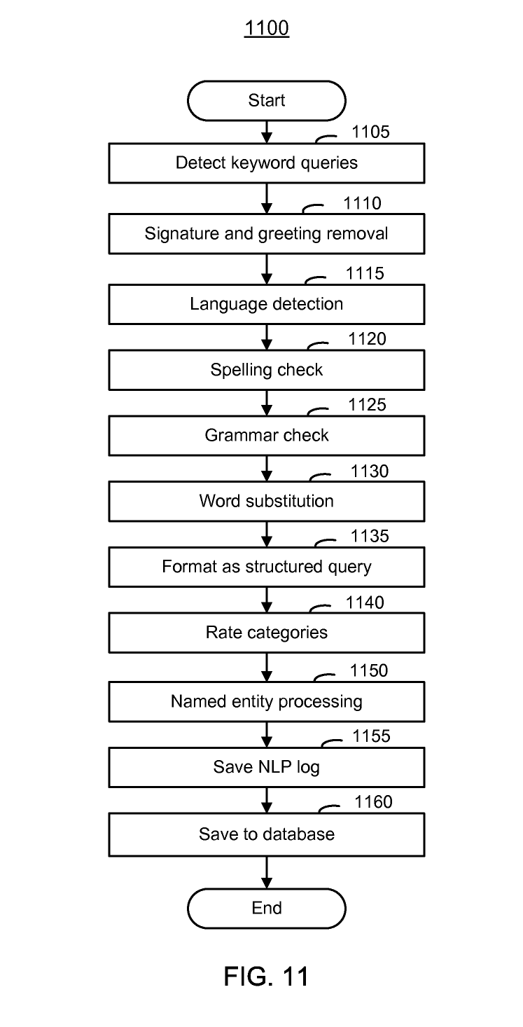

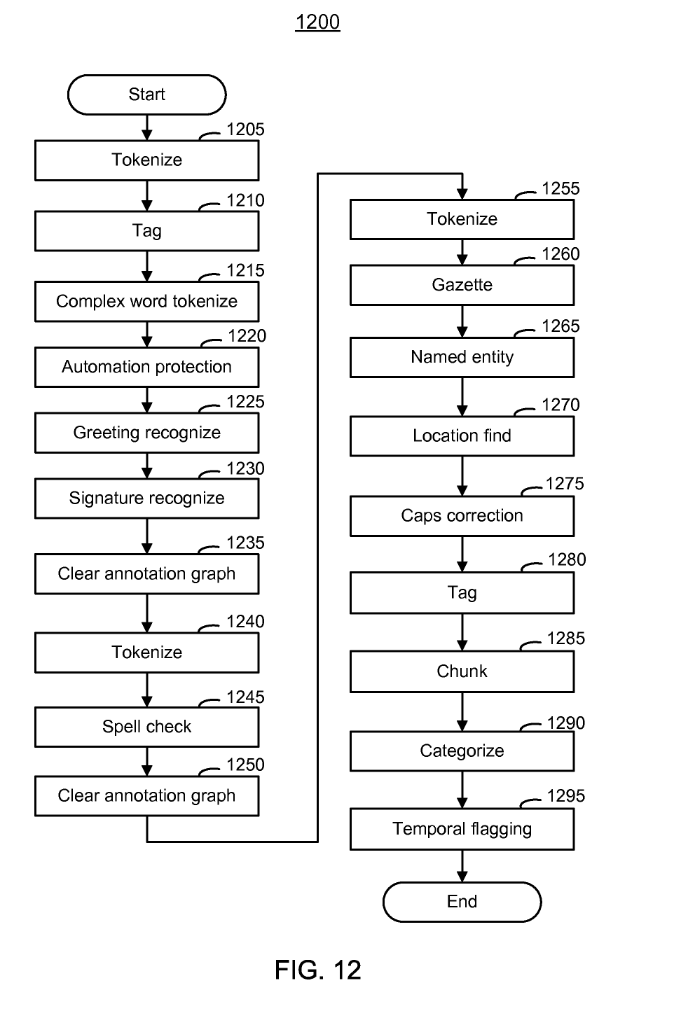

In operation 1007, a query is rewritten. A raw query may have been converted from speech to text in order that processing may be applied. Processes for rewriting a query are further described herein below with respect to FIG. 11 and FIG. 12. Control is passed to operation 1010 and process 1000 continues.

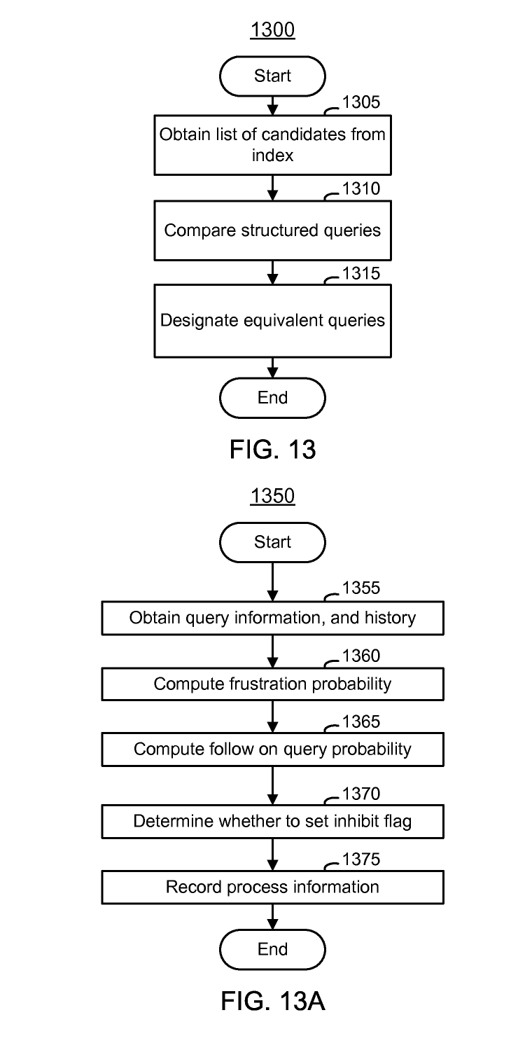

In operation 1010 automation inhibition is determined. It may be desirable that a query is not answered without a review by a guide under some circumstances. For example, a user may be frustrated, may be responding to a previous answer, and/or may require a human response for any reason. In such an instance, an adjustment may be made to the thresholds which are applied to determine whether an automated response to a query is acceptable. A process of evaluating whether an automated response to a query is to be inhibited is further described herein with respect to FIG. 13A. In at least one embodiment, an automated response may be prevented. Control is passed to operation 1012 and process 1000 continues.

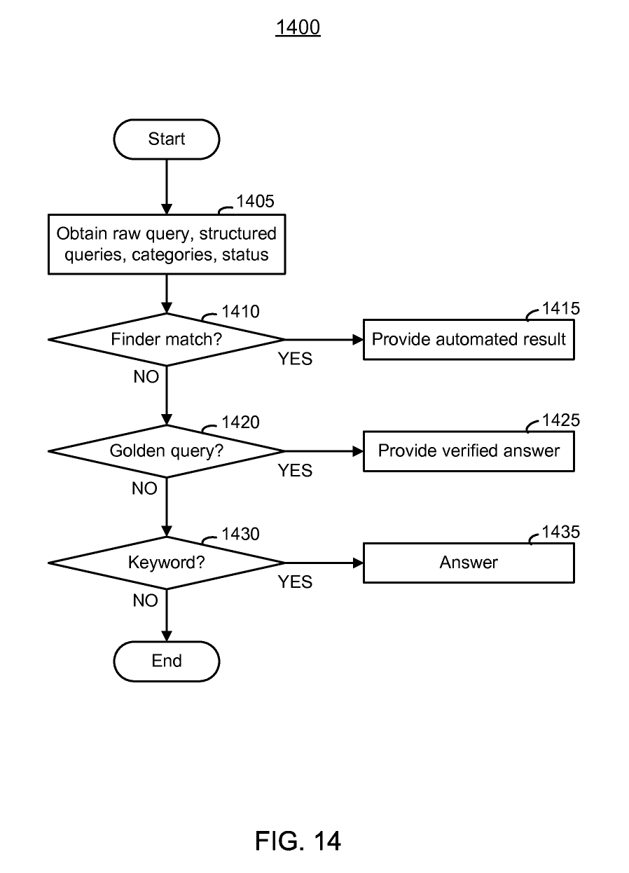

In operation 1012, a determination is made as to whether a request may be answered automatically. If in operation 1012 it is determined that a request may be answered automatically, control is passed to operation 1020 and process 1000 continues. If in operation 1012 it is determined that a request may not be answered automatically, control is passed to operation 1015 and process 1000 continues. In at least one embodiment, it may be determined that a search result such as an advertisement, etc., may be provided automatically while a search result which might include an answer to a user query, a search resource, etc., might require further processing. A process for determining whether a request may be answered automatically is further described herein with respect to FIG. 14.

In operation 1015, a query vetting process (QVP) is applied to a query. An algorithm for query vetting is further described with respect to FIG. 13 herein below. Control is passed to operation 1025 and process 1000 continues.

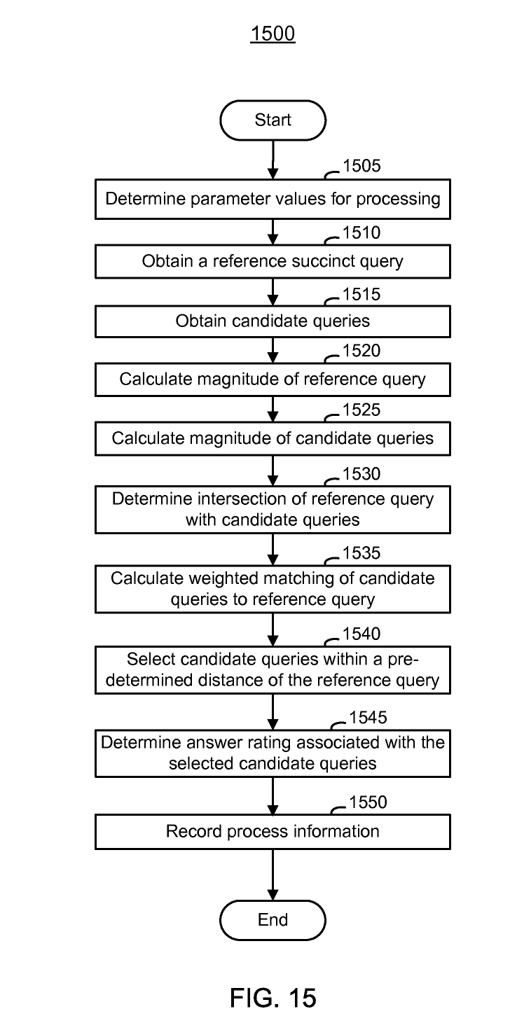

In operation 1025, an answer reuse function is evaluated. A process and functionality for determining a probability that a reusable answer responsive to a user request is available is further described herein with respect to FIG. 15. Control is passed to operation 1030 and process 1000 continues.

In operation 1030, a determination is made as to whether a reusable answer is available. If in operation 1030 it is determined that a reusable answer is available, control is passed to operation 1020 and process 1000 continues. If in operation 1030 it is determined that a reusable answer is not available, control is passed to operation 1040 and process 1000 continues.

In operation 1020, a search result is provided to a user. A search result may be provided to a user using any communication service associated with a user. A search result may be provided using multiple communication services. Any number and/or type of search results may be provided. For example, an automated result and a human assisted result might be provided together, and/or sequentially. Control is passed to operation 1035 and process 1000 continues.

In operation 1040, an expediter usage function is evaluated. A process and functionality for determining a probability that an expediter is to be used is further described herein with respect to FIG. 15. Control is passed to operation 1045 and process 1000 continues.

In operation 1045, a determination is made as to whether an expediter is required to process a request. If in operation 1045 it is determined that an expediter is required to process a request, control is passed to operation 1050 and process 1000 continues. If in operation 1045 it is determined that an expediter is not required to process a request, control is passed to operation 1065 and process 1000 continues.

In operation 1050, an expediter processes a request. Processing of a request by an expediter is further described herein. An expediter may categorize a request, may form a structured or succinct query responsive to a request, may identify a type of automated processing which may respond to a request, may select an answer to a user request, may designate location and/or other information associated with a request, etc. An answer reuse function may be evaluated based on the results of processing by the expediter. A weighting of factors in an answer reuse determination may be altered in order to adjust for human processing versus automated processing. An automated answer based on information provided by an expediter may be determined. Control is passed to operation 1055 and process 1000 continues.

In operation 1055, a determination is made as to whether an answer is available to a user request. If in operation 1055 it is determined that an answer is available to a user request, control is passed to operation 1020 and process 1000 continues. If in operation 1055 it is determined that an answer is not available to a user request, control is passed to operation 1065 and process 1000 continues.

In operation 1065, a searcher performs a search for information. The searcher may be selected based on any suitable criteria. In at least one embodiment, a highest ranking searcher associated with a category associated with a request is selected and is provided with search resources associated with information of the request such as a category, keyword, location, profile, etc. Control is passed to operation 1020 and process 1000 continues.

In operation 1035, information of the process 1000 is recorded. In at least one embodiment, information of a request and a search result may be recorded in the database 120 (FIG. 1). Any information associated with the process 1000 may be recorded such as ratings of an answer, an expediter, a category, a structured query, a user, a resource, a searcher, a keyword, etc. Control is passed to operation 1005 and process 1000 continues.

As illustrated in FIG. 11, a process 1100 for query formation and improvement is provided. The process 1100 may be operative on any suitable element of the system 100 (FIG. 1). In at least one embodiment, the process 1100 is operative on a server associated with the search system 130.

In operation 1105, keyword recognition is performed. Some queries such as SMS, MMS, email, voice, or IM based queries may include a keyword based response. For example, a keyword may be associated with an advertisement, or other user response. If a query is determined to consist of a keyword, processes such as spell checking versus a library of keywords, etc., may be performed. A keyword may include multiple words and/or phrases. For example, if a keyword is associated with a particular system response a query which begins with that keyword may be excluded from processing. Likewise, a query which conforms to a query template after NLP may be selected for an automated response. For example, if a user submitted the query ‘wether 46038’, the corrected version ‘weather 46038’ might be automatically processed. Likewise a query such as ‘stok nfs’, which might be corrected to ‘stock nfs’, could be automatically processed. A dictionary which includes keywords associated with system actions may be implemented. Control is passed to operation 1110 and process 1100 continues.

In operation 1110, signature and greeting removal is performed. Some types of queries such as SMS, MMS, email, or IM based queries may include template information which must be removed in order to effectively determine user intent. For example, a user may have a signature message which is automatically added to an email or SMS message. As this is easily detected by a human assistant, if an expediter identifies such content in a first message from a user, subsequent messages may have the identified content removed without the use of an expediter. Likewise, standard signatures and/or greetings which contain elements such as phone numbers, etc., might be detected and removed from content of a request. Control is passed to operation 1115 and process 1100 continues.

In at least one embodiment, a user history may be used to detect a signature and/or greeting associated with a query. As a user will typically insert a signature or greeting automatically in a message, a statistical model may be used to detect a signature. For example, if a user has submitted a predetermined number of requests, trailing characters of a request may be compared to the trailing characters of previous requests. A match between the trailing characters of a current request to trailing characters of a predetermined number of requests may be used to determine that a group of characters is a signature which may be removed from the request prior to processing of the request. The predetermined number of queries which are examined may allow the system to adapt when a signature is changed. Greeting removal may operate in a similar manner to signature removal by examining leading characters of a request. A Bayesian model may be used to predict a probability that a given group of characters is a signature.

In operation 1115, language detection is performed. Various types of language detection algorithms may be applied. For example, Language Detection in Unknown, International Conference on Computational Linguistics, Proc. of the 18th Conf. on Computational Linguistics 2, Saarbrücken, Germany, 1021-1025 (2000), describes a typical algorithm, or, alternatively, S. Li and K Momoi, A Composite Approach to Language/encoding Detection, Proc. of the 19th Intl Unicode Conf., sfr-fresh.com (2001) also provides a description of a typical algorithm. As the search system may recognize an individual user, such an algorithm might be applied over a query history, and/or may be influenced by factors such as profile information, area code, etc., which may be associated with a user. Control is passed to operation 1120 and process 1100 continues.

In operation 1120, a spelling check is performed. Spelling check is performed using well known techniques such as word comparison and phrase comparison based on the language detected in operation 1115. If language detection results were ambiguous, a spelling check versus more than one dictionary may be performed, and language detection may be repeated based on results of the probable spelling corrections. Control is passed to operation 1125 and process 1100 continues.

In operation 1125, a grammar check is performed. Grammar check is performed using well known techniques such as an annotation graph. For example, Steven Bird, et al., ATLAS: A Flexible and Extensible Architecture for Linguistic Annotation, (Submitted 13 Jul. 2000), describes a software tool for producing and using annotation graphs. Tools such as the OpenNLP tokenizer or Abiword might be used to perform grammar checking and correction. Control is passed to operation 1130 and process 1100 continues.

In operation 1130, a word substitution is performed. Word substitution is a process of replacing common abbreviations and/or slang forms of speech with an alternate form of the word or words. For example ‘b4’ might be replaced with ‘before’, or ‘u’ might be replaced with ‘you’, etc. Such a process may include factors which may be tailored to a user based on factors such as profile information (e.g., regional information, demographic, etc.) and/or query history information, etc. Control is passed to operation 1135 and process 1100 continues.

In operation 1135, a query is formatted as a structured query. Such a process may be performed by semantic processing of a query. For example, a query may be created by converting a statement into a question, e.g., ‘it will rain today’ might be reconstructed as ‘what is the chance of rain today?’. Likewise, a raw query might be compared to a database of raw queries which have been associated with a succinct query by a guide and/or automatically. For example, an entity relationship diagram may be constructed of a raw query, which may be reformulated to produce a succinct query. Control is passed to operation 1140 and process 1100 continues.

In operation 1140, categories associated with a query are rated. An exemplary algorithm for selecting and rating a categorization associated with a query is T. Kardkov, et. al., The Ferrety Algorithm for the KDD Cup 2005 Problem, 7 SIGKDD Explorer Newsletter no. 2, issue 1931-0145 at 111-116 (2005), and Shruti K. Bhandari and Brian D. Davison, Leveraging Search Engine Results for Query Classification, LU-CSE-07-013, Dept. of Comp. Sci. and Eng., Lehigh Univ. (2007). The search system may have a taxonomy for categorization, which is customized in order to index a guide community. Training of a classification algorithm based on query classification information provided by guides may be used. A Bayesian model for determination of a category may be constructed based on a query history. Control is passed to operation 1150 and process 1100 continues.

In operation 1150, named entity processing is performed. Named entity processing techniques are well known in the art. For example, Erik F. Tjong and Kim Sang, Introduction to the CoNLL-2002 Shared Task: Language-Independent name Entity Recognition, http://acl.ldc.upenn.edu/coling2002/workshops/data/w11/w11-24.pdf, describes a typical process and method for performing named entity processing. In particular the search system 130 (FIG. 1) may access a database of named entities which may be included in the database 120, and/or may be an external search resource. Control is passed to operation 1155 (FIG. 11) and process 1100 continues.

In operation 1155, information associated with the NLP operations performed in conjunction with the process 1100 is recorded in the database 120 (FIG. 1). For example, results of the processes, the confidence and/or probability factors associated with various versions of a query, etc., which may be shared with other processes and/or may be used to evaluate training and efficacy of a particular parametric tuning, etc. may be recorded. Control is passed to operation 1160 and process 1100 continues.

In operation 1160, information associated with a query is updated. A query record such as the request record 200a (FIG. 2) may be updated to reflect categorizations, a succinct query, keywords, and/or rating and/or ranking information which is determined based on the process 1100 (FIG. 11). Process 1100 terminates and control is passed back to the parent process.

While the process 1100 has been described in a particular sequence, no limitation is implied thereby. Any or all of the operations in the process 1100 may be performed in any suitable sequence and/or may be performed in parallel, which may permit alternate interpretations of a query to be determined and compared in order to select a highest ranked interpretation.

As illustrated in FIG. 12, an alternate process for vetting of a raw query is provided. The process 1200 may be operative on any suitable element of the system 100 (FIG. 1). In at least one embodiment, the process 1200 is operative on a server associated with the search system 130.

In operation 1205, tokenizing is performed. Elements of a raw query are identified and converted into ‘tokens’ which may be processed further to determine syntax, parts of speech, etc. For example, a contractions such as “isn't” and “can't” are tokenized as “is” “not” and “can” “not” respectively. Control is passed to operation 1210 and process 1200 continues.

In operation 1210, tagging is performed. Tokens identified in a raw query are associated with a part of speech tag, which may be stored as, for example, annotations of the tokens. Tokens may also be tagged as possible stemming candidates. Control is passed to operation 1215 and process 1200 continues.

In operation 1215, complex word tokenizing is performed. As previously noted, with respect to FIG. 11, certain elements of a message may be unique syntax. For example, so-called “emoticons” which are composed of three characters may be tokenized as three punctuation marks. Complex word tokenizing recognizes these special cases. In at least one embodiment, a regular expression (RegEx) based algorithm is used to recognize such cases. These expressions may be tagged as a specific part of speech and/or meaningless. Control is passed to operation 1220 and process 1200 continues.

In operation 1220, automation protection is performed. As previously noted, with respect to FIG. 11, keywords and/or other expressions which are not valid dictionary words may be included in a message intentionally by a user. For example, automation protection may use a RegEx algorithm to detect a special instance and identify it as meaningless in order that subsequent processes will not process a token. Control is passed to operation 1225 and process 1200 continues.

In operation 1225, greeting recognition is performed. As previously noted, with respect to FIG. 11, various forms of irrelevant and/or redundant information may be included in request content. Expressions which may be commonly recognized such as ‘hello folks’, ‘hey bud’, ‘Hi ChaCha’, etc. may be recognized using an algorithm and tagged as a token not to be processed. Control is passed to operation 1230 and process 1200 continues.

In operation 1230, signature recognition is performed. As previously noted, with respect to FIG. 11, various forms of irrelevant and/or redundant information may be included in request content. Signatures which may be commonly recognized such as ‘Wally’ or ‘Peace and Love’ may be recognized using an algorithm and tagged as a token not to be processed. Control is passed to operation 1235 and process 1200 continues.

In operation 1235, the annotation graph is cleared. Annotations associated with a query are deleted. This may exclude text which is marked as skip, and any text which includes the alternate text designation. This may allow the re-writing process (RWP) to review a query without needing to review a node graph with greater complexity. Control is passed to operation 1240 and process 1200 continues.

In operation 1240, tokenizing is performed. Spell checking generally requires that a query be tokenized in order to determine the correct parts of speech and morphology of speech parts. The tokenizing process identifies each word, word group, and sentence where applicable, and identifies a syntactic relationship of the words. Words are tagged as parts of speech, and relationships are annotated. In at least one embodiment, if a query has been received as an SMS message, word substitution may be performed using a specialized group of grammar rules. For example, the word ‘two’, ‘to’, and/or ‘too’ may be substituted in instances wherein grammar correction would be provided by such a substitution. Similarly common homophones such as ‘4’ in place of ‘for’, or ‘1’ in place of ‘won’ may be detected and corrected. In at least one embodiment, if a query is received from a device which is determined to be using a numeric to text conversion process such as Nuance's T9, or Motorola's iTap, or which may use small form factor keyboards may use spelling corrections which are suited to the text entry method of the device. Control is passed to operation 1245 and process 1200 continues.

In operation 1245, a spelling and grammar check is performed. Spelling and grammar are compared to a standard corpus of relevant (e.g. English) words and sentences. One such example is the OpenNLPSpelling Checker, but other spelling and grammar correction methods known in the art may be applied. Control is passed to operation 1250 and process 1200 continues.

In operation 1250, the annotation graph is cleared. Clearing the annotation graph may be used to allow an improved processing of a query after spelling and grammar checking is complete. Control is passed to operation 1255 and process 1200 continues.

In operation 1255, tokenizing is performed. For example, the OpenNLPTokenizer may be applied. Control is passed to operation 1260 and process 1200 continues.

In operation 1260, a gazette function is performed. A gazette function is the process of querying a database to determine whether a token corresponds to an entity in a gazette. A “gazette” may be any published and/or unpublished list of characters which may be annotated. For example, the CIA world fact-book, the US Geological Survey, yellow pages, etc., may be used as a gazette for a gazette function. A statistical weighting may be applied to determine a probability of a match between a name returned by a gazette and a token identified in a request. A match between a token and an entity in a gazette may be used to correct and/or annotate a token. Control is passed to operation 1265 and process 1200 continues.

In operation 1265, named entity analysis is performed. A named entity may be a person, such as a celebrity, or other person, a location such as a city, neighborhood, etc., a sports team, a business, etc. A named entity may be determined based on annotation information provided by and/or a resource associated with a gazette. Control is passed to operation 1270 and process 1200 continues.

In operation 1270, a location associated with a query may be determined. If a user has provided location information, a location is associated with a query by a user device, or a named entity is associated with a location, the location may be associated with a query. In at least one embodiment, probability of a match of a token of a request to a named entity may be affected by a location associated with a request. Control is passed to operation 1275 and process 1200 continues.

In operation 1275, capitals correction is performed. If a token has not been recognized as a named entity, capitals may be removed. If a token has been determined to match a named entity or other gazette item, capital letters may be modified according to the gazette information. If more than one sentence has been detected, capitalization may be modified according to grammar rules of an appropriate language. Control is passed to operation 1280 and process 1200 continues.

In operation 1280, tagging is performed. Tagging is based on analysis of tokens subsequent to corrections and named entity/gazette labeling. Control is passed to operation 1285 and process 1200 continues.

In operation 1285, chunking is performed. “Chunking” is construction of elements which span one or more words. A chunk may include items such as noun phrases, verb phrases, domain specific elements such as mathematical equations, abbreviations, etc. Control is passed to operation 1290 and process 1200 continues.

In operation 1290 a query categorization may optionally be performed. A query may be categorized in various ways. For example, the tokens and/or the annotation graph of a query may be used to query an index of categories to determine a most likely category associated with a query. In at least one embodiment, an index is created associated with a taxonomy which is used to determine a category to be associated with a rewritten query. Control is passed to operation 1295 and process 1200 continues.

In operation 1295 temporal flagging is performed. Temporal flagging is a process intended to determine if a query is time sensitive based on content of a query. For example, if a query is phrased in the past tense, it may be less likely to be determined to be temporally sensitive. Similarly if a query includes present tense phrasing, or phrases such as ‘new’, ‘now’, etc. a probability of temporal sensitivity may be increased. Presence or absence of named entities may be used to determine temporal sensitivity. For example, a query regarding a sports team during the regular season for the team may be more likely to be determined to be a temporally sensitive query than a query about the sports team during the off-season. A final annotation graph of a rewritten query is stored. For example, information of the annotation graph, alternate forms of a rewritten query, temporal flagging, categorization, etc., may be stored in association with a request in the database 120. Process 1200 terminates and control is passed back to the parent process.

As previously discussed, answer reuse is important to success of a human-assisted search system as it directly impacts cost, quality and economic viability of the system. In order that a previous search result may be provided responsive to a request, it is necessary to meet a combination of conditions. The request must be sufficiently close to a request for which a search result is available, and the available search result must be of sufficient quality. A criterion for matching and/or for quality of a search result may change based on the nature of a request and the type of search result.

For example, a search resource, an advertisement, a game, an answer, contact information for a supplier of items and/or services, etc. may have different quality criteria. Quality rating of a resource might be based on the reliability of providing information. Quality rating of an advertisement might be based on fit with a category and/or payment by an advertiser. Quality rating of a game might be based on a match to keyword and/or profile information associated with previous purchases. Quality rating of an answer may be based on ratings by guides, rating of a guide, etc.

Similarly to the quality rating, matching to a query may have different criteria for different types of search results. For example, a search result such as an advertisement might be provided if matching is less exact, while a search result, such as an answer to a question, might be provided if matching is more exact. To determine whether an answer is to be reused, a function which describes the level of matching between a query and a reference query with which a search result is needed. In at least one embodiment, software which implements the evaluation is referred to as the “Answer Reuse Process” (ARP). An ARP evaluation function is used to determine whether an answer is to be reused as further described herein.

Actions of guides and users responsive to results produced by the NLP process may be used to tune various elements of the performance of the NLP algorithms. For example, data of acceptance of a structured query by expediters may be used to determine the weighting given to words and/or phrases when constructing a structured query. Similarly, language detection, named entity processing, spelling correction, etc., may be modified based on actions of guides. Such activities may for example allow NLP, speech recognition, and/or other forms of automated conversion of requests to be personalized to a user without the need for a user to make such corrections. As discussed further herein below, an expediter and/or other guide may be provided with alternate versions of a rewritten query and the original query, and a selection of the guide may be obtained.

The search database 120 (FIG. 1) may include information of previous queries, which may include a structured query associated with the previous queries, and previous search results associated with the requests and the structured query. In order to access answers associated with a previous query, an index may be created and/or maintained of previous structured queries. An index of structured query records may be created using a facility such as Lucene, Egothor, and/or other proprietary and/or open source indexing facilities. The index may return a number of structured queries from the index based on ranking of the queries for an input query. However, as the result set must be limited, and the number of answers associated with each candidate query is unknown, it is desirable to reduce redundancy in a dataset returned.

As illustrated in FIG. 13, a process 1300 for aggregation of results associated with structured queries is provided. The process 1300 may be operative on, for example, a server associated with the search system 130 (FIG. 1).

In operation 1305 (FIG. 13), candidate structured queries are obtained from the index. The candidate structured queries are selected based on an index of structured queries associated with keywords of a request. For example, a set of tokens associated with a query from the RWP 1200 (FIG. 12) may be used to query the index of structured queries, and a list of structured queries may be provided. An index to a query is provided along with a ranking, which is a relative ranking by its nature, as is well known in the Information Retrieval literature. Control is passed to operation 1310 and process 1300 continues.

In operation 1310, structured queries associated with a request are compared. For example, a difference or ‘distance’ function representing the linguistic separation between queries may be determined. In at least one embodiment, a structured query may be processed by the process 1200 (FIG. 12). A distance algorithm may include comparison of nouns, noun phrases, verbs, stop words, etc., within an annotation graph of succinct queries. In at least one embodiment, a succinct query which conforms to a template which includes a keyword of the raw query may be used as a reference to normalize the distance function. Any linguistic distance function may be applied. In at least one embodiment, the Lucene similarity ranking is used to determine a distance function. Control is passed to operation 1315 and process 1300 continues.

In operation 1315, equivalent structured queries are designated. For example, succinct queries within a specified distance of a reference succinct query may be designated to be equivalent. Equivalence relationships may be recorded. For example, a request record indicated in the database 120 (FIG. 1) may be modified to indicate a structured query associated with a request, and any associated structured queries may be recorded in the database 120 in association with for example a search result such as an answer, a resource, etc. Process 1300 (FIG. 13) terminates and control is passed back to the parent process.

A process 1350 for determining whether an automated response is to be inhibited for a query is illustrated in FIG. 13A. The process 1350 may be operative in whole or in part on any suitable element of the system 100 (FIG. 1). In at least one embodiment, the process 1350 is operative on the search system 130.

In operation 1355 query information and history is obtained. For example, content of a query and a query history of a user and/or a searcher associated with a query may be obtained from the database 120. Any information associated with a query may be obtained, such as a rating of a search result, a rating of a guide, a profile of a user, etc. Control is passed to operation 1360 and process 1350 continues.

In operation 1360 a probability that a query is associated with frustration is determined. Frustration is a condition whereby a user has expressed dissatisfaction with previous answers. Various criteria may be used to determine frustration. A query may be compared to a database of stored queries to determine whether the query matches previous queries which have been identified as frustrated. In particular, items such as repetition of an identical query, keywords, phrases, etc. indicating dissatisfaction, query length, time between a query and a previous query, whether a previous response is based on a stored and/or automated response, a quality rating associated with a previous response, etc. may be used to determine a probability that a query is associated with frustration. Control is passed to operation 1365 and process 1350 continues.

In operation 1365 a probability that a query is a follow on query is determined. A follow on query is a query which is related to a previous query. For example, a user might want to know additional information regarding a person or topic associated with a prior query or answer, or may want to obtain information as a continuation of a previous answer which was truncated for any reason. Queries which refer to information not indicated in the query may be referred to as exophora, and may be intractable for automated processing. For this reason, an automated or stored response may be of low relevance and/or quality. A person may be readily able to resolve such conflicts and may not need to perform extensive searching to respond well to the query. Determination of follow on query probability may be performed based on various criteria such as a category and/or keywords of a previous query and/or search result, keywords of a query, magnitude of a query, etc. In at lease one embodiment, a Bayesian model which is constructed based on previous follow on queries is used to evaluate a probability that a query is a follow on query. Determination of follow-on queries may be particularly important for short queries. For example, short queries such as “Yes”, “More”, “Another”, etc. would be very likely to match an existing response, but a stored result would be unlikely to satisfy the customer's expectations. Detection of specific types of follow-on queries using RegEx pattern matching may allow a prior query and/or answer to be user to respond to a follow on query either automatically and/or using a person. Control is passed to operation 1370 and process 1350 continues.

In operation 1370 a determination is made as to whether an automation inhibition variable is to be set. If a frustration probability and/or a follow on probability is determined to be above a threshold, an indicator that automated processing is to be inhibited may be activated. Activation of an automation inhibit indication may cause a query to be directed to a person. For example, if automation is inhibited, a guide receiving a query may be notified of the reason that an automation inhibition was triggered, and/or the nature of the problem as detected automatically. Control is passed to operation 1375 and process 1350 continues.

In operation 1375, process information is recorded. For example information of a query, a user, probability of a follow-on and/or frustrated query, etc., may be recorded in the database 120 (FIG. 1). In at least one embodiment, queries which were within a predetermined value of a threshold for activating an automation inhibit flag may be identified for future evaluation. Any information associated with the process 1350 may be recorded. Control is passed back to the parent process and process 1350 terminates.

While the examples of follow on queries and frustration queries have been used to illustrate processing which may cause automated processing of a query to be inhibited, other types of detections based on analysis of a query may be used to inhibit and/or modify a probability of the use of automation within the scope and spirit of the embodiments herein.

As illustrated in FIG. 14, a process 1400 for determining whether an automated response may be provided to a request is illustrated. The Auto Guide Process (AGP) 1400 may be operative on, for example, a server associated with the search system 130 (FIG. 1). While a limited number of matching processes are depicted in FIG. 14 for the purposes of illustration, any number of matching processes might be used to implement the embodiments. The matching processes are described using a detector function such as operation 1410 and an answer process 1415 associated with the detector. However, one of ordinary skill in the relevant art would immediately recognize that an answer generator might be directly invoked. Likewise, the serial depiction of the detection operations should not be construed to limit the embodiments. Any of the detection functions might be performed in any order, and/or in parallel, which results may be used to determine whether and which type of answer process is to be utilized. For example, if more than one match is detected, resolution of an action may be based on factors such as user history, comparison of an original query to a rewritten query, a type of response action, cost factors, etc.

In operation 1405, information of a request is obtained. For example, information such as a raw query, structured queries, categories, current state of processing, and/or other information of a request may be obtained. Status information associated with a request may affect decision thresholds, etc., associated with the process 1400. For example, if a transcriber and/or an expediter guide reviewed a query, a decision by the guide may affect the decision process. For example, if a guide has determined that a keyword match exists, a keyword based response may take priority over other possible responses and/or may have a higher probability of matching a keyword even if the match is not exact. Likewise, if extensive modification of a raw query has occurred during automated processing to produce a succinct query, a matching threshold may be raised. Control is passed to operation 1410 and process 1400 continues.

In operation 1410, a determination is made as to whether an automated resource may be used to respond to a request. If in operation 1410 it is determined that an automated resource may be used to respond to a request, control is passed to operation 1415 and process 1400 continues. If in operation 1410 it is determined that an automated resource may not be used to respond to a request, control is passed to operation 1420 and process 1400 continues.

The determination in operation 1410 may be made using various criteria. In at least one embodiment, a match of succinct queries associated with automated resources is used to determine whether an automated resource may be used to respond to a request. Information associated with a request may affect the probability that an automated resource may be used to respond to a request. For example, if an automated resource is not highly ranked associated with a category associated with a request, the probability that the automated resource may be used to respond to a request may be reduced. A category may be associated with a request based on actions of a guide such as an expediter and/or transcriber. A category may be associated with a request based on a named entity. For example, a category may be based at least in part on a gazette which matched a term in a request.

In operation 1415, a result associated with a selected automated resource is provided, process information is recorded, process 1400 terminates and control is passed back to the parent process. In at least one embodiment, a database look-up is performed to obtain a response. In at least one embodiment, a response is dynamically determined by a resource.

In operation 1420, a determination is made as to whether a query is a match to a query associated with a verified result or “golden” query. If in operation 1420 it is determined that a query is not a match to a query associated with a verified result control is passed to operation 1430 and process 1400 continues. If in operation 1420 it is determined that a query is a match to a query associated with a verified result, control is passed to operation 1425 and process 1400 continues.

The determination in operation 1420 may be made using various criteria. A verified answer is an answer which has been determined to have a very high confidence of being a correct response to one or more queries. A golden query is a query associated with a verified answer. In particular, a database of verified answers and associated queries may be created and maintained. Such responses have a high quality rating, which may permit a lower matching threshold to be used to determine if such a result is to be provided responsive to a query. A matching evaluator function may be adjusted based on information such as a profile associated with a request. In at least one embodiment, a set of Regular Expression (RegEx) rules as is well known in the art may be applied to various succinct queries to determine if the succinct query is a match to a golden query.

In operation 1425, a result associated with a golden query is provided, process information is recorded, process 1400 terminates and control is passed back to the parent process. In at least one embodiment, a succinct query may be associated with a golden query based on an action of an expediter. For example, if an expediter selects an answer associated with a golden query responsive to a user request which is associated with a succinct query, a response associated with the golden query may be associated with the succinct query automatically for future requests which are associated with the succinct query.

In operation 1430, a determination is made as to whether a query is a match to a keyword. If in operation 1430 it is determined that a query is a not match to a keyword, process information is recorded and process 1400 terminates. If in operation 1430 it is determined that a query is a match to a keyword, control is passed to operation 1435 and process 1400 continues.

The determination in operation 1430 may be made using various criteria. A vetted query may be compared to a keyword table associated with a user, advertising, and/or other response keywords. A rewritten query, a raw query and/or an associated succinct query may be compared to a keyword which is associated with a request. For example, if a rewritten query matches a keyword, but a raw query does not, a spelling algorithm based on a data entry mode of a user may be applied. In such an instance, a request submitted by a user of a T1 predictive text system might have a different matching probability for a given spelling error than a request by a user of a “QWERTY’ keyboard device.

In operation 1435, a result associated with a keyword is provided, process information is recorded, process 1400 terminates and control is passed back to the parent process. In at least one embodiment, an action associated with a keyword is executed.

As illustrated in FIG. 15, a process 1500 for determining whether a reusable search result responsive to a request is available is provided. The process 1500 may be operative on a server associated with the search system 130 (FIG. 1). The process 1500 may be referred to as the Answer Reuse Process (ARP).

In operation 1505 (FIG. 15), a parameter for a reuse evaluation function, such as those described herein above, are determined. For example, if an answer reuse function is to be evaluated in operation 1030 (FIG. 10), a parameter may be adjusted due to the lack of human intervention in the processing of the query. Likewise if a guide such as an expediter, searcher, and/or transcriber has processed a query, a parameter may be modified. For example, a decision level and computations elements in operations 1050 and 1055 may be different than those used in operation 1025 and 1030. Control is passed to operation 1510 (FIG. 15) and process 1500 continues.

In operation 1510, a reference succinct query is obtained. A reference succinct query may include a result of processing of a raw query by the RWP. A category may be associated with a reference query. In at least one embodiment, the reference succinct query is the result of RWP processing of a user raw query. In at least one embodiment, a reference succinct query is a succinct query defined by an expediter. Control is passed to operation 1515 and process 1500 continues.

In operation 1515, candidate succinct queries are obtained. For example, a number of succinct queries and categories which are identified by the process 1300 (FIG. 13) may be obtained. In at least one embodiment, the QVP may provide such information to the ARP. Succinct queries may be selected based at least in part on content of search results associated with the succinct queries. For example, a ranking of succinct queries may include weighting of keywords and/or content of search results associated with the succinct queries. Control is passed to operation 1520 (FIG. 15) and process 1500 continues.

In operation 1520, the magnitude of the reference query is determined. For example, the total number of tokens and/or total length of the reference succinct query may be determined in order to normalize comparison to a candidate succinct query. Control is passed to operation 1525 and process 1500 continues.

In operation 1525, the magnitude of candidate succinct queries is determined. A candidate succinct query magnitude may be compared to the magnitude of a reference succinct query in order to determine whether a match to a reference succinct query is acceptable. For example, if a succinct query has a large magnitude, it may be less likely to be determined to match a reference succinct query with a comparatively small magnitude. If a reference query has a large magnitude, a match to a query of similar magnitude may be allowed to include a percentage of errors based on the magnitude of the reference query. Control is passed to operation 1530 and process 1500 continues.

In operation 1530, the intersection of a reference succinct query with a candidate succinct query is determined. For example, tokens indicated in a reference succinct query may be compared to tokens indicated in a candidate succinct query to determine if there is a match of the tokens. A token match may be based on stemming. A token match may be based on named entities. In at least one embodiment, all candidate succinct queries have been processed by the RWP, and have a homogeneous tokenizing process. Control is passed to operation 1535 and process 1500 continues.

In operation 1535, a weighted matching is calculated for the candidate succinct queries. A weighted matching may modify a match. For example, if a named entity is matched, it may have a high weight, while a ‘stop’ word such as ‘and’ or ‘is’ may have a low weighting. A mismatch which includes a particular word such as ‘not’ may affect a matching. In general nouns and noun phrases may have a high weighting. A match of a part of speech with an equivalent synonym may be used to determine weighting. Any type of suitable weighting of matching may be used to calculate an overall distance between a candidate succinct query and a reference succinct query. Control is passed to operation 1540 and process 1500 continues.

In operation 1540, candidate succinct queries which are within a pre-determined distance of a reference succinct query are selected. The allowable distance may be parameter which is determined in for example, operation 1505. The distance function may be based at least in part on the matching of the candidate succinct query and the reference succinct query. In at least one embodiment, a category associated with a succinct query may influence a distance function calculation. For example, if an expediter has associated a category with a candidate succinct query, and the category is associated with a high percentage of answers associated with a candidate succinct query, the candidate succinct query may be determined to be at a closer distance to the reference succinct query. Control is passed to operation 1545 and process 1500 continues.

In operation 1545, a rating of an answer associated with the selected candidate succinct query is determined. An answer score is calculated to determine whether an answer is suitable to be re-served. An answer score may be based on various criteria. In at least one embodiment, factors such as reuse of the answer by expediters, opinions of guides and/or users regarding an answer, temporal factors (i.e. age, time since last re-use, temporal sensitivity associated with a category, and/or a query), a category (i.e. does a category of an answer match a category of a query), an administrative rating (i.e. designation as a verified result), etc., may be used to determine a rating of an answer. In at least one embodiment, answer ratings may be normalized to values between zero (lowest) and one (highest), in which case factors affecting ratings may be weighted. In at least one embodiment, a category is associated with a succinct query based a category which is most commonly associated with the succinct query. An answer rating may be affected if it is not associated with the category of the succinct query. Control is passed to operation 1550 and process 1500 continues.

In operation 1550 process information is recorded. Process information including a reference query and a number of matching queries may be recorded. A rating and/or ranking of answers associated with succinct queries matching a reference query may be recorded. In at least one embodiment, information of the process 1500 is recorded in the database 120 (FIG. 1). Process 1500 terminates and control is passed back to the parent process.

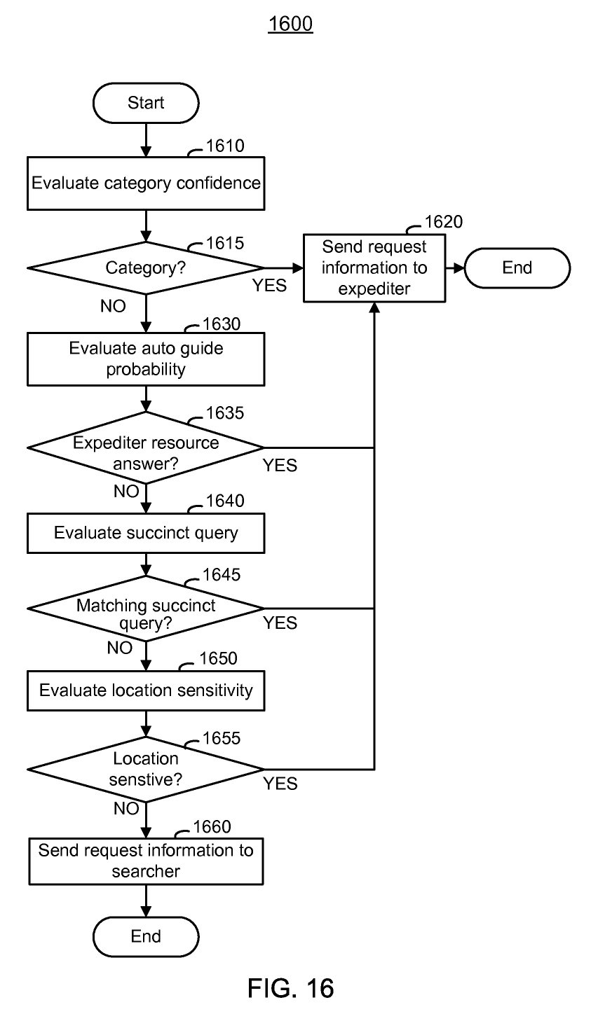

As illustrated in FIG. 16, a process 1600 for determining whether a request is to be directed to an expediter or ambassador is provided. The process 1600 may, for example, be operative on a server associated with the search system 130 (FIG. 1).

In operation 1610 (FIG. 16), category confidence is evaluated. For example, a category may have been associated with a query based on a keyword matching of a query with an ontology of keywords associated with a taxonomy. Category matching to a query may be based on various factors, similar to the query to query matching criteria. For example, a match of a named entity such as a sports team, or a celebrity may be more likely to produce a high category confidence for a short query than a keyword match in a long query. In such an instance a category confidence level may be determined. Similarly, if an expediter has previously assigned a category to a query matching the query, a category confidence may be high. Control is passed to operation 1615 and process 1600 continues.

In operation 1615, a determination is made as to whether an expediter is required to select a category to be associated with a request. If in operation 1615, it is determined that an expediter is required to select a category to be associated with a request, control is passed to operation 1620 and process 1600 continues. If in operation 1615, it is determined that an expediter is not required to select a category to be associated with a request, control is passed to operation 1630 and process 1600 continues.

By determining if a category associated with a query is uncertain, a query may be routed to an expediter to allow a query to be vetted by a person prior to further processing by automated and/or human-assisted means.

In operation 1630, a function which measures the probability that a programmatic response from a search resource may be used to respond to a request is evaluated. For example, a query may be analyzed to determine if it may be mapped to an API available to provide information such as weather, sports scores, etc. Likewise, keywords of a request may be examined in order to determine the probability that a response from an expediter can be used. An evaluation function may be applied to a query structure associated with a resource and a query. A rewritten query may be compared with a group of regular expressions, and/or a vocabulary associated with an automated resource. An operation such as that in operation 1012 (FIG. 10) may be performed. However, a different threshold of acceptance, or a different weighting of factors may be applied, as an expediter may be more able to map a request to a response than an automated system. Control is passed to operation 1635 and process 1600 continues.

In operation 1635, a determination is made as to whether an expediter may provide a response to a request using a resource. If in operation 1635, it is determined that an expediter may provide a response to a request using a resource, control is passed to operation 1620 and process 1600 continues. If in operation 1635 it is determined that an expediter may not provide a response to a request using a resource, control is passed to operation 1640 and process 1600 continues.

By determining if an expediter is likely to be able to produce a response using an automated resource, a query which is not able to be processed by automated means may be processed by an expediter quickly, rather than being sent to a searcher to answer. This may provide a more effective blending of human intelligence between full automation and full human search. For example, an expediter may make a selection between alternatives which are determined automatically.

In operation 1640, a match to a succinct query is evaluated. For example, a function such as that used in the QVP and/or the ARP may be used to determine whether a reference succinct query is a close match to an existing succinct query. Control is passed to operation 1645 and process 1600 continues.

In operation 1645, a determination is made as to whether a matching succinct query is available. If in operation 1645 it is determined that a matching succinct query is available, control is passed to operation 1620 and process 1600 continues. If in operation 1645 it is determined that a matching succinct query is not available, control is passed to operation 1650 and process 1600 continues.

By determining if a succinct query is a rough match to an existing succinct query, it may be that an expediter is not used for a novel query. Likewise, if a match is approximate and perhaps insufficient for automated reuse, an expediter may be able to select a result from existing results, and/or determine that an existing answer associated with a query may be of poor quality. Such processing may avoid a searcher performing a search unnecessarily while allowing a poor quality answer to be removed from the database 120 (FIG. 1) using human intelligence of an expediter.

In operation 1650, location sensitivity of a query is evaluated. For example, if a user request includes words which imply location such as ‘here’, ‘there’, etc. (i.e. exophora), or named entities such as street names, city names, etc., a location sensitivity function may be affected by such content. Exophora terms may have a high weighting for sensitivity, place names might have a medium weighting, etc. Magnitude of a query may influence a determination of location sensitivity. Profile information associated with a user may affect location sensitivity of a query. Control is passed to operation 1655 and process 1600 continues.

In operation 1655, a determination is made as to whether a query is location sensitive. If in operation 1655 it is determined that a query is location sensitive, control is passed to operation 1620 and process 1600 continues. If in operation 1655 it is determined that a query is not location sensitive, control is passed to operation 1660 and process 1600 continues.

In operation 1660, information of a request is sent to a searcher. As a request has been appropriately prepared by the preprocessing, it is not necessary for an expediter to respond to the request. A searcher may be selected based on a categorization, succinct query, profile, and/or other information associated with a request. It should be noted that time required for processing a query may be reduced as a searcher may be responding to well formed queries in the searcher's area of interest. Control is passed back to the parent process and process 1600 terminates.

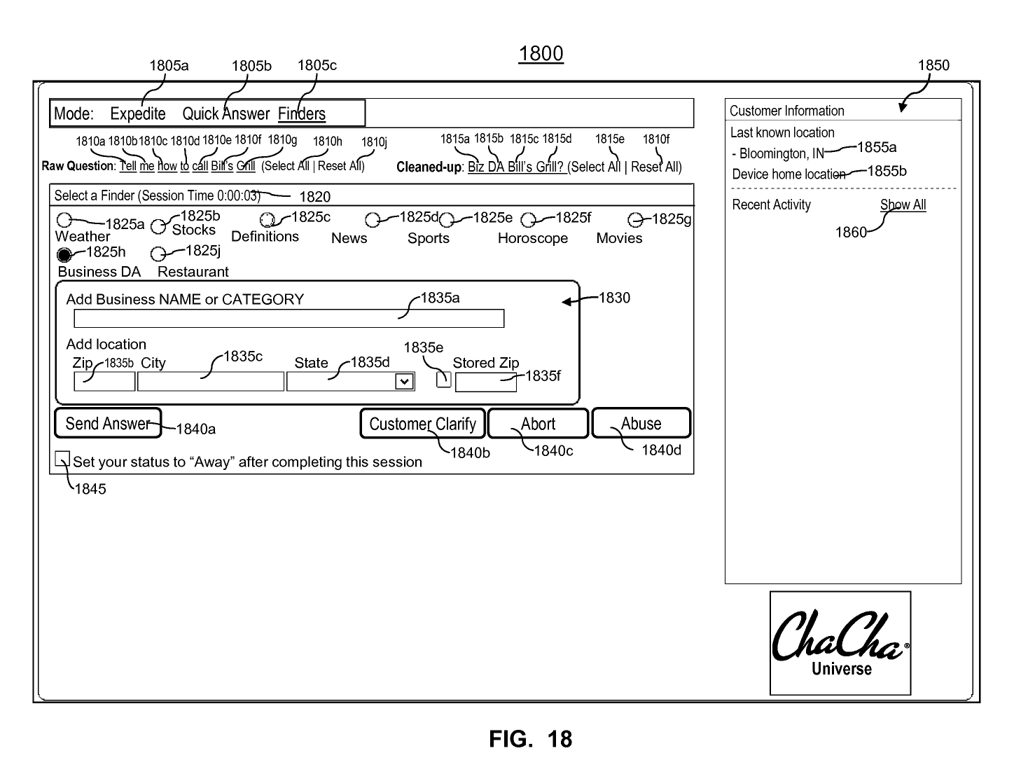

In operation 1620, information of a request is sent to an expediter. As a query has been evaluated to determine the nature of the request an expediter may be selected more effectively. An expediter may further be provided with a toolset which is adapted to a most likely response to a query. As such, an expediter may be able to process a request more rapidly and with fewer errors. An exemplary set of tools for processing of a query by an expediter is illustrated herein below with respect to FIGS. 18 to 23. Control is passed back to the parent process and process 1600 terminates.

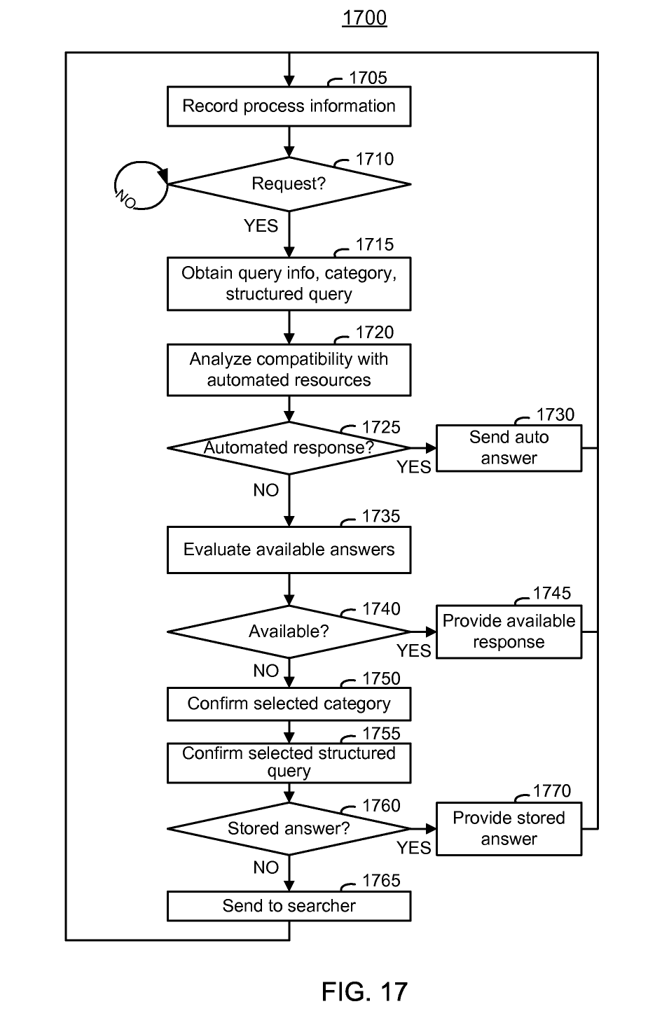

As illustrated in FIG. 17, a process 1700 for qualifying a query by an expediter is provided. The process 1700 may be performed automatically, and/or may be performed using the assistance of a guide in any or all operations. The process 1700 may be operative on any suitable element of the system 100 (FIG. 1). In at least one embodiment, the process 1700 is operative on a server associated with the search system 130.

In operation 1710, a determination is made as to whether a request is received. If in operation 1710 it is determined that a request is not received, control remains at operation 1710 and process 1700 continues. If in operation 1710 it is determined that a request is received, control is passed to operation 1715 and process 1700 continues.

In operation 1715, information of a query including a category and a structured query is obtained. Any information associated with a query may be obtained. For example, a location, a user history, etc., associated with a query may be obtained. In at least one embodiment, information of a request is provided to an ambassador or expediter guide. Control is passed to operation 1720 and process 1700 continues.

In operation 1720, information of a query is analyzed for compatibility with automated resources. For example, databases, or information feeds which may provide a response may be examined. A function may be evaluated to determine if a query may be answered by an automated process. In at least one embodiment, information of a query is provided to an expediter who may evaluate the ability to respond using a resource. Control is passed to operation 1725 and process 1700 continues.

In operation 1725, a determination is made as to whether an automated resource may respond to a request. If in operation 1725 it is determined that a resource may respond to a request, control is passed to operation 1730 and process 1700 continues. If in operation 1725 it is determined that a resource may not respond to a request control is passed to operation 1735 and process 1700 continues.

In operation 1730, an automated response is sent. For example, a database, news feed, RSS feed, a translation service, a music recognition service, and/or other system which may provide a response to a user request may provide information to a user may be provided with information of a request and may respond to the search system 130 (FIG. 1) and/or to a user system. In at least one embodiment rating information of a result provided may be obtained. Control is passed to operation 1705 and process 1700 continues.

In operation 1735, available answers are evaluated. Information of a query may be analyzed to determine suitability of an existing answer to be used to respond to a request. For example, a function such as the ARP function may be evaluated to determine if a query may be answered by a stored result. In at least one embodiment, information of a query is provided to an expediter who may evaluate the ability to respond using an existing answer. For example, stored succinct queries and/or answers determined to match a query may be provided to an expediter based on a ranking of the queries and/or answers. In at least one embodiment, if an expediter elects to change a query and/or a category associated with the query, the QVP and ARP functions may be reevaluated at the discretion of the expediter or ambassador. This may allow the expediter to conveniently search for an answer to a modified query without the need to send a query to a searcher. Control is passed to operation 1740 and process 1700 continues.

In operation 1740, a determination is made as to whether an available answer may be used to respond to a request. If in operation 1740 it is determined that an available answer may be used to respond to a request, control is passed to operation 1745 and process 1700 continues. If in operation 1740 it is determined that an available answer may not be used to respond to a request control is passed to operation 1750 and process 1700 continues.

In operation 1745, an available response to a request is provided. For example, an answer indicated in the database 120 (FIG. 1) may be provided to a user. Rating information may be obtained based on actions of a user and/or a guide. For example, if an expediter has selected an answer to be provided to a user, a ranking and/or rating of the answer may be increased. Control is passed to operation 1705 (FIG. 17) and process 1700 continues.

In operation 1750, information of a category associated with a request is confirmed. In at least one embodiment, an expediter may confirm a category associated with a request. For example, an expediter may be required to confirm that a category assigned to a request automatically is correct. Control is passed to operation 1755 and process 1700 continues.

In operation 1755, information of a succinct query associated with a request is confirmed. In at least one embodiment, an expediter may confirm and/or determine a succinct query associated with a request. For example, an expediter may be required to activate a control selecting elements of a query to cause a transfer of a query to a guide to be performed. Control is passed to operation 1760 and process 1700 continues.

In operation 1760, a determination is made as to whether a stored answer may be used to respond to a request. If in operation 1760 it is determined that a stored answer may be used to respond to a request, control is passed to operation 1770 and process 1700 continues. If in operation 1760 it is determined that a stored answer may not be used to respond to a request, control is passed to operation 1765 and process 1700 continues.

The determination in operation 1760 may be made based on various criteria. In at least one embodiment, a system administrator may select an option which determines that a stored answer may not be used in operation 1760. In at least one embodiment, an expediter may override a determination made automatically. For example, if a stored query is found to exactly match a succinct query, a guide may indicate that a stored response is not acceptable.

In operation 1770, a stored response to a request is provided. For example, an answer indicated in the database 120 (FIG. 1) may be provided to a user. Rating information may be obtained based on actions of a user and/or a guide. For example, if an expediter has selected an answer to be provided to a user, a ranking and/or rating of the answer may be increased. Control is passed to operation 1705 (FIG. 17) and process 1700 continues.

In operation 1765, a request and information associated with the request is provided to a searcher. For example, a succinct query, a category, user information, search resources, etc., which may be associated with a request may be provided to a searcher at a searcher system (e.g. the guide system 105 (FIG. 1)) using a web server functionality of the search system 130 and a web browser functionality of the searcher system 105. Control is passed to operation 1705 and process 1700 continues.

In operation 1705, process information is recorded. For example information of a category, a succinct query, a response provided by a resource, a stored response provided, an ambassador, a guide, a query, etc., may be recorded in the database 120 (FIG. 1). In at least one embodiment, usage information of a resource may be recorded to determine compensation for the resource. In at least one embodiment, use of a stored result may cause a rating of the stored result to be reduced. In at least one embodiment an amount of time required by an expediter may be recorded in order to evaluate efficiency of the expediter. Any information associated with the process 1700 may be recorded. Control is passed to operation 1710 and process 1700 continues.

A GUI which is presented to an expediter may be influenced by a category and/or analysis of a user request. For example, if it is determined that an automated response to a user request is likely to be found, a GUI associated with a most likely category and/or other information associated with the request may be provided to an expediter initially. Expediter actions may be used as feedback. If an expediter provides a different type of response than the response determined to be most likely by an algorithmic process, the algorithmic process may be modified to be a better predictor. For example, an expediter succinct query may be associated with a succinct query based on selection of an answer associated with the succinct query by an expediter. Similarly, selection of a system answer responsive to a request may cause a succinct query associated with the request to be associated with the request, which may cause an automated and/or stored response to be provided if another user submits a similar request. Expediter selections may be used for the purposes of training for a Bayesian model for categorization of queries.

A GUI 1800 for processing a request for submission to a resource is illustrated in FIG. 18. The GUI 1800 may be provided to a guide if a request is accepted. For example, the GUI 1800 may be provided to an expediter or ambassador in order to process a user request which has been determined to require expediting. The GUI 1800 may include activity indicators 1805, raw query indicators 1810, succinct query indicators 1815, a session time indicator 1820, finder indicators 1825, a parameter window 1830, parameter indicators 1835, action controls 1840, an away control 1845, a user information window 1850, location indicators 1855, and user information control 1860.

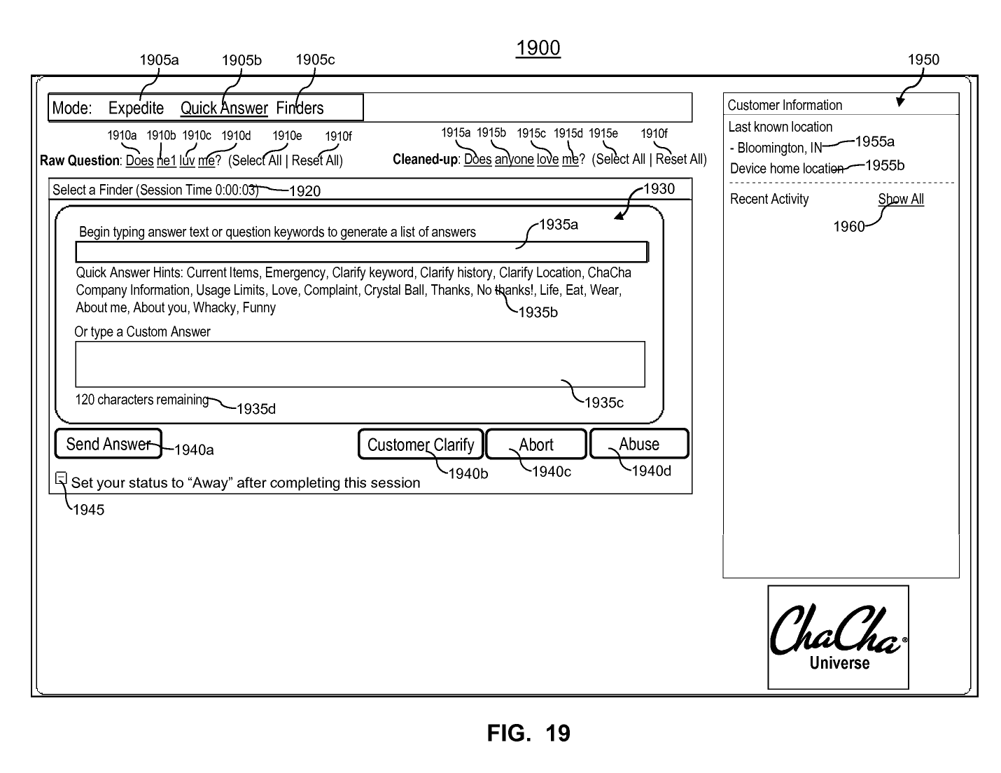

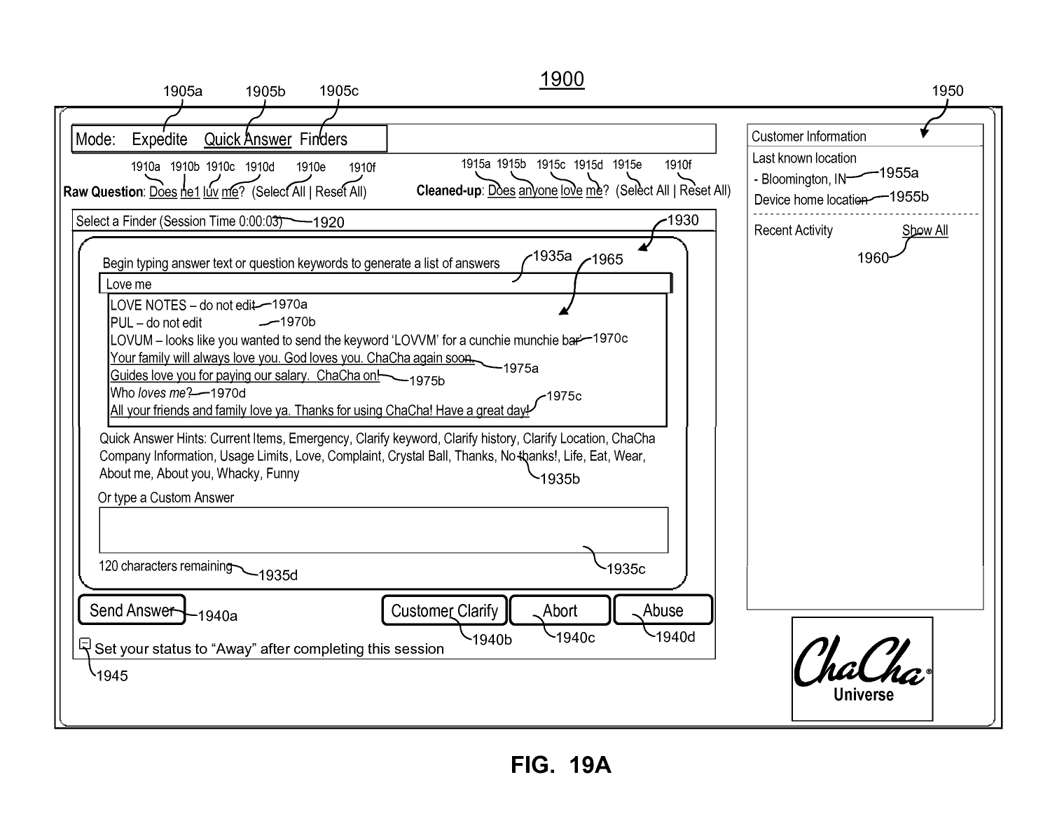

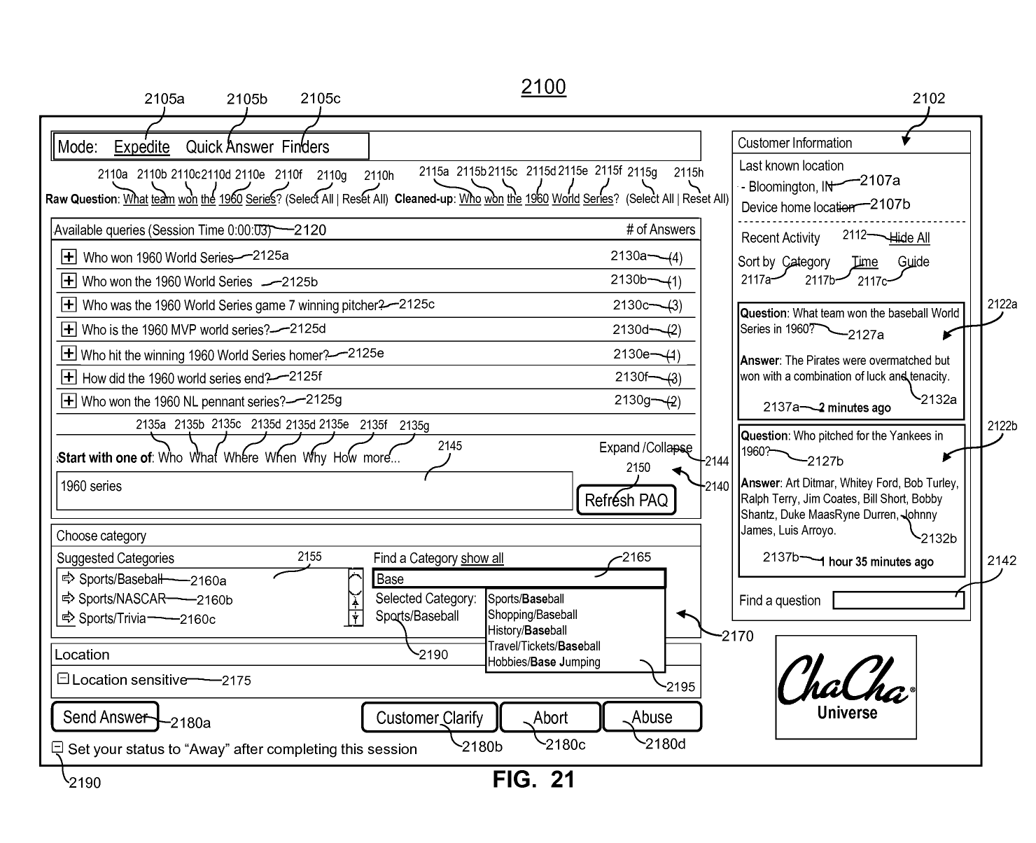

The activity indicators 1805 may be used to indicate a current activity. For example, the ‘Finders’ activity indicator 1805c is active as indicated by the underline. Activation of the ‘Finders’ activity indicator 1805c may cause a GUI such the GUI 1800 (FIG. 18) to be provided. Activation of the ‘Quick Answers’ activity indicator 1805b may cause a GUI such the GUI 1900 (FIG. 19) to be provided. Activation of the ‘Expedite’ activity indicator 1805a may cause a GUI such the GUI 2100 (FIG. 21) to be provided.

The raw query indicators 1810 may be used to indicate elements of a raw query. The raw query indicators may be used to add and remove information from the parameter indicators 1835. For example the raw query indicator 1810a may transfer the word ‘Tell’ to an active parameter indicator 1835 when activated, or may be used to remove the word ‘Tell’ if it is present in the active parameter indicator 1835. Similarly, the raw query indicators 1810b-1810g may transfer and/or remove a word associated with a respective raw query indicator. The ‘Select All’ raw query indicator 1810h may be used to transfer all words associated with a raw query to the active parameter indicator 1835. The ‘Reset All’ raw query indicator 1810j may be used to remove all words associated with a raw query from the active parameter indicator 1835.

The succinct query indicators 1815 may be used to indicate elements of a succinct query. The succinct query indicators may be use to add and remove information from the parameter indicators 1835. For example the succinct query indicator 1815a may transfer the word ‘Biz’ to an active parameter indicator 1835 when activated, or may be used to remove the word ‘Biz’ if it is present in the active parameter indicator 1835. Similarly, the succinct query indicators 1815b-1815d may transfer and/or remove a word associated with the respective succinct query indicators. The ‘Select All’ succinct query indicator 1815e may be used to transfer all words associated with a succinct query to the active parameter indicator 1835. The ‘Reset All’ succinct query indicator 1815f may be used to remove all words associated with a succinct query from the active parameter indicator 1835.

The session time indicator 1820 may be used to indicate time associated with an activity performed using the GUI 1800. The finder indicators 1825 may be used to indicate a type of finder which is to be used to provide a response to a request. A finder is any resource which may provide a response to a query based on standard input parameters. For example, a weather database which may provide a weather forecast based on a location and a date may be a finder resource. Using the example in FIG. 18 the finder indicator 1825a may provide an interface for supplying information required to obtain ‘Weather’ information when selected. The ‘Stocks’ finder indicator 1825b provides an interface for stock quotes. The finder indicators 1825c-1825j provide interfaces for ‘Definitions’, ‘News’, ‘Sports’, ‘Horoscope’, ‘Movies’, ‘Business DA’ and ‘Restaurants’ are provided. As indicated by the dark spot in the ‘radio button’ feature of the finder indicator 1825h, an interface for business directory assistance is provided in the parameter window 1830. If a finder GUI is selected, a more specific ontology for the finder GUI may be enabled. For example, a spelling check and/or a ‘pick list’ of options provided to an expediter may be customized to the task which is being performed.

The parameter indicators 1835 may be used to indicate information associated with parameters needed by a resource in order to provide a response to a request. The parameter indicator 1835a may be used to provide a business name and/or category. For example, an expediter might transfer ‘Bill's Grill’ to the parameter indicator by ‘cutting and pasting’ or by activating the respective raw query indicators 1810. The zip code parameter indicator 1835b may be used to indicate a zip code associated with a request. For example, activation of the location indicator 1855a may cause a zip code associated with ‘Bloomington, Ind.’ to be transferred to the zip code parameter indicator 1835b when the ‘attention’ pointer is located there. The city parameter indicator 1835c may be used to indicate a city associated with a request. For example, activation of the location indicator 1855b may cause a city associated with a device home location, which may not be revealed to an expediter, to be transferred to the city parameter indicator 1835c when the ‘attention’ pointer is located there. The state parameter indicator 1835d may be used to indicate a state associated with a request. For example, activation of the location indicator 1855b may cause a state associated with a device home location, which may not be revealed to an expediter, to be transferred to the state parameter indicator 1835d when the ‘attention’ pointer is located there. The parameter indicator 1835e may be used to indicate if a zip code should be stored. For example, if there is no location associated with a user, or if a number of requests have been associated with businesses in a given location, an expediter may determine that a zip code is to be stored in relation to a user and/or a request. The parameter indicator 1835f may be used to indicate a zip code which may be a stored zip code. Ontology may be associated with any of the parameter indicators 1835. Further any finder may have ontology associated with the finder. For example, the Business DA finder might have a category structure for finding a type of business.

The ‘Send Answer’ action control 1840a may be used to indicate that information indicated in the GUI 1800 is to be submitted in order to provide a response to a request. The ‘Customer Clarify’ action control 1840b may be used to indicate that a request is unclear or ambiguous, which may cause a request for clarification to be provided responsive to a request. The ‘Abort’ action control 1840c may be used to indicate that a request is to be provided to another guide. The ‘Abuse’ action control 1840d may be used to indicate that a request is inappropriate. In at least one embodiment, activation of the ‘Abuse’ control 1840d may cause a warning message to be sent to a user submitting a request. In at least one embodiment, activation of the ‘Send Answer’ action control 1840a may cause a GUI such as the GUI 2000 for confirmation of a result to be provided.

The Away control 1845 may be used to indicate that a guide has elected to become inactive after completion of a current task. The customer information window 1850 may be used to provide information associated with a user such as location, preferences, profile information, previous queries, and/or other information which may assist in responding to a request. The ‘Show All’ user information control 1860 may be used to show and/or hide expanded user information such as user history, etc.

A GUI associated with a finder such as the GUI 1800 may be provided to a guide as a first GUI based on an automated analysis of a request which may indicate a most probable activity and/or resource type which is associated with the request.

A GUI 1900 for responding to a request for generalized information is illustrated in FIG. 19. The GUI 1900 may be provided to a guide if a request is accepted. For example, the GUI 1900 may be provided to an expediter or ambassador in order to process a user request which has been determined to require expediting. The GUI 1900 may include activity indicators 1905, raw query indicators 1910, succinct query indicators 1915, a session time indicator 1920, a parameter window 1930, parameter indicators 1935, action controls 1940, an away control 1945, a user information window 1950, location indicators 1955, and user information control 1960.

The activity indicators 1905 may be used to indicate a current activity. For example, the ‘Quick Answers’ activity indicator 1905b is active as indicated by the underline. Activation of the ‘Finders’ activity indicator 1905c may cause a GUI such the GUI 1800 (FIG. 18) to be provided. Activation of the ‘Quick Answers’ activity indicator 1905b may cause a GUI such the GUI 1900 (FIG. 19) to be provided. Activation of the ‘Expedite’ activity indicator 1905a may cause a GUI such the GUI 2100 (FIG. 21) to be provided.

The raw query indicators 1910 may be used to indicate elements of a raw query. The raw query indicators may be used to add and remove information from the parameter indicators 1935. For example the raw query indicator 1910a may transfer the word ‘Does’ to an active parameter indicator 1935 when activated, or may be used to remove the word ‘Does’ if it is present in the active parameter indicator 1935. Similarly, the raw query indicators 1910b-1910d may transfer and/or remove a word associated with the respective raw query indicators 1910. The ‘Select All’ raw query indicator 1910e may be used to transfer all words associated with a raw query to an active parameter indicator 1935. The ‘Reset All’ raw query indicator 1910f may be used to remove all words associated with a raw query from an active parameter indicator 1935.

The succinct query indicators 1915 may be used to indicate elements of a succinct query. The succinct query indicators may be use to add and remove information from the parameter indicators 1935. For example the succinct query indicator 1915a may transfer the word ‘Does’ to an active parameter indicator 1935 when activated, or may be used to remove the word ‘Does’ if it is present in the active parameter indicator 1935. Similarly, the succinct query indicators 1915b-1915d may transfer and/or remove a word associated with the respective succinct query indicators. The ‘Select All’ succinct query indicator 1915e may be used to transfer all words associated with a succinct query to an active parameter indicator 1935. The ‘Reset All’ succinct query indicator 1915f may be used to remove all words associated with a succinct query from an active parameter indicator 1935.

The session time indicator 1920 may be used to indicate time associated with an activity performed using the GUI 1900. The parameter indicators 1935 may be used to indicate information associated which may be used to provide a response to a request. The parameter indicator 1935a may be used to index various types of available responses. As further described with respect to FIG. 19A, content of the parameter indicator 1935a may cause various types of information to be provided. The ‘Quick Answer’ parameter indicator 1935b may be used to select responses associated with a particular topic. For example, if a query is of a conversational nature, selection of the ‘Crystal Ball’ element of the parameter indicator 1935b may cause information of a random group of responses to be provided in the parameter indicator 1935a. The ‘Custom Answer’ parameter indicator 1935c may be used to provide a response which may be customized by an expediter. The parameter indicator 1935d may be used to provide information of formatting of an answer. For example, the parameter indicator 1935d indicates a number of remaining characters in a response to a request.

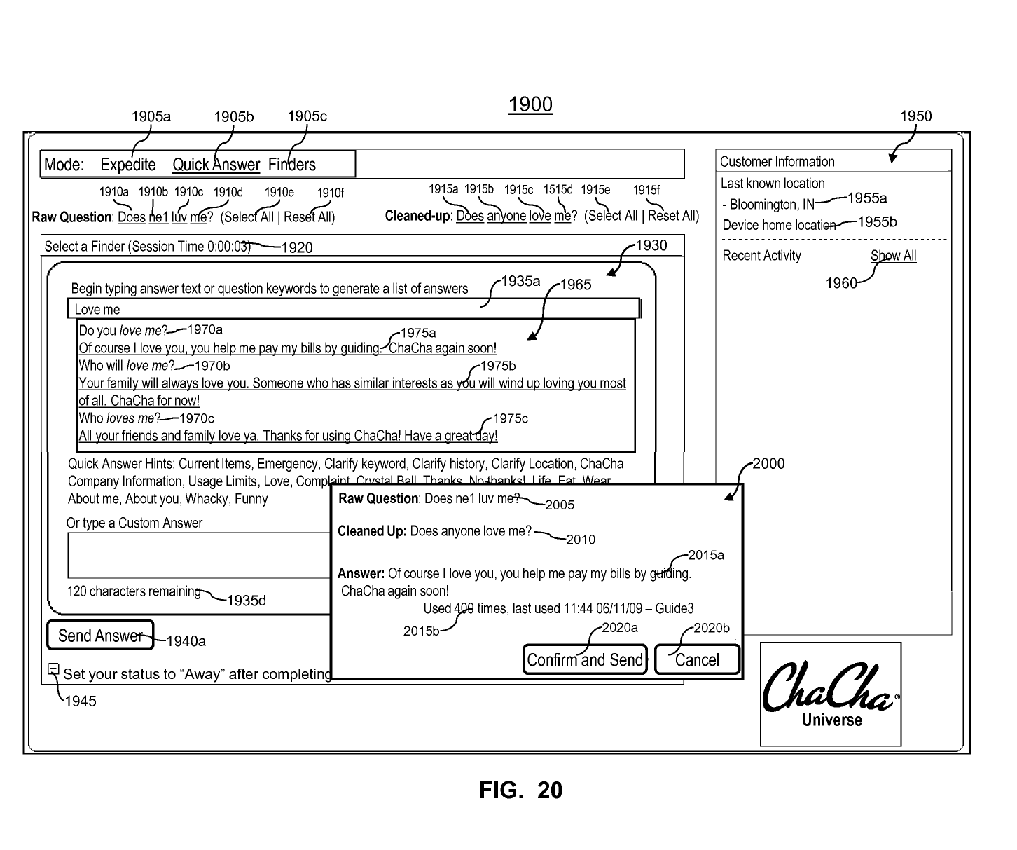

The ‘Send Answer’ action control 1940a may be used to indicate that information indicated in the GUI 1900 is to be submitted in order to provide a response to a request. The ‘Customer Clarify’ action control 1940b may be used to indicate that a request is unclear or ambiguous, which may cause a request for clarification to be provided responsive to a request. The ‘Abort’ action control 1940c may be used to indicate that a request is to be provided to another guide. The ‘Abuse’ action control 1940d may be used to indicate that a request is inappropriate. In at least one embodiment, activation of the ‘Abuse’ control 1940d may cause a warning message to be sent to a user submitting a request. In at least one embodiment, activation of the ‘Send Answer’ action control 1940a may cause a GUI such as the GUI 2000 (FIG. 20) for confirmation of a result to be provided.

The Away control 1945 may be used to indicate that a guide has elected to become inactive after completion of a current task. The customer information window 1950 may be used to provide information associated with a user such as location, preferences, profile information, previous queries, and/or other information which may assist in responding to a request. The last location indicator 1955a may indicate a location most recently associated with a user device. The device home location indicator 1955b may indicate a location associated with a device which is not a current location associated with the device. The ‘show all’ user information control 1960 may be used to show and/or hide expanded user information such as user history, etc.

Referring to FIG. 19A, if information is indicated in the parameter indicator 1935a the quick answer selection menu 1965 may be provided. Various types of response options may be provided responsive to the information indicated in the parameter indicator 1935a. The ‘LOVE NOTES’ response indicator 1970a indicates a random response with a ‘Love Note’ message which will be delivered without intervention by a guide. The ‘PUL’ response indicator 1970b indicates a humorous response which may be delivered automatically. The ‘LOVUM’ response indicator 1970c indicates a response associated with a typographic error for items such as keywords which are associated with automated responses, which may be a fixed response. The ‘your family’ free form response indicator 1975a may indicate a query and/or associated response. Activation of the response indicator 1975a may cause text associated with the response indicator 1975a to be transferred to the parameter indicator 1935c. Activation of the fee form response indicators 1975b, 1975c may cause the associated text to be transferred to the parameter indicator 1935c. The response indicator 1970d may indicate an alternate succinct query associated with a result. Information in the parameter indicator 1935c may be edited by an expediter prior to activating the ‘Send Answer’ action control 1940a. In at least one embodiment, queries and answers indexed using information indicated in the parameter indicator 1935a may be edited content which is controlled by an operator of the search system 130 (FIG. 1).

In at least one embodiment, the free form responses may be edited responses which originated from a searcher responsive to a query. For example, a number of guide or user responses to conversational queries may be edited, rated, and/or otherwise selected to be presented to an expediter as a response. In at least one embodiment, information indicated in the parameter indicator 1935a may be compared to a database which is indexed and maintained for the purpose of providing a response to a conversational query. For example, keywords, queries, etc., may be compared to a corpus of queries and answers which has different parameters based on a functionality selected by an expediter and/or the search system 130 (FIG. 1).

It is important to note that this feature provides a highly advantageous functionality. Because a user query is compared to a database which is relevant to a currently selected activity, a query from a user may be compared to a limited database rather than being compared to a large database of previous queries. For example, if a keyword response is expected from a user, it might be very difficult for a spelling check to recognize a typographic error in a keyword which is itself a misspelling. A sponsored response keyword might be ‘ROBT’ for promotion of a robot movie. However, the user might send ‘ROAT’ a common T1 keypad error. Machine checking might not easily resolve the intent of a keyword. But an expediter who sees the query (a single word) and a user history as a movie buff, and is prompted with ROBT as a possible response, may correct the keyword and send the requested offer to the user. Similarly a database of responses to common queries ensures a high quality response to the most common types of queries, avoiding an opportunity for errors by inexperienced and/or inattentive guides seeking information which is readily available.

A GUI 2000 which may be used to confirm a result or response is illustrated in FIG. 20. The GUI 2000 may be provided as, for example, a ‘pop-up’ responsive to activation of the ‘Send Answer’ action control 1940a (FIG. 19). The GUI 2000 may include a raw query indicator 2005, a succinct query indicator 2010, response indicators 2015, and action buttons 2020.

The raw query indicator 2005 may be used to indicate information of an original query submitted by a user. The succinct query indicator 2010 may be used to indicate information of a succinct query constructed by an expediter. The answer response indicator 2015a may indicate content of a response which is to be provided to a request. The auxiliary response indicator 2015b may include information regarding a response such as a date of creation, usage, etc., which may be used to judge relevance of a result. The ‘Confirm and Send’ action button 2020a may be used to indicate that a result is confirmed. The ‘Cancel’ action button 2020b may be used to cancel submission of a result and return to a previous GUI. In at least one embodiment, the GUI 2000 includes the action buttons 2020a, 2020b, and other features may be suppressed. The GUI 2000 may serve as a final check by an expediter to avoid accidental selection of a response.

A GUI 2100 for responding to a request is illustrated in FIG. 21. The GUI 2100 may be provided to a guide if a request is accepted. For example, the GUI 2100 may be provided to an expediter or ambassador in order to process a user request which has been determined to require expediting. The GUI 2100 may include activity indicators 2105, raw query indicators 2110, succinct query indicators 2115, a session time indicator 2120, query indicators 2125, answer count indicators 2130, query initial word indicators 2135, a query formation window 2140, an ‘Expand/Collapse’ control 2144, a query box 2145, a refresh control 2150, a suggested categories window 2155, suggested category indicators 2160, a category search control 2165, a categorization window 2170, a location sensitivity indicator 2175, action buttons 2180, an Away control 2190, and a user information window 2102.

The activity indicators 2105 may be used to indicate a current activity. For example, the ‘Expedite’ activity indicator 2105a is active as indicated by the underline. Activation of the ‘Finders’ activity indicator 2105c may cause a GUI such the GUI 1800 (FIG. 18) to be provided. Activation of the ‘Quick Answer’ activity indicator 2105b may cause a GUI such the GUI 1900 (FIG. 19) to be provided. Activation of the ‘Expedite’ activity indicator 2105a may cause a GUI such the GUI 2100 (FIG. 21) to be provided.

The raw query indicators 2110 may be used to indicate elements of a raw query. The raw query indicators may be use to add and remove information from the query box 2145. For example the raw query indicator 2110a may transfer the word ‘What’ to the query box 2145 when activated, or may be used to remove the word ‘What’ if it is present in the query box 2145. Similarly, the raw query indicators 2110b-2110f may transfer and/or remove a word associated with the respective raw query indicators. The ‘Select All’ raw query indicator 2110g may be used to transfer all words associated with a raw query to the query box 2145. The ‘Reset All’ raw query indicator 2110h may be used to remove all words associated with a raw query from the query box 2145.

The succinct query indicators 2115 may be used to indicate elements of a succinct query. The succinct query indicators may be use to add and remove information from the query box 2145. For example the succinct query indicator 2115a may transfer the word ‘Who’ to the query box 2145 when activated, or may be used to remove the word ‘Who’ if it is present in the query box 2145. Similarly, the succinct query indicators 2115b-2115f may transfer and/or remove a word associated with the respective succinct query indicators. The ‘Select All’ succinct query indicator 2115g may be used to transfer all words associated with a succinct query to the query box 2145. The ‘Reset All’ succinct query indicator 2115h may be used to remove all words associated with a succinct query from the query box 2145.

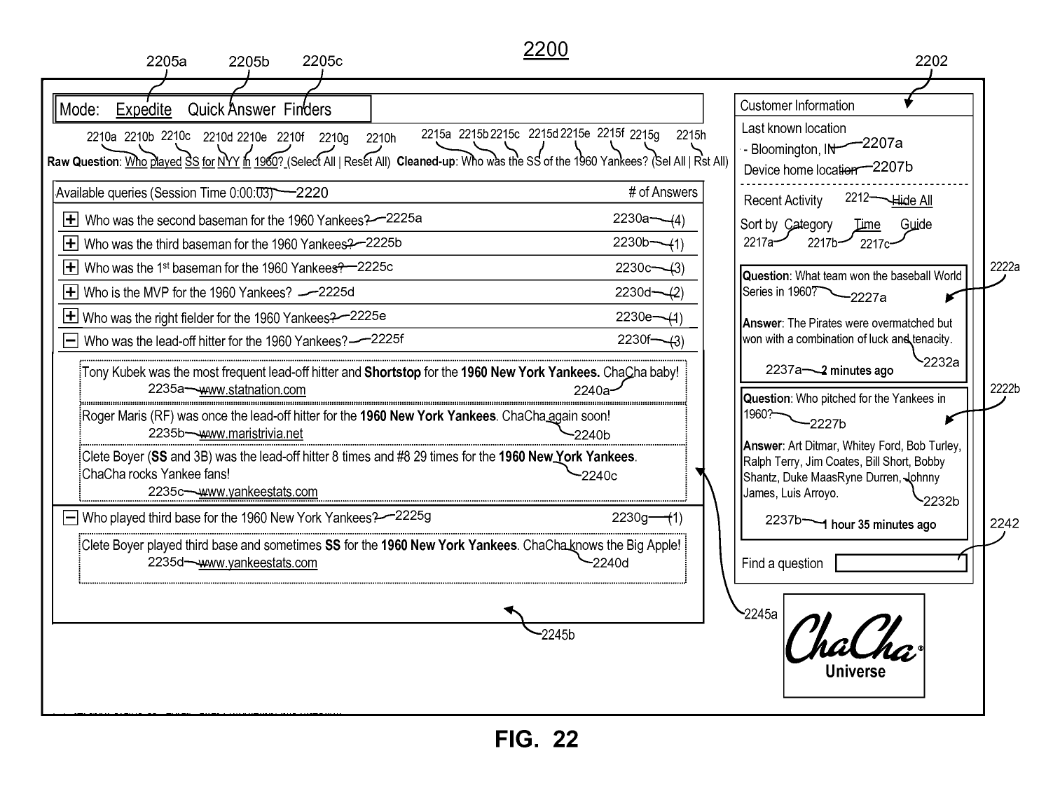

The session time indicator 2120 may be used to indicate time associated with an activity performed using the GUI 2100. The previous query indicators 2125 may indicate information of previous queries determined to match a query indicated in the query box 2145. In at least one embodiment, the query indicated in the succinct query indicators 2115 is transferred to the query box 2145 as an initial default state of the GUI 2100 when presented. The answer count indicators 2130 may be used to indicate a number of answers associated with a previous query indicated in the previous query indicators 2125. For example, the answer count indicator 2130a indicates that there are ‘4’ answers associated with the query ‘Who won the 1960 World Series?’ indicated in the previous query indicator 2125a. Activation of the previous query indicators 2125 may cause details of results associated with the query to be provided as further described with respect to FIG. 22. The query initial word selectors 2135 may be used to select a question word which may be used to start a succinct query. For example activation of the query initial word selection 2135a may cause the word ‘What’ to be transferred to the query box 2145. The query initial word selectors 2135b-2135f may transfer the respective words indicated to the query box 2145. Activation of the query initial word indicator 2135g may cause a menu (not shown) of additional initial query words to be provided. The ‘expand/collapse’ detail control 2144 may be used to toggle between revealing and hiding information of answers associated with queries indicated in the previous query indicators 2125. The refresh control 2150 may be used to cause content of the query formation window 2140 to be updated based on content of the query box 2145 when activated.

The categorization window 2170 includes controls which may be used to categorize a query. The suggested categories window 2155 includes information of categories which have been determined to match a raw query. In at least one embodiment, the suggested category indicators 2160 are presented in an order based on ranking of the categories based on content of a raw query. The suggested category indicator 2160a indicates the category ‘Sports/Baseball’. The suggested category indicator 2160b indicates the category ‘Sports/NASCAR’. The suggested category indicator 2160c indicates the category ‘Sports/Trivia’. Activation of the suggested category indicators 2160 transfers the category indicated to the selected category indicator 2190. The category search control 2165 may be used to search for a category based on matching of text indicated in the category search control 2165 with text associated with an index. As illustrated, the category selection menu 2195 may be provided as text is entered in the category selection control 2165. The location sensitivity indicator 2175 may be used to indicate if a request is sensitive to a location associated with the request. Activation of the location sensitivity indicator may toggle the status of the location sensitivity indicator 2175. The Away control 2190 may be used to indicate that a guide has elected to become inactive after completion of a current task.

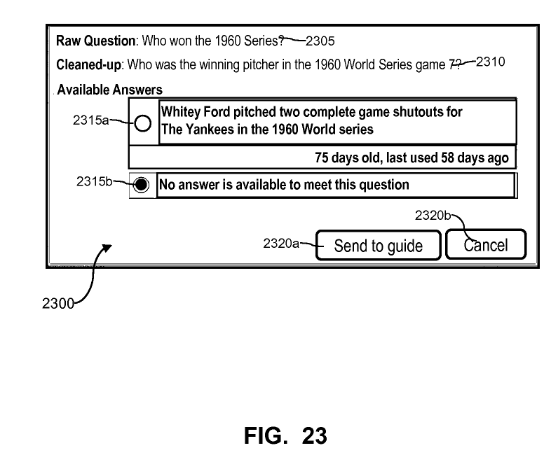

The ‘Send Answer’ action button 2180a may be used to indicate that information indicated in the GUI 2100 is to be submitted in order to provide a response to a request. The ‘Customer Clarify’ action button 2180b may be used to indicate that a request is unclear or ambiguous, which may cause a request for clarification to be provided responsive to a request. The ‘Abort’ action button 2180c may be used to indicate that a request is to be provided to another guide. The ‘Abuse’ action button 2180d may be used to indicate that a request is inappropriate. In at least one embodiment, activation of the ‘Abuse’ button 2180d may cause a warning message to be sent to a user submitting a request. In at least one embodiment, activation of the ‘Send Answer’ action button 2180a may cause a GUI such as the GUI 2300 (FIG. 23) for confirmation of a result to be provided.

The user information window 2102 may include information associated with a person submitting a request. A location indicator 2107a may indicate a last location associated with a user, and may be used to transfer such information to features of the GUI 2100. A location indicator 2107b may indicate a primary location associated with a user which may for example be associated with a user device. If a query is determined to be location sensitive, an option to select a location indicated in the location indicators 2107 may be provided.

Recent activity indicators 2122 may be used to provide information of activities associated with a user. A ‘hide all’ control 2112 may toggle between an expanded and a collapsed view of user activities. Sort controls 2117 may be used to indicate a sort criterion applied to information of previous activities of a user. The ‘Category’ sort indicator 2117a may cause previous questions to be sorted by category. The ‘Time’ sort indicator 2117b may cause previous questions to be sorted chronologically. The ‘Guide’ sort indicator 2117c may cause previous questions to be sorted by a guide associated with an activity. Any number and/or type of sort controls may be provided.

Result indicators 2122 may provide information of previous requests and responses. Previous request indicators 2127 may indicate content of a request. Previous answer indicators 2132 may indicate information of a response provided to a request. Previous request auxiliary information indicators 2137 may indicate time, guide, quality, location, etc., which may be associated with a previous request. A previous request search control 2142 may be used to locate a previous request by a user which matches a query entered in the previous request search control 2142.

A GUI 2200 for responding to a request is illustrated in FIG. 22. The GUI 2200 may be provided to a guide if a request is accepted. For example, the GUI 2200 may be provided to an expediter or ambassador in order to process a user request which has been determined to require expediting. The GUI 2200 may include activity indicators 2205, raw query indicators 2210, succinct query indicators 2215, a session time indicator 2220, query indicators 2225, answer count indicators 2230, resource indicators 2235, answer indicators 2240, result detail windows 2245, and a user information window 2202.

The activity indicators 2205 may be used to indicate a current activity. For example, the ‘Expedite’ activity indicator 2205a is active as indicated by the underline. Activation of the ‘Finders’ activity indicator 2205c may cause a GUI such the GUI 1800 (FIG. 18) to be provided. Activation of the ‘Quick Answer’ activity indicator 2205b may cause a GUI such the GUI 1900 (FIG. 19) to be provided. Activation of the ‘Expedite’ activity indicator 2205a may cause a GUI such the GUI 2200 (FIG. 22) to be provided.

The raw query indicators 2210 may be used to indicate elements of a raw query. The raw query indicators may be use to add and remove information from the query box 2245. For example the raw query indicator 2210a may transfer the word ‘What’ to the query box 2245 when activated, or may be used to remove the word ‘Who’ if it is present in the query box 2245. Similarly, the raw query indicators 2210b-2210f may transfer and/or remove a word associated with the respective raw query indicators. The ‘Select All’ raw query indicator 2210g may be used to transfer all words associated with a raw query to the query box 2145 (FIG. 21). The ‘Reset All’ raw query indicator 2210h may be used to remove all words associated with a raw query from the query box 2145 (FIG. 21).

The succinct query indicators 2215 may be used to indicate elements of a succinct query. The succinct query indicators may be use to add and remove information from the query box 2245. For example the succinct query indicator 2215a may transfer the word ‘Who’ to the query box 2245 when activated, or may be used to remove the word ‘Who’ if it is present in the query box 2245. Similarly, the succinct query indicators 2215b-2215f may transfer and/or remove a word associated with the respective succinct query indicators. The ‘Select All’ succinct query indicator 2215g may be used to transfer all words associated with a succinct query to the query box 2145 (FIG. 21). The ‘Reset All’ succinct query indicator 2215h may be used to remove all words associated with a succinct query from the query box 2145 (FIG. 21).

The session time indicator 2220 may be used to indicate time associated with an activity performed using the GUI 2200. The previous query indicators 2225 may indicate information of previous queries determined to match a query indicated in the query box 2245. In at least one embodiment, the query indicated in the succinct query indicators 2215 is transferred to the query box 2245 as an initial default state of the GUI 2200 when presented. The answer count indicators 2230 may be used to indicate a number of answers associated with a previous query indicated in the previous query indicators 2225. For example, the answer count indicator 2230a indicates that there are ‘4’ answers associated with the query ‘Who won the 1960 World Series?’ indicated in the previous query indicator 2225a. Activation of the previous query indicators 2225 may cause details of results associated with the query to be provided using the result detail windows 2245. Activation of a previous query indicator 2225 may toggle between display and hiding of a result detail window 2245 associated with the previous query indicator 2225. The result detail window 2245a includes result resource indicators 2235 and result content indicators 2240 associated with the previous query ‘Who was the lead-off hitter for the 1960 New York Yankees’ indicated in the previous query indicator 2225f. The result content indicator 2240a indicates the answer ‘Tony Kubek was the most frequent lead-off hitter and Shortstop for the 1960 New York Yankees’, which may be the top ranked result, was obtained from the resource ‘www.statnation.com’ as indicated in the result resource indicator 2235a. Similarly the result content indicators 2240b and 2240c provide information of alternate responses to the query indicated in the previous query indicator 2225f. Elements of an answer which may match a query indicated in the query box 2145 (FIG. 21) may be indicated in a result content indicator 2240 using for example bold as illustrated in the result content indicators 2240a-2240d. Activation of a result content indicator may cause a result to be selected and may cause a GUI such as the GUI 2000 (FIG. 20) or the GUI 2300 (FIG. 23) to be provided.

In at least one embodiment, opinion indicators may be provided in the GUI 2100 (FIG. 21), 2200 (FIG. 22), and the GUI 2300 (FIG. 23). An opinion indicator such as a ‘radio button’ or other controls well known in the art may be provided for expressing an opinion regarding an answer. For example, an expediter may indicate a preference for a particular previous result even if it is not the highest ranking result for a given query. Similarly, an expediter may be able to identify an obviously wrong or outdated answer, which may improve the overall quality of service provided by a search service.

The user information window 2202 may include information associated with a person submitting a request. The location indicator 2207a may indicate a last location associated with a user, and may be used to transfer such information to features of the GUI 2200. The location indicator 2207b may indicate a primary location associated with a user which may for example be associated with a user device. If a query is determined to be location sensitive, an option to select a location indicated in the location indicators 2207 may be provided.

The recent activity indicators 2222 may be used to provide information of activities associated with a user. The ‘hide all’ control 2212 may toggle between an expanded and a collapsed view of user activities. The sort controls 2217 may be used to indicate a sort criteria applied to information of previous activities of a user. The ‘Category’ sort indicator 2217a may cause previous questions to be sorted by category. The ‘Time’ sort indicator 2217b may cause previous questions to be sorted chronologically. The ‘Guide’ sort indicator 2217c may cause previous questions to be sorted by a guide associated with an activity. Any number and/or type of sort controls may be provided.

Result indicators 2222 may provide information of previous requests and responses. Previous request indicators 2227 may indicate content of a request. Previous answer indicators 2232 may indicate information of a response provided to a request. Previous request auxiliary information indicators 2237 may indicate time, guide, quality, location, etc., which may be associated with a previous request. A previous request search control 2242 may be used to locate a previous request by a user which matches a query entered in the previous request search control 2242.

A GUI 2300 for confirming a response to a request is illustrated in FIG. 23. The GUI 2300 may include a raw query indicator 2305, a succinct query indicator 2310, answer option indicators 2315, and action buttons 2320.

The raw query indicator 2305 may be used to indicate content of a request. Any type of information may be indicated in the raw query indicator, such as text, audio, images, video, etc., which may be provided to the search system 130 (FIG. 1). The succinct query indicator 2310 may be used to indicate content of a processed query which has been modified to improve indexing of a raw query. The answer option indicators 2315 may be used to indicate information of answer options which may be selected. An answer option indicator 2315 may be provided for any or all answers which may be determined to match a request. For example, if a raw query matches a succinct query which is associated with a number of search results, an answer option indicator 2315 may be provided which corresponds to any or all search results associated with the succinct query. Referring to FIG. 23, the answer option control 2315a corresponds to the result ‘Whitey Ford pitched two complete game shutouts for the Yankees in the 1960 World Series’ which is associated with the succinct query ‘Who was the winning pitcher in the 1960 World Series game 7?’ which has been associated with the raw query ‘Who won the 1960 Series?’ the answer option control 2315b is associated with the option ‘No answer is available to meet this question’ which may be used to indicate that available results are not suitable for any reason. The answer option control 2315b is selected as indicated by the black spot in the ‘radio button’ control of the answer option control 2315b. In at least one embodiment, the answer option controls 2315 are mutually exclusive. Activation of the answer option control 2315b may change the information provided in the action button 2320a. If an existing answer is selected the action button 2320a may indicate that a result is to be provided to a user. This may occur for example if a result content indicator 2240 (FIG. 22) is activated. If the answer option control 2315b is active the action button 2320a may indicate that a request is to be directed to a guide who may perform a search responsive to the request. If an expediter indicates that there is not an existing result which may be used to respond to a request associated with a succinct query, a ranking of the succinct query with respect to a raw query may be modified. Similarly, a rating of a search result associated with a succinct query which is determined not to be a suitable response may be reduced. In at least one embodiment, an expediter may indicate that a response is relevant to a query, but is not a suitable response. This indication may cause a searcher receiving the request to be directed to a resource associated with a result identified by an expediter.

Re-use of answers is important to a system for responding to user requests. As many queries may have similar intent it is important to reuse previous answers to avoid unneeded time to respond and expense. However it is crucial that answer quality remain as high as possible in order that user experience is not degraded. As a result, a trade-off is necessary. To accomplish an optimum performance, two factors mainly are considered. First it is necessary to reliably determine whether a user request is equivalent to a stored and/or synthetic request. Processes such as spell checking, grammar checking, word substitution, named entity comparison, etc., are applied to a user request in order that stored requests are as homogeneous as possible.

A rewritten user query is compared to stored or ‘candidate’ queries which may be associated with answers which have been previously provided by guides and/or may be generated automatically. If it is determined that a candidate query is within a suitable distance of a user request, answers associated with a candidate query are evaluated to determine whether the answers are suitable for reuse. If an answer is found to be suitable for reuse, a ranking of reusable answers may be performed to determine which answer is most suitable for reuse.

The answer reuse evaluation capability may be combined with the human intelligence of an expediter, who may be trained and provided with tools for processing a request. As an expediter modifies a user request, the request may be reevaluated and further answer options may be provided to the expediter. The expediter may override an automated decision as allowed by the business rules of the system.

While the method and system are described in the context of a search system, they might also be applied to any type of customer service activity. In lieu of providing every representative with the same training and the same tools, tools which are suitable to the particular task assigned to the worker are provided. Although more effort may be expended on complex queries, as a high percentage of queries are not complex. As a consequence the time and effort to respond are greatly reduced.

A system where advertisements are delivered to a user may use a so-called ‘third party’ ad server. A third party ad server acts to provide advertisements to publishers such as websites. If a publisher requests an ad associated with a keyword, the ad is provided, and may include a form of response such as a URL. A URL provided by a third party ad server typically redirects back to the third party ad server, which measures a number of clicks which have been delivered by a publisher to an advertiser, who pays for the counted clicks. A cookie may be provided to a user device which allows a webpage to which the link directs a user to track whether the user makes a purchase, which may allow the advertiser to gauge the efficacy of a publisher and/or an advertisement to obtain customers who make a purchase. Information regarding pages viewed, items purchased, and a total amount of a purchase may be gathered based on a cookie provided to a user.

Likewise a third party ad server may be used to measure a total number of ads or “impressions” delivered by a publisher on behalf of an advertiser. A total number of impressions may apply to cost per impression (CPM) advertising. The number of times an advertisement such as a banner ad or interstitial ad is served may be tracked in order to determine compensation for a publisher. While links associated with banners and interstitials may be tracked in the same manner as a click-through, a banner or interstitial may have greater staying power as the brand of the advertiser is exposed to a user even if no immediate action was taken.

Recently a new form of advertising has been developed by companies such as 4Info and ChaCha whereby a user receives an advertisement within an SMS message. Mobile messaging advertising systems have found user acceptance, and advertisers have found the messages to be effective. In some instances, an advertiser may, for example, include a response code with an SMS message which may be used in a similar manner to a click on a URL provided to a user in web page to trigger an action responsive to the response code. However, there is no known system whereby a third party verification of advertising performance can be performed responsive to an SMS communication between a user and an SMS publishing service.

In light of these and other problems, a method and system of verification of mobile messaging advertising performance would be greatly appreciated.

A system is provided whereby mobile messages may be monitored to determine whether an advertisement is delivered, and a user response to an advertisement. An advertiser composes ad copy as a message which may be provided to a user. Ad copy may be provided to a publisher and to a third party verification service. A publisher may inform a third party verification service how the third party verification service may determine whether a message to a user includes ad copy. If a response code is provided in a message, a publisher may inform a third party verification service how the third party verification service may determine whether a message from a user includes the response code. A third party verification service may be provided with decoding information regarding messages between a publisher and a user which may be used to monitor communications between the user and the publisher to determine impressions delivered, responses received, etc.

A verification service may be provided with access to communication between a publisher and a service which routes SMS messages between the publisher and a user. A service which routes SMS messages between a publisher and a user may be referred to as an ‘aggregator’. A publisher may communicate with an aggregator via a network interface such as Hypertext Transfer Protocol (HTTP) and a software layer such as Simple Object Access Protocol (SOAP), and/or other similar web based communication. An aggregator may provide a publisher with access to users of various wireless service provider networks. As communication messages are passed between a publisher and an aggregator, a third party verification service may monitor the messages to determine whether a message includes ad copy and/or response codes. Thus, a verification service may provide independent data to an advertiser regarding efficacy of a publisher, response rates, and transactions completed responsive to ad copy delivered by a publisher. In embodiments, messages may be passed directly between a publisher and a wireless carrier without using an aggregator. In such an embodiment, a wireless network system functions in the same way as an aggregator service to deliver messages to and receive messages from a user device and a verification service operates between a publisher and a wireless carrier.

A system is provided which allows a user, who may be any person, to submit a request to a publisher and receive a result or response. A system which allows communication to occur between a user, a publisher, a verifier and an advertiser is provided. A database, comprising information regarding a user, a request, an aggregator, a publisher, an advertiser, an advertisement, a verifier, etc., is provided.

A request submitted by a user may receive a response which is produced automatically and/or utilizing assistance of a person. A response may be produced automatically, and/or may be provided to a user that did not submit a request. An advertisement may be delivered as part of a result, and/or may be a result. A result may include an indicator which may be used by a user to respond to a result. A message associated with an indicator may be used to determine that a user has responded to an advertising message.

A verification operation is performed by a server system which is interposed between an aggregator or other router of Short Messaging Service (SMS) messages and/or other mobile messaging services, such as a wireless carrier and a publisher. A publisher and/or a verifier obtain advertisement information from an advertiser. A publisher and a verifier may add information to the message provided by an advertiser, which allows a unique indicator to be added to the message in order that a response associated with the identifier may be recognized. While the system is described in the context of an aggregator routing messages between a publisher and a wireless carrier, the aggregator system may be integrated in the carrier system and/or the publisher system without departing from the scope and spirit of the embodiments herein.

If a publisher receives a request, the publisher may select an advertisement and deliver the selected advertisement to a user. A message provided to a user is routed to a verifier system which may confirm the delivery of an advertisement to a user. A verifier may forward the message to a suitable aggregator, who may be a wireless carrier, who delivers the message to a wireless carrier, who delivers the message to a user.

If a message is received by an aggregator which is directed to a publisher, the aggregator may redirect the message to a verifier system. A verifier system may examine an incoming message to determine whether the message includes a response indicator. If a response indicator is found, a verifier system may record relevant information from the message and deliver the message to a publisher. A verifier system forwards an incoming message to a publisher.

If a response indicator is a telephone number which may be called by a user, a voice server may be provided. If a voice call is received, a verifier system may determine if a caller associated with a response indicator has received an advertisement and may direct a call to an advertiser or a merchant who is a provider of an advertised product and/or service.

The terms voice and speech are used interchangeably herein. A user and a publisher may establish a communication session using a voice service, a messaging service such as Short Messaging Service (SMS), Enhanced Messaging Service (EMS), Multi-media Messaging Service (MMS), Instant Messaging (IM), email, an internet portal or web page, a web service, an API, regular mail or any other type of communication. A connection may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a user and a publisher search system may include conversion of text to speech and speech to text, and/or other types of information conversion. Any type of media which can be sent or received using a communication system may be part of a communication session. A communication session may be conducted using any or all communication service associated with a user, an advertiser, and/or a publisher. A verification system may utilize any suitable communication services to verify communications and/or delivery between a user, a publisher, and/or an advertiser.

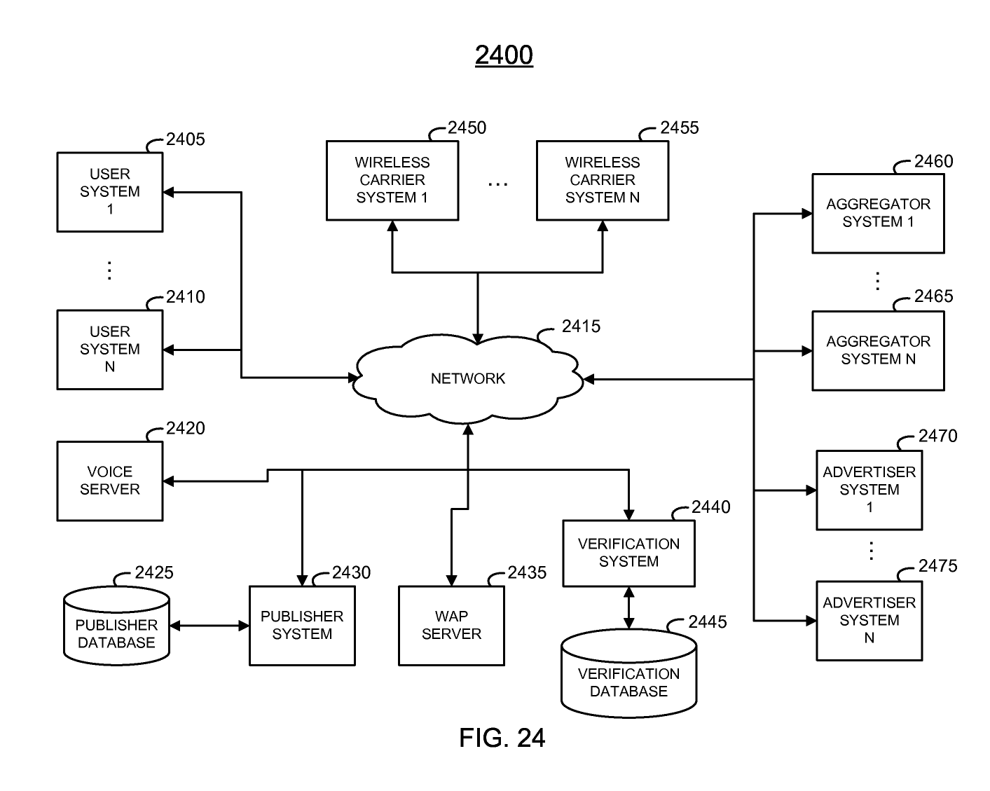

As illustrated in FIG. 24, a system 2400 is provided. The system 2400 includes user systems 2405, 2410, a network 2415, a voice server 2420, a publisher database 2425, a publisher system 2430, a WAP server 2435, a verification system 2440, a verification database 2445, wireless carrier systems 2450, 2455, aggregator systems 2460, 2465, and advertiser systems 2470, 2475. The system 2400 allows a user to communicate with a publisher, who may provide a response to a user message which may include an advertisement.

While only a limited number of systems associated with a user, publisher, verification system, aggregator, advertiser, Wireless Access Protocol (WAP) server, wireless carrier, and voice server are depicted in FIG. 24, it is within the scope of the disclosure for multiple systems for users, publishers, verification systems, aggregators, advertisers, Wireless Access Protocol (WAP) servers, wireless carriers, and voice servers to be utilized. Further, any or all of the system may be integrated and provided as a single system. For example, a verification system may be incorporated with that of the publisher system 2430, or the voice server 2420 may be incorporated in a wireless carrier system.

Any user system (e.g., the user systems 2405, 2410) can be operated by a user, who may be a person, to submit a request to the publisher system 2430 and/or receive a response and/or other information. A user system may communicate with other elements of the system 2400, using services such as voice, SMS, MMS, EMS, web services, email, etc.

The network 2415 (FIG. 24) may be a global public network of networks (the Internet) and/or consist in whole or in part of one or more private networks and communicatively couples the user systems 2405, 2410, the voice server 2420, the publisher database 2425, the publisher system 2430, the WAP server 2435, the verification system 2440, the verification database 2445, the wireless carrier systems 2450, 2455, the aggregator systems 2460, 2465, and the advertiser systems 2470, 2475. For example, a private network might be provided to enable more secure communication between the verification system 2440 and other elements of the system 2400, such as the publisher system 2430, and the advertiser systems 2470, 2475. The network 2415 may include one or more wireless networks which may enable wireless communication between the various elements of the system 2400. For example, a mobile phone carrier network accessible using the wireless carrier system 2450 might be used to connect the user system 2410 to the publisher system 2430, the WAP server 2435, and/or the voice server 2420.

The voice server 2420 may receive a voice call from a user, an advertiser, and/or a publisher and may provide voice information as voice packets using a protocol, such as SIP, as is well known in the art. The WAP server 2435 may allow a user of a wireless device to access a web page which is designed to operate more effectively on a mobile device, using technology which is well known in the art.

The publisher system 2430 may provide information to a user system responsive to a request. A publisher might for example provide information services such as weather, sports, etc. In at least one embodiment the publisher system 2430 is a human assisted search service which responds to queries by users regarding any type of information. The publisher system 2430 may obtain revenue based at least in part on advertising revenue. The publisher system 2430 may provide a response to a user, which may include an advertisement, using any communication services associated with the user and/or accessible to the publisher system 2430.

The publisher system 2430 is communicatively coupled with the publisher database 2425. As will be described herein in further detail below, the publisher database 2425 includes data that is processed in association with operation of the embodiments. Although FIG. 24 illustrates the publisher database 2425 as a separate component of the system, the publisher database 2425 may be integrated with the publisher system 2430. Further, the records maintained in the publisher database 2425 may be stored in any typical manner, including in a Network Attached Storage (NAS), a Storage Area Network (SAN), etc., using any typical or proprietary database software, such as DB2®, Informix®, Microsoft® SQLServer™, MySQL®, Oracle®, etc., and may also be a distributed database on more than one server. Elements of the publisher database 2425 may reside in any suitable elements of the system 2400.

The verification system 2440 may provide information to a user system responsive to a request. A verification service might, for example, provide advertising message information obtained from the advertiser systems 2470, 2475. In at least one embodiment, the verification system 2440 is used to provide and track responses to advertisements received from advertisers and delivered to users by publishers. The verification system 2440 may obtain revenue based at least in part on advertising revenue. The verification system 2440 may manage advertising delivery on behalf of an advertiser.

The verification system 2440 is communicatively coupled with the verification database 2445. As will be described herein in further detail below, the verification database 2445 includes data that is processed in association with operation of the embodiments. Although FIG. 24 illustrates the verification database 2445 as a separate component of the system, the verification database 2445 may be integrated with the verification system 2440. Further, the records maintained in the verification database 2445 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the verification database 2445 may reside in any suitable elements of the system 2400. While the verification system 2440 is depicted as a separate component of the system, the verification system 2440 may be integrated with the publisher system 2430, the aggregator systems, 2460, 2465, the wireless carrier systems 2450, 2455 and/or the advertiser systems 2470, 2475.

The wireless carrier systems 2450, 2455, provide access to a wireless network, which may be used to deliver messages to and/or from users. The wireless carrier systems 2450, 2455, may receive a message via a web service protocol, which may be delivered via a wireless network, and may receive a message via a wireless network, which may be provided via a web protocol.

The aggregator systems 2460, 2465, may act as a routing system between a wireless carrier system and other elements of the system 2400. The aggregator systems 2460, 2465, may receive messages from a system such as the publisher system 2430 and/or the verification system 2440 and may distribute the message to a wireless carrier system 2450, 2455, associated with a target user of the message. Similarly, the aggregator systems 2460, 2465 may receive messages from the wireless carrier systems 2450, 2455, and provide the messages to a system such as the verification system 2440. In at least one embodiment, the verification system 2440 and/or the publisher system 2430 may send and receive messages, such as SMS messages, directly with a wireless carrier system without use of an aggregator system.

A user system 2405, 2410, a wireless carrier system 2450, 2455, an aggregator system 2460, 2465, an advertiser system 2470, 2475, a verification system 2440, a WAP server 2435, a voice server 2420, and/or a publisher system 2430 may be a desktop or mobile PC or Mac®, a mobile phone, a smart phone, a PDA, a server system, a landline phone, a specialized communication terminal, a terminal connected to a mainframe, or any other communication device and/or system. The wireless carrier systems 2450, 2455, the aggregator systems 2460, 2465, the advertiser systems 2470, 2475, the verification system 2440, the WAP server 2435, the voice server 2420, and/or the publisher system 2430 may include one or more servers, computers, etc. For example, servers such as the PowerEdge® 2900 by Dell, or the BladeCenterJS22 by IBM, or equivalent systems, might be used to implement elements of the system 2400. The system 2400 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as a user system, a wireless carrier system, an aggregator system, an advertiser system, a verification system, a WAP server, a voice server, and/or a publisher system.

The wireless carrier systems 2450, 2455, may be registered with the publisher system 2430, the verification system 2440, and/or the aggregator systems 2460, 2465, and information of the wireless carrier systems 2450, 2455 may be recorded. A wireless carrier associated with a subscriber may provide information of a user system which has originated a request or message. In at least one embodiment, the verification system 2440 and/or the publisher system 2430 may communicate with a wireless carrier system directly. The aggregator systems 2460, 2465, may or may not be present in embodiments of the system 2400, as needed to provide service to a user.

The aggregator systems 2460, 2465, may be registered with the publisher system 2430, and/or the verification system 2440 and information of the aggregator systems 2460, 2465 may be recorded. An aggregator system may provide information of a carrier and a user associated with a message. A messaging protocol associated with an aggregator may be provided to the publisher system 2430 and the verification system 2440.

The advertiser systems 2470, 2475, may be registered with the publisher system 2430, and/or the verification system 2440 and information of the advertiser systems 2470, 2475 may be recorded. The advertiser systems 2470, 2475, may provide advertisements and/or targeting information associated with advertisements to the verification system 2440, and/or the publisher system 2430. Information of advertisements and/or targeting may be stored in the publisher database 2425, and/or the verification database 2445. A communication protocol associated with an aggregator and/or a wireless carrier may be utilized by the publisher system 2430 and/or the verification system 2440 to confirm advertising performance as further described herein.

A user system may be identified by the publisher system 2430. For example, if the user system 2410 sends a message to the wireless carrier system 2450, the wireless carrier system 2450 may direct the message to the aggregator system 2465, which may route the message to the verification system 2440 and/or the publisher system 2430 based on a target destination such as a short code associated with the publisher system 2430. The publisher system 2430 may obtain a subscriber ID associated with the user system 2410 which may be used to provide a response to the user system 2410. An identifier of a user may be shared between the publisher system 2430, the verification system 2440, and/or the advertiser systems 2470, which may be used to verify advertising performance. Messages associated with the user system 2410 which are delivered via any communication services associated with the user system 2410 may be examined in order to verify advertising performance. An identifier of a user may be based on a random number associated with a subscriber ID.

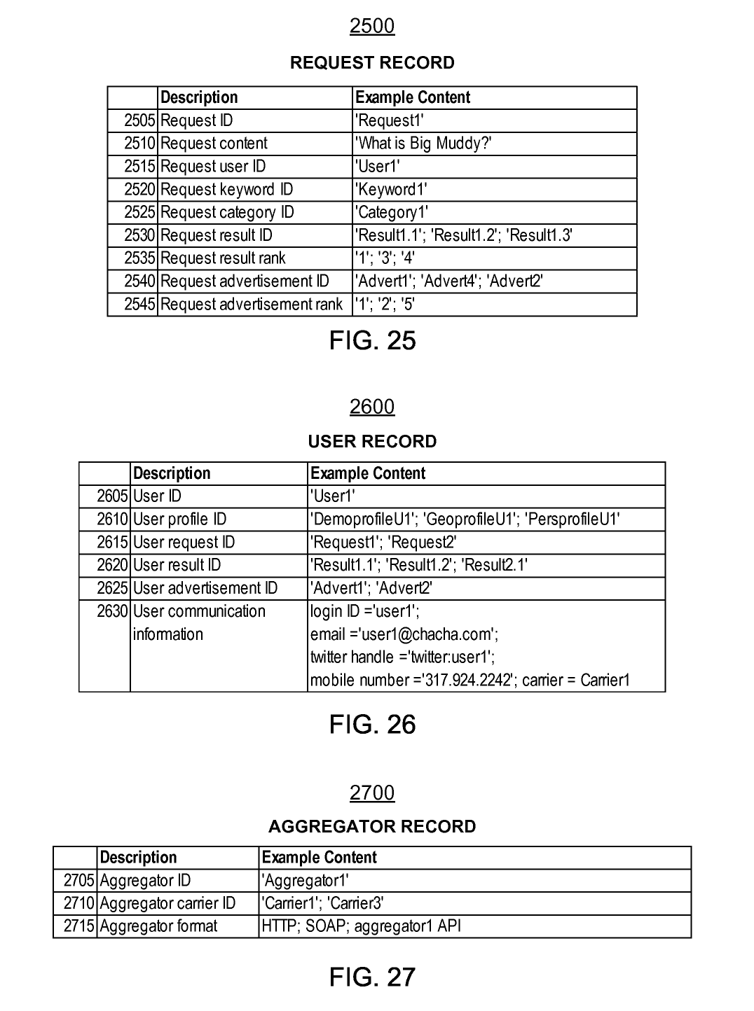

As illustrated in FIG. 25, an exemplary request record 2500 is provided, of which one or more may be associated with or resident in the publisher database 2425 (FIG. 24). The request record 2500 may include a request ID field 2505, a request content field 2510, a request user ID field 2515, a request keyword ID field 2520, a request category ID field 2525, a request result ID field 2530, a request result rank field 2535, a request advertisement ID field 2540, and a request advertisement rank field 2545. A request record may be created if a request is received by the publisher system 2430 (FIG. 24).

The request ID field 2505 (FIG. 25) preferably contains a unique identifier of a request, which is preferably used consistently. For example, in at least one embodiment, the request ID field 2505 can include a randomly generated numerical code, and/or a text string indicating the content of a query. A request ID serves to distinguish the request record associated with a request from a request record associated with other requests. Other unique identifiers of a request may be utilized without departing from the spirit and scope of the embodiments. As illustrated in FIG. 25, ‘Request1’ is the request ID associated with the request record 2500.

The request content field 2510 may include information regarding content of a request. For example, text associated with a request submitted by a user may be indicated in the request content field 2510. Content indicated in the request content field 2510 may be processed in order to associate a keyword and/or category and/or other information with a request. Information such as audio recordings, images, etc., which are associated with a request may be indicated in the request content field 2510. Using the example illustrated in FIG. 25, the text ‘What is Big Muddy?’ is the request content associated with ‘Request1’. This may, for example, indicate that ‘Request1’ including the text ‘What is Big Muddy?’ may have been submitted by ‘User1’.

The request user ID field 2515 may include information of a user that submitted a request. The request user ID field 2515 may be used to associate a user with a query or request. An identifier of any number of users may be indicated in the request user ID field 2515. Information indicated in the request user ID field 2515 may be used to obtain information of a user using a record such as the user record 2600 illustrated in FIG. 26. Using the example illustrated in FIG. 25, ‘User1’ has been associated with ‘Request1’. This may indicate that ‘User1’ submitted ‘Request1’.

The request keyword ID field 2520 may include information of a number of keywords associated with a request. For example, if content of a request includes a keyword, the keyword may be included in the request keyword ID field 2520. Any type of processing may be applied to a request to select keywords associated with a request. For example, content of text associated with a request may be parsed to determine keywords associated with a request. Synonyms associated with keywords parsed from a request, etc., may be used to determine a keyword associated with a request. A keyword may be associated with a request for the purposes of targeting an advertisement and/or other information which is to be delivered to a user responsive to the request. Using the example in FIG. 25, ‘Keyword1’ is associated with ‘Request1’. This may indicate that the publisher system 2430 (FIG. 24) has determined that ‘Keyword1’ is associated with ‘What is Big Muddy?’.

The request category ID field 2525 may include information of a number of categories associated with a request. Any type of processing may be applied to a request to select a category associated with a request. For example, analysis of keywords indicated in a request may be used to determine that a request is related to a category. A category may be associated with a request for the purpose of targeting an advertisement and/or other information that is to be delivered to a user responsive to the request. In at least one embodiment, a human assistant or ‘guide’ may associate a category with a request. Using the example illustrated in FIG. 25, ‘Category1’ is associated with ‘Request1’. This may indicate that the publisher system 2430 (FIG. 24) has determined that ‘Category1’ is associated with content indicated in the request content field 2510.

The request result ID field 2530 may include information of a result or response to a user request which is associated with a request. For example, a request for information may be associated with a response or search result produced by a person and/or may be selected from a database and/or using an index based on a category, keyword, and/or other information associated with a query. Any number of results may be associated with a request. Using the example illustrated in FIG. 25, ‘Result1.1’, ‘Result1.2’, and ‘Result1.3’ have been associated with ‘Request1’. This may indicate that ‘Result1.1’, ‘Result1.2’, and ‘Result1.3’ may potentially be provided responsive to ‘Request1’. In at least one embodiment, a result may be text of an SMS message which may be delivered to a user responsive to a request.

The request result rank field 2535 may include information of a ranking associated with a result. For example, a ranking of a result associated with a request may be based on a ranking of a result associated with a keyword and/or category associated with a request. If a result has a high ranking associated with a keyword and/or category associated with a request, the result may have a high ranking associated with the query. In at least one embodiment, the request result ID field 2530 and the request result rank field 2535 may be linked by, for example, a pointer. Using the example in FIG. 25, ‘Result1.1’ has the ranking ‘1’, ‘Result1.2’ has the ranking ‘3’, and ‘Result1.3’ has the ranking ‘4’. This may indicate that ‘Result1.1’ is most likely to be presented to ‘User1’ responsive to ‘Request1’.

The request advertisement ID field 2540 may include information of an ‘advertisement’ or sponsored message which is associated with a request. For example, a request for information may be associated with an advertisement by a person and/or selected from a database and/or selected using an index based on a category, keyword, and/or other information associated with a query. Any number of advertisements may be associated with a request. Using the example illustrated in FIG. 25, ‘Advert1’, ‘Advert4’, and ‘Advert2’ have been associated with ‘Request1’. This may indicate that ‘Advert1’, ‘Advert4’, and ‘Advert2’ may potentially be provided responsive to ‘Request1’. In at least one embodiment, an advertisement may be text of an SMS message which may be delivered to a user responsive to a request.

The request advertisement rank field 2545 may include information of a ranking associated with an advertisement. For example, a ranking of an advertisement associated with a request may be based on a ranking of an advertisement associated with a keyword and/or category associated with a request. If an advertisement has a high ranking associated with a keyword and/or category associated with a request, the advertisement may have a high ranking associated with the query. In at least one embodiment, the request advertisement ID field 2540 and the request advertisement rank field 2545 may be linked by, for example, a pointer. Using the example in FIG. 25, ‘Advert1’ has the ranking ‘1’, ‘Advert4’ has the ranking ‘2’, and ‘Advert2’ has the ranking ‘5’. This may indicate that ‘Advert1’ is most likely to be presented to ‘User1’ responsive to ‘Request1’.

Ranking of an advertisement may be performed by any suitable element of the system 2400 (FIG. 24). In at least one embodiment, the publisher system 2430 may perform ranking and selection of advertisements. In at least one embodiment, the verification system 2440 may perform ranking and selection of advertisements. While the example of ranking an advertisement and/or a result using a category and a keyword are used for the purposes of illustration, any type of ranking method may be used to determine a ranking, which may be based on any information available to the publisher system 2430. For example, compensation, profile information, geographic information, temporal information, user history, a wireless carrier, etc., may be used to determine a rank of an item such as a result, advertisement, etc.

As illustrated in FIG. 26, an exemplary user record 2600 is provided, of which one or more may be associated with or resident in the publisher database 2425 (FIG. 24). The user record 2600 may include a user ID field 2605, a user profile ID field 2610, a user request ID field 2615, a user result ID field 2620, a user advertisement ID field 2625, and a user communication information field 2630.

The user ID field 2605 preferably contains a unique identifier of a user, which is preferably used consistently. For example, in at least one embodiment, the user ID field 2605 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 26, ‘User1’ is the user ID associated with the user record 2600.

The user profile ID field 2610 may include information of a profile associated with a user. A profile may indicate characteristics of a user which may be used to rank and/or select an item such as an advertisement, a result, etc. A profile may include information such as geographic, demographic, personality, preference, affiliation, etc., information regarding a user. Using the example illustrated in FIG. 26, the profiles ‘DemoprofileU1’, ‘GeoprofileU1’ and ‘PersprofileU1’ are associated with the user ‘User1’. This may indicate that ‘User1’ has indicated and/or generated information indicated in the profiles ‘DemoprofileU1’ which may be a demographic profile, ‘GeoprofileU1’ which may be a geographic profile and ‘PersprofileU1’ which might indicate personality information regarding the user ‘User1’.

The user request ID field 2615 may include information of a request associated with a user. Content of the user request ID field 2615 may be modified based on actions of a user. If a user submits a request to the publisher system 2430 (FIG. 24), an identifier of the request may be included in the user request ID field 2615. Using the example illustrated in FIG. 26, the requests ‘Request1’ and ‘Request2’ are associated with the user ‘User1’. This may indicate that ‘User1’ has submitted the requests ‘Request1’ and ‘Request2’ to the publisher system 2430 (FIG. 24).

The user result ID field 2620 may include information of a result associated with a user. Content of the user result ID field 2620 may be modified based on actions of a user. If a user receives a result responsive to a request, an identifier of the result may be included in the user result ID field 2620. A usage indicator associated with a result provided to a user may affect a rating and/or ranking associated with a result. Using the example illustrated in FIG. 26, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’ responsive to a request.

The user advertisement ID field 2625 may include information of an advertisement associated with a user. Content of the user advertisement ID field 2625 may be modified based on actions of a user. If a user receives an advertisement responsive to a request, an identifier of the advertisement may be included in the user advertisement ID field 2625. Using the example illustrated in FIG. 26, the advertisements ‘Advert1’ and ‘Advert2’ are associated with the user ‘User1’. This may indicate that ‘User1’ has been presented with ‘Advert1’ and ‘Advert2’.

The user communication information field 2630 may include information of a device and/or service associated with a user. Content of the user communication information field 2630 may be modified based on actions of a user. If a user establishes communications with the publisher system 2430 using a device and/or service, information regarding the device and/or service may be included in the user communication information field 2630. Any type of communication service and/or system may be indicated in the user communication information field 2630. For example, a username and/or password associated with a user may be indicated in the user communication information field 2630. Communication services such as Instant Messaging (IM), e-mail, SMS, MMS, EMS, telephone, wireless or wired communication, etc., may be indicated in the user communication information field 2630. A telephone number, an email address, an IM provider and login ID, a keyword associated with a service, etc., may be indicated in the user communication information field 2630. Using the example illustrated in FIG. 26, the login ID ‘user1’, the email ‘user1@chacha.com’, the Twitter™ service account ‘twitter:user1’, the phone number ‘317.924.2242’, and the wireless carrier ‘wireless1’ are associated with the user ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’ which may be associated with the carrier ‘Carrier1’.

As illustrated in FIG. 27, an exemplary aggregator record 2700 is provided, of which one or more may be associated with or resident in the publisher database 2425 (FIG. 24) and/or the verification database 2445. The aggregator record 2700 may include an aggregator ID field 2705, an aggregator carrier ID field 2710, and an aggregator format field 2715.

The aggregator ID field 2705 preferably contains a unique identifier of an aggregator, which is preferably used consistently. For example, in at least one embodiment, the aggregator ID field 2705 can include a randomly generated numerical code, and/or a text string indicating a name associated with an aggregator. An aggregator ID serves to distinguish an aggregator record associated with an aggregator from an aggregator record associated with other aggregators. Other unique identifiers of an aggregator may be utilized without departing from the spirit and scope of the embodiments. Using the example illustrated in FIG. 27, ‘Aggregator1’ is the aggregator ID associated with the aggregator record 2700.

The aggregator carrier ID field 2710 may include information of wireless carriers associated with an aggregator. A carrier ID associated with an aggregator may be used to determine a destination for a message to be delivered to a user. For example, the user communication information field 2630 (FIG. 26) indicates that ‘User 1’ is associated with the wireless carrier ‘Carrier1’. If a message is to be delivered to ‘User1’ the message may be sent to ‘Aggregator1’ via the aggregator carrier ID ‘Carrier1’.

The aggregator format field 2715 may include information of a communication protocol associated with an aggregator. For example, a transport protocol, a packet format, and an API may be defined. Any information required to send and/or receive a message via an aggregator may be indicated in the aggregator format field 2715. Information indicated in the aggregator format field 2715 may be used to decode messages in order that advertising performance may be confirmed. For example, the verification system 2440 may decode a message from the publisher system 2430 to the aggregator system 2465 to determine an advertisement delivered to a user, or the verification system 2440 may decode a message from the aggregator system 2460 to determine if a response code associated with an advertisement is indicated in the message. Using the example illustrated in FIG. 27, the protocols ‘HTTP’, ‘SOAP’ and ‘aggregator1 API’ are associated with ‘Aggregator1’.

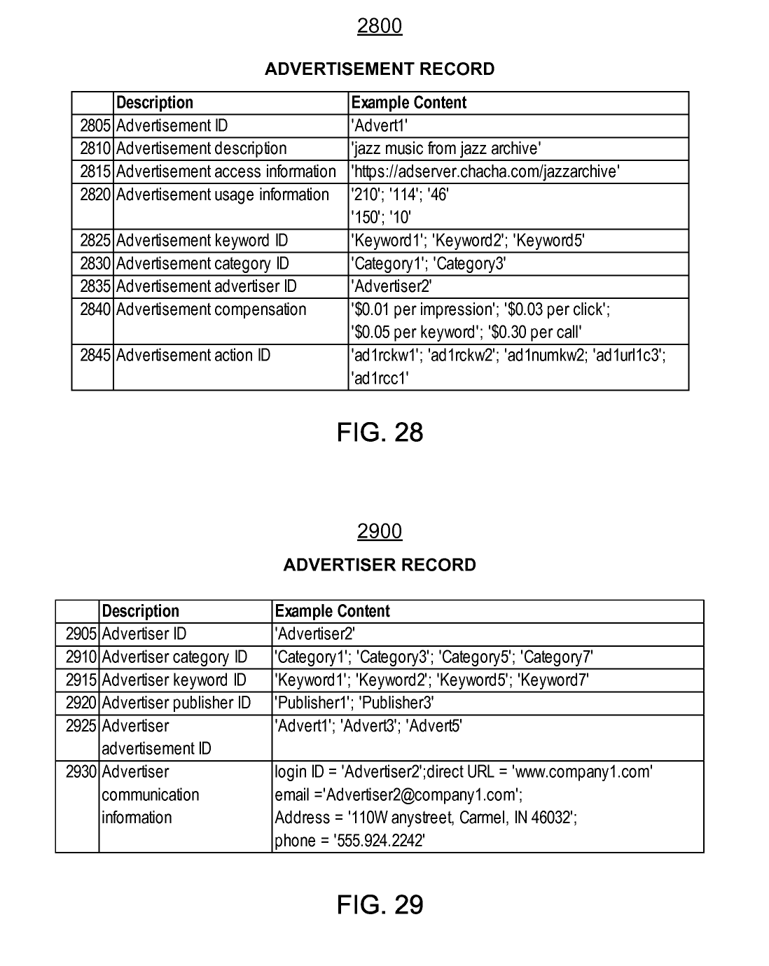

As illustrated in FIG. 28, an exemplary advertisement record 2800 is provided, of which one or more may be associated with or resident in the publisher database 2425 (FIG. 24) and/or the verification database 2445. The advertisement record 2800 may include an advertisement ID field 2805, an advertisement description field 2810, an advertisement access information field 2815, an advertisement usage information field 2820, an advertisement keyword ID field 2825, an advertisement category ID field 2830, an advertisement advertiser ID field 2835, an advertisement compensation field 2840, and an advertisement action ID field 2845.

The advertisement ID field 2805 preferably contains a unique identifier of an advertisement, which is preferably used consistently. For example, in at least one embodiment, the advertisement ID field 2805 can include a randomly generated numerical code, and/or a text string indicating a name associated with an advertisement. An advertisement ID serves to distinguish the advertisement record associated with an advertisement from an advertisement record associated with other advertisements. Other unique identifiers of an advertisement may be utilized without departing from the spirit and scope of the embodiments. In at least one embodiment, an advertisement ID may include a description associated with an advertisement. Using the example illustrated in FIG. 28, ‘Advert1’ is the advertisement ID associated with the advertisement record 2800.

The advertisement description field 2810 may include information of a description associated with an advertisement. For example, a description of an advertisement may be presented to a person in order that the person may select an advertisement to be associated with targeting information. Using the example illustrated in FIG. 28, ‘jazz music from jazz archive’ is the advertisement description associated with the advertisement ‘Advert1’. Any type of information such as text, audio, video, images, etc., may be indicated in the advertisement description field 2810.

The advertisement access information field 2815 may include access information associated with an advertisement. For example, a URL may be indicated in the advertisement access information field 2815. Information contained in the advertisement access information field 2815 may be used to provide access to an advertisement. Using the example illustrated in FIG. 28, the URL ‘https://adserver.chacha.com/jazzarchive’ is the access information associated with the advertisement ‘Advert1’. This may for example indicate that the advertisement ‘Advert1’ may be delivered using content accessed at ‘https://adserver.chacha.com/jazzarchive’. Advertisement access information may indicate a resource associated with an advertisement.

The advertisement usage information field 2820 may include information regarding the use of an advertisement. For example, a number of times that an advertisement has been delivered to a user may be indicated in the advertisement usage information field 2820. Using the example illustrated in FIG. 28, the indicators ‘210’, ‘114’, ‘46’, ‘150’ and ‘10’ are associated with ‘Advert1’. The advertisement usage information field 2820 may indicate usage of ‘Advert1’ for any purpose.

The advertisement keyword ID field 2825 may include information of a number of keywords which may be associated with an advertisement. In at least one embodiment, the advertisement keyword ID field 2825 and the advertisement usage information field 2820 may be linked by, for example, a pointer. Using the example illustrated in FIG. 28, ‘Keyword1’, ‘Keyword2’, and ‘Keyword5’ are associated with the advertisement ‘Advert1’. This may, for example, indicate that the advertisement ‘Advert1’ has been selected and/or presented ‘210’, ‘114’, and ‘46’ times responsive to requests associated with the keywords ‘Keyword1’, ‘Keyword2’, and ‘Keyword5’, respectively. Any item may be indicated in the advertisement keyword ID field 2825, including but not limited to any or all of a word, phrase, sentence, image, audio, video, etc. A keyword may be selected to be associated with an advertisement in order that the advertisement may be ranked.

The advertisement category ID field 2830 may include information of a number of categories associated with an advertisement. In at least one embodiment, the advertisement category ID field 2830 and the advertisement usage information field 2820 may be linked by, for example, a pointer. Using the example illustrated in FIG. 28, the categories ‘Category1’ and ‘Category3’ are associated with the advertisement ‘Advert1’. This may, for example, indicate that the advertisement ‘Advert1’ has been selected and/or presented ‘150’, and ‘10’ times in association with the categories ‘Category1’ and ‘Category3’. A category may be selected to be associated with an advertisement in order that the advertisement may be ranked.

The advertisement advertiser ID field 2835 may include information of a number of advertisers associated with an advertisement. In at least one embodiment, information indicated in the advertisement advertiser ID field 2835 may be used to ‘look up’ information of an advertiser using a record such as the advertiser record 2900 illustrated in FIG. 29. Using the example illustrated in FIG. 28, the advertiser ‘Advertiser2’ is associated with the advertisement ‘Advert1’. This may indicate that ‘Advertiser2’ has provided information associated with the advertisement ‘Advert1’.

The advertisement compensation field 2840 may include information of compensation associated with an advertisement. Information regarding compensation for the publisher system 2430 (FIG. 24) may be indicated in the advertisement compensation field 2840. In at least one embodiment, compensation information may be based on a type of response and/or delivery associated with an advertisement. Using the example illustrated in FIG. 28, the compensation information ‘$0.01 per impression’, ‘$0.03 per click’, ‘$0.05 per keyword’, and ‘$0.30 per call’ is associated with ‘Advert1’. This may, for example, indicate various levels of compensation which may be provided to a publisher and/or a verification system responsive to actions taken responsive to ‘Advert1’. For example, if the verification system 2440 determines that ‘Advert1’ is delivered to a user in an SMS message, a publisher system delivering the SMS message may receive ‘$0.01’, that a user responds with the keyword ‘ad1rckw1’ (i.e. a response keyword), a publisher system delivering the original advertisement may receive ‘$0.05’ for a response.

The advertisement action ID field 2845 may include information of actions associated with an advertisement. Content of the advertisement action ID field 2845 may be modified by the verification system 2440 (FIG. 24). Actions associated with an advertisement may be used to identify a publisher, a keyword, a category, etc., which may have been used to target an advertisement. For example, ‘ad1rckw1’ might be a response code provided to a user if ‘Advert1’ is presented to the user based on targeting with ‘Keyword1’. If the response code ‘ad1rckw1’ is detected by the verification system 2440, it may indicate that a user has responded to ‘Advert1’ when ‘Advert1’ was targeted to the user based on ‘Keyword1’. Similarly a tracking phone number, URL, or other identifier might be associated with an advertising message, which may be detected by the verification system 2440. For example, if an SMS message includes a URL, activation of the URL may direct a browser to a server associated with the verification system 2440. Likewise, if an SMS message includes a phone number, if a call is placed to that number, it may be received by the voice server 2420 (FIG. 24), which may deliver a message to the verification system 2440 associated with the tracking phone number, which may be recorded for verification of performance of ‘Advert1’ as delivered by a publisher. A call received at a tracking phone number may be routed to a destination by, for example, the voice server 2420, the publisher system 2430, and/or the verification system 2440.

As illustrated in FIG. 29, an exemplary advertiser record 2900 is provided, of which one or more may be associated with or resident in the publisher database 2425 (FIG. 24) and/or the verification database 2445. The advertiser record 2900 may include an advertiser ID field 2905, an advertiser category ID field 2910, an advertiser keyword ID field 2915, an advertiser publisher ID field 2920, an advertiser advertisement ID field 2925, and an advertiser communication information field 2930.

The advertiser ID field 2905 preferably contains a unique identifier of an advertiser, which is preferably used consistently. For example, in at least one embodiment, the advertiser ID field 2905 can include a randomly generated numerical code, and/or a text string indicating a name associated with an advertiser. An advertiser ID serves to distinguish the advertiser record associated with an advertiser from an advertiser record associated with other advertisers. Other unique identifiers of an advertiser may be utilized without departing from the spirit and scope of the embodiments. Using the example illustrated in FIG. 29, ‘Advertiser2’ is the advertiser ID associated with the advertiser record 2900.

The advertiser category ID field 2910 may include information of a number of categories associated with an advertiser. The content of the advertiser category ID field 2910 may be modified based on actions of an advertiser. A person such as an advertiser, a system administrator, a guide, etc., may select a category which is associated with an advertiser. A category may be associated with an advertiser based on testing. A category may be associated with an advertiser based on an affiliate group associated with an advertiser. For example, if an advertiser has chosen to be associated with affiliate groups associated with basketball (e.g., Pacer fans), a category associated with basketball (e.g., sports>professional) might be associated with the advertiser. A category associated with an advertiser may be used to select items which are to be presented to an advertiser. For example, information of keywords and advertisements associated with ‘Category1’ might be provided to advertisers associated with ‘Category1’ to assist in selecting keywords associated with an advertisement. Using the example illustrated in FIG. 29, the categories ‘Category1’, ‘Category3’, ‘Category5’ and ‘Category7’ are associated with ‘Advertiser2’. Advertisements associated with an advertiser may be associated with a category associated with an advertiser automatically,

The advertiser keyword ID field 2915 may include information of a number of topics or keywords associated with an advertiser. Content of the advertiser keyword ID field 2915 may be modified based on actions of an advertiser. A person may select a keyword which is associated with an advertiser. For example, an advertiser may select a keyword to be associated with the advertiser during a registration process. Content of the advertiser keyword ID field 2915 may be compared to the content of a request in order to determine a ranking of an advertiser for responding to a request. Using the example illustrated in FIG. 29, the keywords ‘Keyword1’, ‘Keyword2’, ‘Keyword5’, and ‘Keyword7’ are associated with ‘Advertiser2’. This may, for example, indicate that ‘Advertiser2’ has selected to associate those keywords with a number of advertisements associated with ‘Advertiser2’.

The advertiser publisher ID field 2920 may include information of a number of publishers associated with an advertiser. The content of the advertiser publisher ID field 2920 may be modified based on actions of an advertiser. Association of a publisher with an advertiser may indicate that an advertiser and a publisher have agreed to publish advertisements of the advertiser using media and/or services associated with the publisher. For example, a publisher of information via SMS might agree with an advertiser to include advertisements provided by the advertiser in SMS messages associated with information provided by the publisher.

The advertiser advertisement ID field 2925 may include information of a number of advertisements associated with an advertiser. Content of the advertiser advertisement ID field 2925 may be modified based on actions of an advertiser. If an advertiser provides advertisements to be published, an indicator of the advertisement may be included in the advertiser advertisement ID field 2925. Using the example illustrated in FIG. 29, the advertisements ‘Advert1’, ‘Advert3’ and ‘Advert5’ are associated with the advertiser ‘Advertiser2’. This may indicate that ‘Advertiser2’ has provided the advertisements ‘Advert1’, ‘Advert3’ and ‘Advert5’.

The advertiser communication information field 2930 may include information of a number of devices and/or services associated with an advertiser. Content of the advertiser communication information field 2930 may be modified based on actions of an advertiser. If an advertiser establishes communications using a device and/or service information regarding the device and/or service may be included in the advertiser communication information field 2930. Any type of communication service and/or system may be indicated in the advertiser communication information field 2930. For example, a username and/or password associated with an advertiser may be indicated in the advertiser communication information field 2930. Communication services such as IM, e-mail, SMS, MMS, EMS, telephone, wireless or wired communication, etc., may be indicated in the advertiser communication information field 2930. A telephone number, an email address, an IM provider and login ID, a keyword associated with a service, an IP address, a MAC address, a URL, etc., may be indicated in the advertiser communication information field 2930. Using the example illustrated in FIG. 29, the login ID ‘Advertiser2’, and the direct URL ‘www.company1.com’, the email ‘Advertiser2@company1.com’, the physical address ‘110W anystreet, Carmel, Ind. 46032’ and the phone number ‘555.924.2242’ are associated with the advertiser ‘Advertiser2’. This may indicate, for example, a login ID whereby ‘Advertiser2’ may obtain information regarding advertising performance, a URL to which a tracking URL might forward, an email contact address, a physical address and a phone number associated with ‘Advertiser2’.

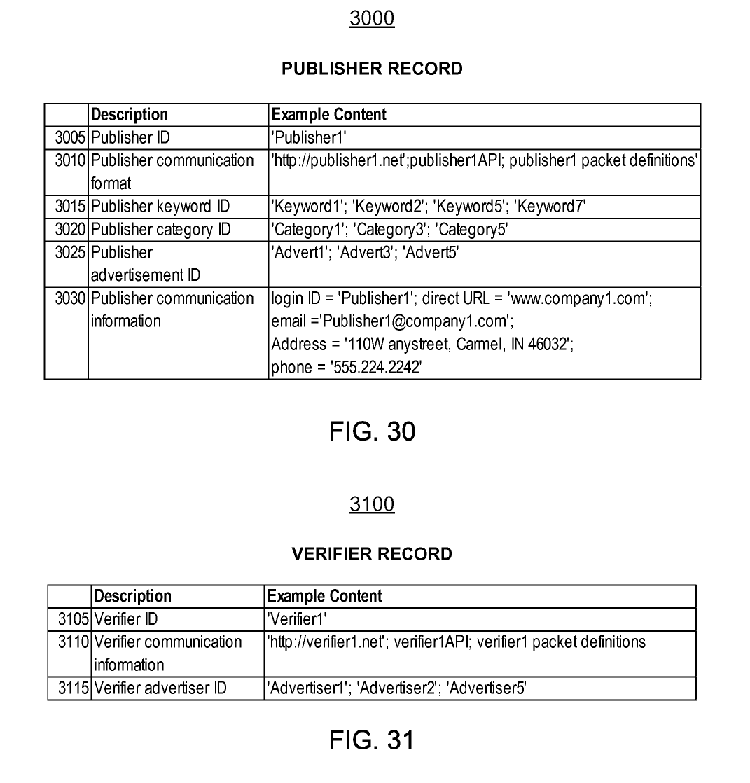

As illustrated in FIG. 30, an exemplary publisher record 3000 is provided, of which one or more may be associated with or resident in the verification database 2445. The publisher record 3000 may include a publisher ID field 3005, a publisher communication format field 3010, a publisher keyword ID field 3015, a publisher category ID field 3020, a publisher advertisement ID field 3025, and a publisher communication information field 3030.

The publisher ID field 3005 preferably contains a unique identifier of a publisher, which is preferably used consistently. For example, in at least one embodiment, the publisher ID field 3005 can include a randomly generated numerical code, and/or a text string indicating a name associated with a publisher. A publisher ID serves to distinguish the publisher record associated with a publisher from a publisher record associated with other publishers. Other unique identifiers of a publisher may be utilized without departing from the spirit and scope of the embodiments. Using the example illustrated in FIG. 30, ‘Publisher1’ is the publisher ID associated with the publisher record 3000.

The publisher communication format field 3010 may include information of a communication format associated with a publisher. Content of the publisher communication format field 3010 may be used by the verification system 2440 (FIG. 24) to examine content of messages between the publisher system 2430 and other elements of the system 2400. For example, content of outbound messages to a user via an aggregator and/or carrier, and/or incoming messages from an aggregator and/or carrier may be decoded to verify advertising performance using information indicated in the publisher communication format field 3010. As illustrated in FIG. 30, a URL, ‘http://publisher1.net’, an API ‘publisher1API’, and a packet definition associated with ‘Publisher1’ is indicated.

The publisher keyword ID field 3015 may include information of a number of keywords associated with a publisher. Content of the publisher keyword ID field 3015 may be modified based on actions of a publisher. A person may select a keyword which is associated with a publisher. For example, a publisher may select a keyword to be associated with the publisher during a registration process. A publisher may provide a list of keywords to an advertiser and/or verification service, which may be indicated in the publisher keyword ID field 3015. Content of the publisher keyword ID field 3015 may be used for various purposes. For example, content of the publisher keyword ID field 3015 may be compared to the content of a request in order to determine a ranking of a publisher for responding to a request, or keywords associated with a publisher may be used to rank the publisher for receiving an advertisement associated with the keywords. Using the example illustrated in FIG. 30, the keywords ‘Keyword1’, ‘Keyword2’, ‘Keyword5’, and ‘Keyword7’ are associated with ‘Publisher1’. This may for example indicate that ‘Publisher1’ has elected to accept advertisements associated with those keywords for publication.

The publisher category ID field 3020 may include information of a number of categories associated with a publisher. Content of the publisher category ID field 3020 may be modified based on actions of a publisher. A person may select a category which is associated with a publisher. A category may be associated with a publisher based on testing. A category may be associated with a publisher based on an affiliate group associated with a publisher. For example, if a publisher has chosen to be associated with affiliate groups associated with basketball (e.g., Pacer fans), a category associated with basketball (e.g., sports>professional) might be associated with the publisher. A category associated with a publisher may be used to select items which are to be presented to a publisher. For example, information of keywords and advertisements associated with ‘Category1’ might be provided to publishers associated with ‘Category1’. Using the example illustrated in FIG. 30, the categories ‘Category1’, ‘Category3’, and ‘Category5’ are associated with ‘Publisher1’. A publisher may associate an advertisement with a category to target the advertisement. A publisher may elect to publish and/or not to publish advertisements associated with a category.

The publisher advertisement ID field 3025 may include information of a number of advertisements associated with a publisher. Content of the publisher advertisement ID field 3025 may be modified based on actions of a publisher. If a publisher accepts advertisements to be published, an indicator of the advertisement may be included in the publisher advertisement ID field 3025. Using the example illustrated in FIG. 30, the advertisements ‘Advert1’, ‘Advert3’ and ‘Advert5’ are associated with the publisher ‘Publisher1’. This may indicate that ‘Publisher1’ has provided and/or published ‘Advert1’, ‘Advert3’ and ‘Advert5’.

The publisher communication information field 3030 may include information of a number of devices and/or services associated with a publisher. Content of the publisher communication information field 3030 may be modified based on actions of a publisher. If a publisher establishes communications using a device and/or service information regarding the device and/or service, this may be included in the publisher communication information field 3030. Any type of communication service and/or system may be indicated in the publisher communication information field 3030. For example, a username and/or password associated with a publisher may be indicated in the publisher communication information field 3030. Communication services such as IM, e-mail, SMS, MMS, EMS, telephone, wireless or wired communication, etc., may be indicated in the publisher communication information field 3030. A telephone number, an email address, an IM provider and login ID, a keyword associated with a service, an IP address, a URL, etc., may be indicated in the publisher communication information field 3030. Using the example illustrated in FIG. 30, the login ‘Publisher1’, the direct URL ‘www.company1.com’, the email ‘Publisher1@company1.com’, the physical address ‘110W anystreet, Carmel, Ind. 46032’ and the phone number ‘555.224.2242’ are associated with the publisher ‘Publisher1’. This may indicate for example, a login ID whereby ‘Publisher1’ may obtain information regarding advertising performance, a URL of a company website, an email contact address, a physical address and a phone number associated with ‘Publisher1’.

As illustrated in FIG. 31, an exemplary verifier record 3100 is provided, of which one or more may be associated with or resident in the publisher database 2425 (FIG. 24). The verifier record 3100 may include a verifier ID field 3105, a verifier communication information field 3110, and a verifier advertiser ID field 3115.

The verifier ID field 3105 preferably contains a unique identifier of a verifier, which is preferably used consistently. For example, in at least one embodiment, the verifier ID field 3105 can include a randomly generated numerical code, and/or a text string indicating a name associated with a verifier. A verifier ID serves to distinguish the verifier record associated with a verifier from a verifier record associated with other verifiers. Other unique identifiers of a verifier may be utilized without departing from the spirit and scope of the embodiments. Using the example illustrated in FIG. 31, ‘Verifier1’ is the verifier ID associated with the verifier record 3100.

The verifier communication information field 3110 may include information of a communication format associated with a verifier. Content of the verifier communication format field 3110 may be used by the publisher system 2430 (FIG. 24) to deliver messages to the verification system 2440. For example, content of outbound messages to a user via a verifier, and/or content of incoming messages from a verifier may be decoded based on content of the verifier communication information field 3110 (FIG. 31). As illustrated in FIG. 31, the URL http://verifier1.net, the API ‘verifier1API’, and a packet definition associated with ‘Verifier1’ is indicated.

The verifier advertiser ID field 3115 may include information of a number of advertisers associated with a verifier. Content of the verifier advertiser ID field 3115 may be modified based on actions of an advertiser and/or a verifier. For example, if an advertiser selects a ‘Verifier1’ as a third-party advertisement server, an identifier of the advertiser may be added to the verifier advertiser ID field 3115. If an advertisement associated with an advertiser indicated in the verifier advertiser ID field 3115 is selected to be published, a publisher may deliver information to the verifier in order that advertising performance may be verified. For example, if ‘Publisher1’ elects to provide ‘Advert1’, which is associated with ‘Advertiser2’, responsive to ‘Request1’, messages between ‘Publisher1’ and ‘User1’ may be tracked by ‘Verifier1’. Using the example illustrated in FIG. 31, the advertisers ‘Advertiser1’, ‘Advertiser2’, and ‘Advertiser5’ are associated with ‘Verifier1’. This may, for example, indicate that ‘Verifier1’ has been selected as a third-party advertising server by ‘Advertiser1’, ‘Advertiser2’, and ‘Advertiser5’.

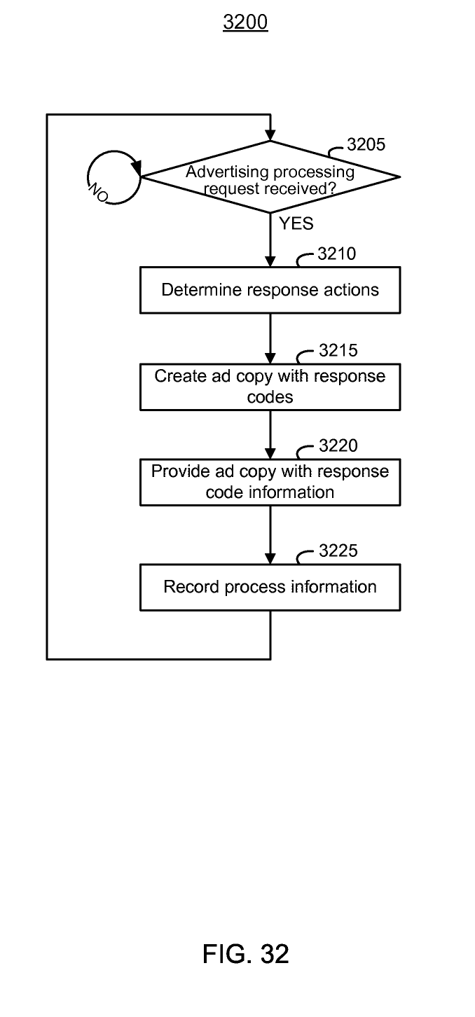

As illustrated in FIG. 32, a process 3200 for creating a tracking response for an advertisement is provided. The process 3200 may be operative in whole or in part on the publisher system 2430 (FIG. 24), the verification system 2440 and/or any suitable elements of the system 2400. In at least one embodiment, the process 3200 is performed by the verification system 2440 responsive to receipt of advertising information from the advertiser systems 2470, 2475.

In operation 3205 (FIG. 32), a determination is made as to whether an advertising processing request is received. If it is determined in operation 3205 that an advertising processing request is not received, control remains at operation 3205 and process 3200 continues. If it is determined in operation 3205 that an advertising processing request is received, control is passed to operation 3210 and process 3200 continues.

The determination in operation 3205 may be made based on various criteria. It may be determined that a request is received based on receiving a message at any device associated with a system which may provide advertisements such as the publisher system 2430 and/or a verification system (FIG. 24). For example, a voice message might be received at a telephone number, an SMS message might be received, an IM might be received, an email might be received, a web request might be received, and/or a message using any services associated with the system 2400 might be used to determine that a request has been received. A request may be received using an API.

In operation 3210, a response action is determined for an advertisement. For example, a keyword and/or a response code might be assigned to an advertisement which may allow a response to the advertisement to be tracked. Similarly a URL, a phone number, and/or any other code which may be used to identify a user action may be determined. A response code may be associated with targeting information of an advertisement. A response action may be any action by a user which may be detected by a verifier. Control is passed to operation 3215 and process 3200 continues.

In operation 3215, ad copy, including a response code, is created. A response code may be associated with actions such as a keyword, a telephone number, a URL, etc., which may be used to respond to an advertisement. Any number of response codes may be associated with an advertisement. For example, a response code may be associated with a publisher, a keyword, a category, a profile, and/or any type of information associated with delivery and/or targeting of an advertisement. Control is passed to operation 3220 and process 3200 continues.

In operation 3220, advertising information including a response code is provided. For example, advertising information may be provided to a publisher, a verifier, and/or an advertiser. An advertiser may be offered a right of review of response codes which may be read by a person such as a keyword used to respond to an SMS message or other type of text-based message. Information of a response code associated with an advertisement and/or other information of advertisements may be provided to a verifier, an advertiser, and/or a publisher. Control is passed to operation 3225 and process 3200 continues.

In operation 3225, process information is recorded. Response information associated with an advertisement is recorded. Information of a response associated with an advertisement, targeting information, compensation information, advertiser information, etc., may be recorded. For example, information may be recorded in the publisher database 2425, the verification database 2445, the advertiser system 2475, etc. Control is passed to operation 3205 and process 3200 continues.

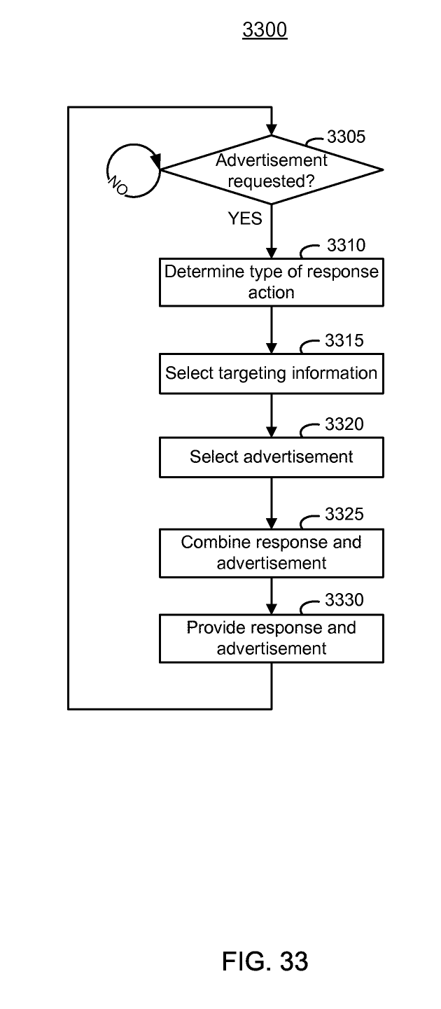

As illustrated in FIG. 33, a process 3300 for distributing advertisements is provided. The process 3300 may be operative in whole or in part on the publisher system 2430 (FIG. 24), the verification system 2440 and/or any suitable elements of the system 2400.

In operation 3305 (FIG. 33), a determination is made as to whether a request for an advertisement is received. If it is determined in operation 3305 that a request for an advertisement is not received, control remains at operation 3305 and process 3300 continues. If it is determined in operation 3305 that a request for an advertisement is received, control is passed to operation 3310 and process 3300 continues.

The determination in operation 3305 may be made based on various criteria. It may be determined that a request for an advertisement is received based on receiving a message at any device associated with a system such as the verification system 2440 (FIG. 24), the publisher system 2430, etc. A request may be received through an API. A message may be received from a publisher system, an aggregator system, an advertiser system, a user system, etc. In at least one embodiment, an advertisement is requested by the publisher system 2435 from the verification system 2440.

In operation 3310, a type of response action is determined. For example, a response action associated with an SMS message, a voice call, a URL, an image, and/or other form of advertisement may be determined to be required based on a type of media which is to be delivered to a user. Control is passed to operation 3315 and process 3300 continues.

In operation 3315, targeting information is selected. If a request for an advertisement is associated with a publisher, a keyword, a category, a profile, an aggregator, a location, a carrier, etc., an identifier associated with a response action may be determined and associated with the selected targeting information. Control is passed to operation 3320 and process 3300 continues.

In operation 3320, an advertisement is selected. For example, a highest ranking advertisement associated with a category, a keyword, a profile, compensation, and/or any combination of targeting information which may be associated with a request may be selected. Control is passed to operation 3325 and process 3300 continues.

In operation 3325, an advertisement is combined with a response indicator. A response action or response indicator may be combined with an advertisement. A response indicator may be associated with targeting information identified by a request for an advertisement. Control is passed to operation 3330 and process 3300 continues.

In operation 3330, an advertisement and a response indicator is provided. For example, if the verification system 2440 (FIG. 24) is providing an advertisement, a message may be delivered to an aggregator system and/or a carrier system targeted to a user indicated by the publisher system 2430. Similarly, if the publisher system 2430 is providing an advertisement, a message may be delivered to the verification system 2440 for processing prior to being delivered to a user via a carrier and/or aggregator. Control is passed to operation 3305 and process 3300 continues.

Use of the publisher system 2430 as an advertisement selector and/or server may allow a publisher to improve utilization of inventory available to the publisher. Use of the verification system 2440 as an advertisement selector and/or server may allow an advertiser to optimize cost and/or efficacy of advertising.

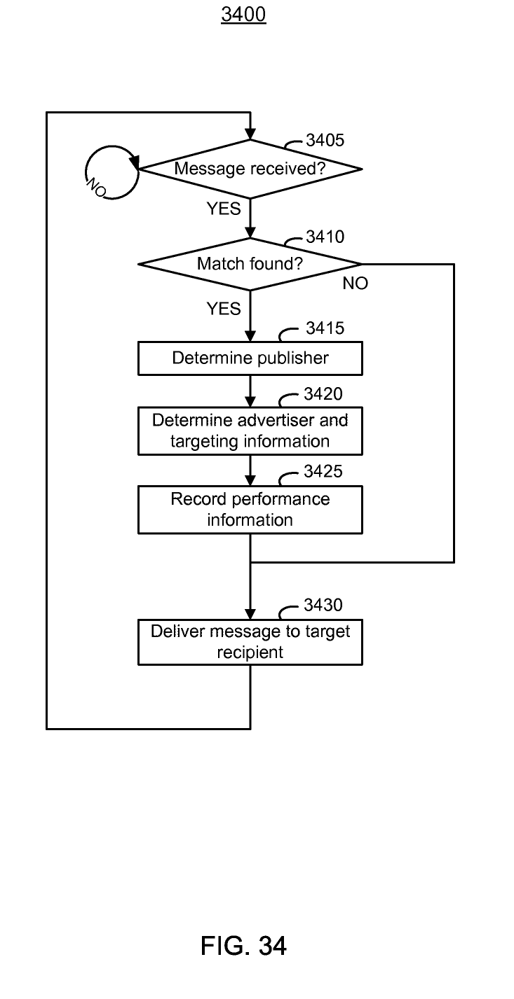

As illustrated in FIG. 34, a process 3400 for processing a message from a verifier system perspective is provided. The process 3400 may be operative in whole or in part on the publisher system 2430 (FIG. 24), the verification system 2440 and/or any suitable elements of the system 2400.

In operation 3405 (FIG. 34), a determination is made as to whether a message is received. If it is determined in operation 3405 that a message is not received, control remains at operation 3405 and process 3400 continues. If it is determined in operation 3405 that a message is received, control is passed to operation 3410 and process 3400 continues.

The determination in operation 3405 may be made based on various criteria. It may be determined that a message is received based on receiving a message at any device associated with a system such as the verification system 2440 (FIG. 24). A request may be received through an API provided in association with the verification system 2440. A message may be received from a publisher system, an aggregator system, etc.

In operation 3410 (FIG. 34), a determination is made as to whether a match to a pattern associated with an advertising message is found. If it is determined in operation 3410 that a match to a pattern associated with an advertising message is not found, control is passed to operation 3430 and process 3400 continues. If it is determined in operation 3410 that a match to a pattern associated with an advertising message is found, control is passed to operation 3415 and process 3400 continues.

The determination in operation 3410 may be made based on various criteria. In at least one embodiment, a message is decoded and compared to a database of patterns associated with advertisements to determine if the message includes a response code. For example, a response code, such as would be produced by the process 3200 (FIG. 32) as depicted in the advertisement action ID field 2845 (FIG. 28), might be included in a database of patterns associated with advertisements. Any suitable criteria may be used to determine that a match to a pattern associated with an advertising message is found.

In operation 3415, a publisher associated with a message is determined. A response code associated with a message may be used to ‘look up’ a publisher associated with an advertisement associated with the response code. For example, if a response code associated with the advertisement record 2800 (FIG. 28) is detected, information indicated in the advertisement ID field 2805 might be compared to information indicated in the publisher advertisement ID field 3025 (FIG. 30) to determine a publisher associated with the advertisement. Control is passed to operation 3420 and process 3400 continues.

In operation 3420, an advertiser and any targeting information associated with a message is determined. For example, a number of records such as the advertisement record 2800 (FIG. 28) and the advertiser record 2900 (FIG. 29) may be used to obtain targeting and/or advertiser information associated with a message. Control is passed to operation 3425 and process 3400 continues.

In operation 3425, performance information is recorded. Information of time, count, targeting, etc., related to advertising performance indicated in a message may be recorded. For example, the verifier database 2445 may be updated with advertising information such as compensation, performance, targeting, inventory, etc. Information such as a number of impressions, a user ID, a type of action, type of response, etc., associated with an advertisement may be recorded. Likewise if a message includes a tracking code or response code which is associated with a form of compensation such as cost per impression (CPM), cost per click (CPC), cost per call, cost per action (CPA), etc., is detected compensation may be determined for a publisher, etc. Control is passed to operation 3430 and process 3400 continues.

In operation 3430, a message is delivered to a target recipient. For example, a message from an aggregator and/or carrier may be provided to a publisher identified by an aggregator and/or a carrier. Likewise a message from a publisher may be delivered to an aggregator and/or carrier indicated by the publisher. In at least one embodiment, a user ID associated with an outgoing message may be used to route a return message to a publisher. In at least one embodiment, a message may be routed in parallel to a verification system and other systems who are intended recipients of the message such as a user and/or a publisher system. Control is passed to operation 3405 and process 3400 continues.

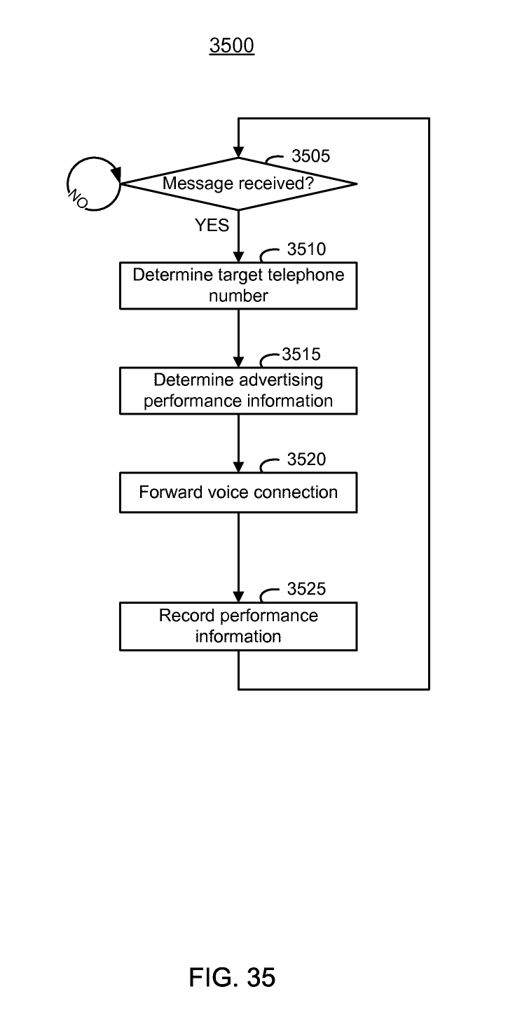

In at least one embodiment of the system 2400 (FIG. 24), a response such as a response keyword of an SMS message may initiate a voice call. Likewise, a user may respond to a phone number indicated in an SMS message which may be a tracking number. In such an instance, a message may be provided to the verification system 2440 directly and/or by the voice sever 2420. As illustrated in FIG. 35, a process 3500 for processing a message from a verification system perspective is provided. The process 3500 may be operative on the verification system 2440 (FIG. 24).

In operation 3505 (FIG. 35), a determination is made as to whether a message is received. If it is determined in operation 3505 that a message is not received, control remains at operation 3505 and process 3500 continues. If it is determined in operation 3505 that a message is received, control is passed to operation 3510 and process 3500 continues.

The determination in operation 3505 may be made based on various criteria. It may be determined that a message is received based on receiving a message at any device associated with a system such as the verification system 2440 (FIG. 24). A request may be received through an API provided in association with the verification system 2440. A message may be received from a publisher system, an advertiser system, a voice service, etc.

In operation 3510 (FIG. 35), a target telephone number associated with a message is determined. For example, a port associated with a phone number dialed by a user and/or designated by a user response action may be identified. Control is passed to operation 3515 and process 3500 continues.

In operation 3515, advertising performance information associated with a message is determined. For example, a publisher, a keyword, a category and/or other information associated with a telephone number associated with a message may be determined. Control is passed to operation 3520 and process 3500 continues.

In operation 3520, a voice connection is forwarded. For example, a connection may be established with a user, and/or an advertiser associated with a phone number associated with a message. In at least one embodiment, a publisher system may manage call interactions. Control is passed to operation 3525 and process 3500 continues.

In operation 3525, performance information is recorded. Information of time, count, targeting, etc., related to advertising performance indicated in a message may be recorded. For example, the verifier database 2445 (FIG. 24) may be updated with advertising information such as compensation, performance, targeting, inventory, etc. Control is passed to operation 3505 (FIG. 35) and process 3500 continues.

A system for verification of advertising performance is described. In an SMS or mobile messaging advertising environment, a message exchanged between a publisher and a user may be monitored to determine advertising performance. Advertisements are provided by advertisers to a publisher and a verification system. Response and detection codes may be shared between a verification system, a publisher system, and an advertiser system. As messages are transmitted through a wireless carrier, a verification of advertising performance may be made. A unique identifier of an advertisement or ‘response code’ which is included in an advertising message may be used to indicate a response. If a response code is detected in a message, the relevant advertising performance may be verified.

In at least one embodiment, SMS advertisements are published by a search service. Information of advertisements and a number of response actions may be provided to a verification system by a search service. A verification service may monitor and/or analyze SMS and/or other mobile messages, and response actions such as URL's, phone calls, etc., to determine whether an advertisement has been delivered, whether a user has responded to an advertisement, and/or other information relating to advertising performance. A verification service may be an independent system from a publisher/search system such as a third party ad server, and/or may be incorporated with the publisher/search system. Advertisers may be able to access information obtained by a verification system. Performance information may be obtained based on any parameters which may be used to target and/or deliver advertisements to a user. Advertising performance may be verified for cost per click, cost per impression, cost per call and/or cost per action types of advertising associated with SMS and/or other text or media based advertising. Any number of advertisers and/or publishers of media via SMS may verify performance of advertising delivered to a user.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The present invention may be implemented using a program stored, for example, in a computer-readable storage medium such as a CD-ROM, etc., or using one or more specialized terminals, devices or systems that is enabled to execute operation described herein.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”.

What is claimed is:

1. A computer-implemented method, comprising:
modifying an original query received based on a processing applied to the original query prior to performing a search; and
performing the search using the modified query and providing a response to the query as a result of the search.

2. The computer-implemented method of claim 1, comprising:
removing a portion of the original query based on content of previous queries.

3. The computer-implemented method of claim 2, comprising:
comparing a trailing or leading character series of the original query to an equal length trailing or leading character series of a predetermined number of previous queries; and
storing the trailing or leading character series when determining that a match occurs with a predetermined frequency.

4. The computer-implemented method of claim 1, comprising:
determining whether an automated response to the original query is used based on an automated comparison of selected historical queries to a query history of a user associated with the original query.

5. The computer-implemented method of claim 1, comprising:
comparing the modified query to a database of queries associated with a verified response; and
providing the verified response in preference to results associated with other queries matching the modified query.

6. The computer-implemented method of claim 1, comprising:
obtaining a ranked list of queries matching the modified query;
determining a normalized matching between the ranked queries; and
ranking search results associated with a predetermined number of the ranked queries which have a normalized matching which differs by less than a predetermined value.

7. The computer-implemented method of claim 1, comprising:
providing the response to a human searcher;
receiving a second modified query from the human searcher;
performing the search using the second modified query;
providing a query and a response selected using the second modified query to the human searcher; and
modifying a ranking of the query and the response when the query and the response are not selected by the human searcher.

8. The computer-implemented method of claim 1, comprising:
determining a probability that response to the modified query can be obtained automatically;
providing the response to a human searcher selected based on a category automatically assigned to the query when determining that the probability is below a predetermined value; and
providing the response to a generalist human searcher determining that the probability is not below the predetermined value.

9. The computer-implemented method of claim 1, comprising:
obtaining from an indexed database a plurality of queries matching the modified query;
calculating a magnitude associated with the modified query;
calculating a magnitude associated with each of the plurality of queries;
calculating an intersection of each of the plurality of queries with the modified query;
calculating a distance between the modified query and each of the plurality of queries based on the magnitude associated with each of the plurality of queries and the intersection of the modified query with each of the plurality of queries;
selecting a subset of the plurality of queries based on the distance;
obtaining rating values associated with answers associated with the subset;
ranking the answers based on the rating values; and
providing a highest ranking answer as the response.

10. The computer-implemented method of claim 1, comprising:
selecting an advertisement based on a keyword of the original query;
delivering the advertisement to a verifier; and
delivering the advertisement to a user associated with the original query.

11. A system, comprising:
a search service device receiving a search query, performing a natural language processing of the search query, comparing the search query to a corpus of requests, and determining a process for responding to the search query;
a searcher device receiving information of the search query, and providing a response to the search query; and
a database including information of search queries and search results.

12. The system of claim 11, comprising:
an advertiser device providing advertisements;
a user device submitting the search query, receiving an advertisement, and responding to the advertisement; and
a verification device receiving messages from the user device, the search service device, and the advertiser device and confirming delivery of the messages wherein the messages are mobile media messages.

13. A computer-implemented method, comprising:
receiving a search request;
determining whether the search request refers to historical information; and
selecting an automated process for responding to the search request based on the determining.

14. The computer-implemented method of claim 13, comprising:
comparing content of the search request to a plurality of keywords;
inhibiting an automated response when determining that the content of the search request matches the plurality of keywords; and
notifying a guide selected to respond to the search request of the matching.

15. The computer-implemented method of claim 13, comprising:
comparing content of the search request to a plurality of keywords;
examining a previous query associated with a user submitting the search request;
determining whether the search request refers to the previous query; and
processing the search request based on the determining by decreasing a probability that an automated search result will be provided.

16. The computer-implemented method of claim 13, comprising:
receiving from a guide an indication that a stored query is related to the search request; and
providing the stored query and a search resource associated with the stored query to a searcher selected to respond to the search request.

17. The computer-implemented method of claim 13, comprising:
receiving from a guide an indication that a stored query associated with a verified search result is a match to the search request; and
ranking the verified search result as the highest ranking search result for the search request.

18. The computer-implemented method of claim 13, comprising:
obtaining from a guide a rewritten search request based on the search request; and
modifying a statistical model for rewriting of search requests based on the rewritten search request from the guide.

19. The computer-implemented method of claim 13, comprising:
determining whether the search request includes a keyword referring to a previous search query; and
responding to the search request by performing a search for the previous request by directing the request to a human searcher when determining that the search request includes the keyword.

20. The computer-implemented method of claim 13, comprising:
comparing content of the search request to a plurality of keywords;
inhibiting an automated response when determining that the content of the search request matches the plurality of keywords;
notifying a guide selected to respond to the search request of the matching;
comparing content of the search request to a plurality of keywords;
examining a previous query associated with a user submitting the search request;
determining whether the search request refers to the previous query;
processing the search request based on the determining by decreasing the probability that an automated search result will be provided;
receiving from the guide an indication that a stored query is related to the search request;
providing the stored query and a search resource associated with the stored query to a searcher selected to respond to the query;
receiving from the guide an indication that the stored query is associated with a verified search result is a match to the search request;
ranking the verified search result as the highest ranking search result for the search request;
obtaining from the guide a rewritten search request based on the search request;
modifying a statistical model for rewriting of search requests based on the rewritten search request from the guide;
determining whether the search request includes a keyword referring to the previous search query;
responding to the search request by performing a search for the previous search query by directing the request to a human searcher when determining that the search request includes the keyword;
determining a time period between the search request and the previous search query; and
adjusting a probability that the search request will be processed automatically based on the time period.
